(19) United States
(12) Patent Application Publication
(10) Pub. No.: US 2008/0225210 A1
(43) Pub. Date: Sep. 18, 2008

(54) Optical Compensation Film, Polarizing Plate, and Liquid Crystal Display Device

(75) Inventors: Kazuhiro Shimoda, Kanagawa (JP); Hirokazu Nishimura, Kanagawa (JP); Akihiro Ikeyama, Kanagawa (JP); Tsuyoshi Yamamoto, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/044,238

(22) Filed: Mar. 7, 2008

(30) Foreign Application Priority Data
Mar. 8, 2007 (JP) 2007-059009

(51) Int. Cl. G02F 1/1333; G02B 1/08; G02B 5/30

(52) U.S. Cl. 349/96; 359/500; 428/1.31

(57) ABSTRACT

An optical compensation film including: a support; an alignment film layer including a polymer having a radical polymerizable group; and an optical anisotropic layer including a liquid crystal compound, laminated in this order, wherein a content of a polymerization initiator capable of reacting with the radical polymerizable group and/or a compound capable of reacting with the radical polymerizable group and having two or more vinyl groups is 0.05% by mass to 30.0% by mass with respect to a total solid content of the polymer having a radical polymerizable group contained in the alignment film layer; and the like.

### BACKGROUND OF THE INVENTION

1. Field of the Invention

The present invention relates to an optical compensation film, a polarizing plate, and a liquid crystal display device.

2. Description of the Related Art

An optical film in which a liquid crystal compound is precisely aligned and fixed has recently been applied on various uses, such as an optical compensation film of a liquid crystal display device, a luminance improvement film, an optical correction film of a projection display device, and the like. Among these, the optical film has been significantly developed as the optical compensation film of the liquid crystal display device.

The liquid crystal display device is mainly comprised of a polarizing plate and a liquid crystal cell. For example, in a thin film transistor (TFT) liquid crystal device of Twisted Nematic mode (TN mode) which is currently in the main stream of the technology, the optical compensation film is inserted between the polarizing plate and the liquid crystal cell so that high display quality of the liquid crystal display device is realized. However, there is a problem such that a thickness of the liquid crystal display device itself becomes large in this method.

In order to solve the problem of the thick liquid crystal display device, there has been proposed a use of an elliptical polarizing plate which has a retardation plate on one surface of a polarizing film and a protective film on the other surface of the polarizing film so that the thickness of the liquid crystal display device is reduced and the front face contrast is maintained high (refer to Japanese Patent Application Laid-Open (JP-A) No. 02-247602). However, the proposed retardation film (optical compensation film) does not provide a sufficient effect for improving an angle of field, and there is a problem such that the display quality of the liquid crystal display device is lowered.

Therefore, in order to solve the problem of the thickness and angle of field of the liquid crystal display device, there has been proposed a use of an optical compensation film in which an optical anisotropic layer formed from a discotic compound is coated on a transparent support as a protective film of a linear polarizing plate (refer to JP-A No. 07-191217 and European Patent No. 911656).

However, in these proposals, the optical compensation film is developed for a small size to middle size of the liquid crystal display device having a size of 15 inches or smaller. When it is disposed on a polarizing plate for a liquid crystal display device of a large size and high luminance having a size of 17 inches or larger, the unevenness is caused on the panel, and thus it cannot be applied for such the large liquid crystal display device. Therefore, it is necessary to further develop an optical film which is responsive to the upsizing and enhanced luminance of the liquid crystal display device as well as solving the unevenness of light leakage.

In order to improve the unevenness, there has been proposed a method in which a leveling agent is added to a polymerizable liquid crystal (refer to JP-A No. 11-148080). However, this proposal is only effective in the case that the polymerizable liquid crystal is homogeneous alignment, and it cannot be applied for the complicated alignment such as a hybrid alignment.

Therefore, there has been proposed an optical compensation film or the like, which has an optical anisotropic layer on the support, and the optical anisotropic layer containing a liquid crystal compound, and a fluoro-aliphatic group containing copolymer having a repeating unit derived from fluoro-aliphatic group containing (meth)acrylate monomer and polyoxyalkylene(metha)acrylate monomer (refer to JP-A No. 2004-198511).

However, compared to other supports and optical anisotropic layers consisting optical compensation films mentioned earlier, this optical compensation film uses a material which easily absorb water for an alignment film bonded to a support via an adhesive layer, and thus the expansion coefficient of the alignment film becomes larger than the expansion coefficient of the support or adhesive layer when the optical compensation film is left in a high humidity condition. As a result, the cracks are formed on the alignment film, and the display quality of the displaying device in which the optical compensation film is disposed. Therefore, it is necessary to improve a durability of this optical compensation film.

Accordingly, there have been demands for the developments of an optical compensation film which provides a high durability of a polarizing plate when it is prepared by using the optical compensation film and maintains an excellent alignment, a polarizing plate containing such the optical compensation film, and a liquid crystal display device containing such the polarizing plate.

### BRIEF SUMMARY OF THE INVENTION

The present invention resolves the above-described problems inherent to the related art and attains the below-described object. Thus, it is an object of the present invention to provide an optical compensation film which has an improved durability in the high temperature and/or high humidity conditions without deterioration of alignment or optical compensatory function, a polarizing plate which contains the optical compensation film of the present invention and a polarizer bonded to the optical compensation film, and a liquid crystal display device which has an excellent viewing-angle property even in the high temperature and/or high humidity conditions without deterioration of display quality.

As a result of dedicated investigations conducted by the present inventors, they have found the following experiences or discoveries. Specifically, for the purpose of resolving the above-described problems, a predetermined amount of a polymerization initiator, which accelerates crosslinking of the radical polymerizable group of the polymer contained in an alignment film layer, is contained in the alignment film layer, and a pretreatment step, in which the radical polymerizable group is crosslinked, is performed before disposing an optical anisotropic layer. These enable reduction of a phenomenon that cracks are formed in the optical anisotropic layer in the high temperature and/or high humidity conditions and improvement of durability.

In addition, as a result of dedicated investigations conducted by the present inventors, they have found the following experiences or discoveries. Specifically, for the purpose of resolving the above-described problems, a predetermined amount of a compound which reacts with the radical polymerizable group and has two or more vinyl groups is contained in the alignment film layer. This enables reduction of a phenomenon that cracks are formed in the optical anisotropic layer in the high temperature and/or high humidity conditions and improvement of durability.

The present invention is based on the above-mentioned experiences or discoveries by the present inventors, and means for solving the above-mentioned problems are as follows. Specifically,

<1> An optical compensation film including at least: a support; an alignment film layer including a polymer having a radical polymerizable group and a polymerization initiator capable of reacting with the radical polymerizable group, the alignment film layer disposed over the support; and an optical anisotropic layer including at least one liquid crystal compound and at least one fluoroaliphatic group-containing polymer, the optical anisotropic layer disposed over the alignment film layer, wherein the amount of the polymerization initiator is 0.05% by mass to 30.0% by mass with respect to a total solid content of the polymer having a radical polymerizable group contained in the alignment film layer.
<2> The optical compensation film according to the <1>, wherein the polymer having a radical polymerizable group is a polymer containing at least one of polyvinyl alcohol and modified polyvinyl alcohol as a main substance, and the alignment film layer is a cured film obtained by coating a composition for an alignment film having a solid concentration of 0.5% by mass to 3.0% by mass, and drying.
<3> The optical compensation film according to the <1>, wherein a water solubility of the polymerization initiator is 0.01% by mass to 5.0% by mass at 25° C.
<4> The optical compensation film according to the <1>, wherein the polymerization initiator has a maximum absorption wavelength of 200 nm to 350 nm.
<5> The optical compensation film according to the <1>, wherein a thickness of the alignment film layer is 0.07 μm to 0.40 μm.
<6> The optical compensation film according to the <1>, wherein the alignment film layer is formed through performing a pretreatment step, which allows the polymer having a radical polymerizable group to be crosslinked, before disposing the optical anisotropic layer.
<7> An optical compensation film including at least: a support; an alignment film layer including a polymer having a radical polymerizable group and a compound capable of reacting with the radical polymerizable group and having two or more vinyl groups, the alignment film layer disposed over the support; and an optical anisotropic layer including at least one liquid crystal compound and at least one fluoroaliphatic group-containing polymer, the optical anisotropic layer disposed over the alignment film, wherein the amount of the compound capable of reacting with the radical polymerizable group and having two or more vinyl groups is 0.10% by mass to 30.0% by mass with respect to a total solid content of the polymer having a radical polymerizable group contained in the alignment film layer.
<8> The optical compensation film according to the <7>, wherein the polymer having a radical polymerizable group is a polymer containing at least one of polyvinyl alcohol and modified polyvinyl alcohol as a main substance, and the alignment film layer is a cured film obtained by coating a composition for an alignment film having a solid concentration of 0.5% by mass to 3.0% by mass, and drying.
<9> The optical compensation film according to the <7>, wherein a water solubility of the compound having two or more vinyl groups is 0.05% by mass to 5.0% by mass at 25° C.
<10> The optical compensation film according to the <7>, wherein the compound having two or more vinyl groups is a multifunctional (meth)acrylate compound having at least two (meth)acrylate groups.
<11> The optical compensation film according to the <7>, wherein a thickness of the alignment film layer is 0.07 μm to 0.40 μm.
<12> An optical compensation film including at least: a support; an alignment film layer including a polymer having a radical polymerizable group, a polymerization initiator capable of reacting with the radical polymerizable group, and a compound capable of reacting with the radical polymerizable group and having two or more vinyl groups, the alignment film disposed over the support; and an optical anisotropic layer including at least one liquid crystal compound and at least one fluoroaliphatic group-containing polymer, the optical anisotropic layer disposed over the alignment film layer, wherein the amount of the polymerization initiator and the compound having two or more vinyl groups is 0.05% by mass to 30.0% by mass with respect to a total solid content of the polymer having a radical polymerizable group contained in the alignment film layer.
<13> The optical compensation film according to the <12>, wherein the polymerization initiator has a maximum absorption wavelength of 200 nm to 350 nm.
<14> The optical compensation film according to the <12>, wherein a thickness of the alignment film layer is 0.07 μm to 0.40 μm.
<15> The optical compensation film according to the <12>, wherein the alignment film layer is formed through performing a pretreatment step, which allows the polymer having a radical polymerizable group to be crosslinked, before disposing the optical anisotropic layer.
<16> A polarizing plate including: the optical compensation film of the <1>; and a polarizer bonded to the optical compensation film.
<17> A polarizing plate including: the optical compensation film of the <7>; and a polarizer bonded to the optical compensation film.
<18> A polarizing plate including: the optical compensation film of the <12>; and a polarizer bonded to the optical compensation film.
<19> A liquid crystal display device including: the polarizing plate of the <16>; and a liquid crystal cell.
<20> A liquid crystal display device including: the polarizing plate of the <17>; and a liquid crystal cell.
<21> A liquid crystal display device including: the polarizing plate of the <18>; and a liquid crystal cell.

The present invention can solve the conventional problems and can provide an optical compensation film which has an improved durability in the high temperature and/or high humidity conditions without deterioration of alignment or optical compensatory function, a polarizing plate which contains the optical compensation film and a polarizer bonded to the optical compensation film, and a liquid crystal display device which has an excellent viewing-angle property even in the high temperature and/or high humidity conditions without deterioration of display quality.

### BRIEF DESCRIPTION OF THE SEVERAL VIEW OF THE DRAWING

FIG. 1 is a schematic diagram showing an example of the entire processes for a production method of the optical compensation film of the present invention.

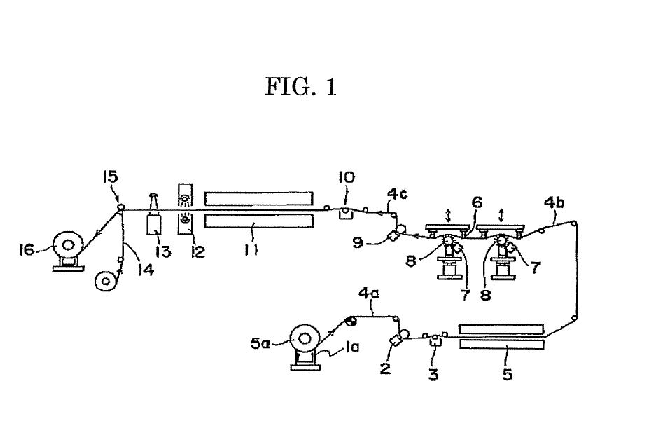

### DETAILED DESCRIPTION OF THE INVENTION

An optical compensation film in accordance with the present invention and the production method thereof, a polarizing plate and a crystal liquid display device will be described below in greater detail.

### (Optical Compensation Film)

The optical compensation film of the present invention contains at least an alignment film layer and an optical anisotropic layer laminated on a support in this order, wherein the alignment film contains a polymer having a radical polymerizable group and, a polymerization initiator capable of reacting with the radical polymerizable group and/or a compound capable of reacting with the radical polymerizable group and having two or more vinyl groups, and the optical anisotropic layer contains at least one liquid crystal compound and at least one fluoro-aliphatic group containing polymer.

### <Support>

The support is preferably made of glass or transparent polymer film, and preferably has an optical transparency of 80% or more.

Examples of the polymer constituting the polymer film are cellulose ester, norbornene polymer, polymethyl methacrylate, and the like. Specific examples of cellulose ester include cellulose acetate, cellulose diacetate, and the like.

The polymer can be selected from the commercially available polymers. Examples of the commercially available polymers of norbornene polymer include ARTON (product name), ZEONEX (product name), and the like.

Among the polymers listed above, cellulose ester is preferable to use, and lower fatty acid ester of cellulose is more preferable to use.

The lower fatty acid is determined as C1-6 fatty acids, and preferred examples of the lower fatty acid ester of cellulose include C2 cellulose acetate, C3 cellulose propionate, and C4 cellulose butyrate. Among these, cellulose acetate is the most preferable.

Even the conventionally known polymers which tend to cause birefringence such as polycarbonate and polysulfone can be used for the optical compensation film of the present invention, provided that the generation of birefringence is inhibited by modifying the molecules of the polymers in the way described in International Patent Publication No. WO 00/26705.

In the case where the optical compensation film of the present invention is used for a polarizing plate protection film or retardation film, the polymer film of the support is preferably made of cellulose acetate having an oxidation degree of 55.0% to 62.5%, and is more preferably made of cellulose acetate having an oxidation degree of 57.0% to 62.0%.

The oxidation degree is determined here as an amount of bonded acetic acid per unit mass of cellulose. For example, this can be determined by measuring and calculating an acetylation degree in accordance with ASTM: D-817-91 (testing methods for cellulose acetate, etc.).

Cellulose acetate for use in the present invention preferably has a viscosity average polymerization degree (DP) of 250 or more, and more preferably has DP of 290 or more. Moreover, cellulose acetate for use in the present invention preferably has a narrow molecular weight distribution of Mw/Mn (Mw: weight average molecular weight, Mn: number average molecular weight) in accordance with gel permeation chromatography. Specifically, Mw/Mn is preferably 1.0-1.7, more preferably 1.0-1.65, and the most preferably 1.0-1.6.

Cellulose acetate has a tendency such that hydroxyl groups at 2-, 3-, 6-positions are not uniformly substituted, but the substitution degree of the 6-position is small. Therefore, in the polymer film for use in the present invention, it is preferable that the substitution degree of the 6-position of cellulose is equal to or more than the 2- and 3-positions of cellulose.

The ratio of the substitution degree of the 6-position of cellulose acetate to the total of the substitution degrees of the 2-, 3-, and 6-positions of the cellulose acetate is preferably 30% to 40%, more preferably 31% to 40%, and the most preferably 32% to 40%. The substitution degree of the 6-position is preferably 0.88 or more. Note that, the substitution degree at each of the positions can be determined by NMR.

The cellulose acetate having a high substitution degree at the 6-position can be synthesized for example, with reference to Synthesis Example 1 described in the paragraphs—, Synthesis Example 2 described in the paragraphs—, and Synthesis Example 3 described in the paragraphs—of JP-A No. 11-5851.

### <Alkali Saponification Method as Surface Treatment of Optical Film>

From the viewpoint of adhesion to the below-mentioned alignment film, it is preferable that the surface of the polymer film serving as a support be hydrophilized. The surface of the film can be hydrophilized preferably by alkali saponification treatment.

In the present invention, a method for alkali saponifying a polymer film serving as a support preferably contains a step of applying an alkaline solution onto a polymer film and a step of washing away the alkaline solution from the polymer film. In the present invention, in addition to these steps, the method for alkali saponifying a polymer film preferably contains a step of heating the polymer film to room temperature or higher in advance and a step of retaining the temperature of the polymer film at room temperature or higher. In other words, the method for alkali saponifying a polymer film preferably contains the steps of heating a polymer film to room temperature or higher in advance, applying an alkaline solution onto the polymer film, retaining the temperature of the polymer film at room temperature or higher, and washing away the alkaline solution from the polymer film.

### [Alkali Saponification]

Alkali saponification can be performed by either a method in which an optical film is immersed in an alkaline solution or a method in which an alkaline solution is sprayed at the surface of an optical film, or an alkaline solution is applied onto the surface of an optical film. In the present invention, alkali saponification is performed more preferably by a coating method that allows uniform saponification of only one side of an optical film without unevenness. In other words, saponification is performed more preferably by a step of applying an alkaline solution onto a polymer film. On the other hand, the saponification by an immersion method is particularly useful in the alkali saponification containing an organic solvent and can make the processing speed much faster compared to that which does not contain an organic solvent.

Alkali saponification is performed preferably at a process temperature not exceeding 120° C., which does not cause deformation of the film to be saponified or denaturing of an alkaline solution, more preferably at a temperature of from 25° C. to 120° C., and the most preferably at a temperature of from 25° C. to 100° C.

The duration of saponification is determined by adjusting properly depending on the alkaline solution and the temperature at which saponification is performed, preferably in a range of 1 second to 60 seconds.

Further, the alkali saponification method of the present invention preferably contains a step of applying an alkaline solution onto a polymer film at a temperature of room temperature (25° C.) or higher. Further, in addition to these steps, the alkali saponification method of the present invention preferably contains a step of retaining the temperature of the polymer film at room temperature or higher. This step is favorable since the temperature during saponification can be made at a desired temperature.

Moreover, in the present invention, in order to make the polymer film at a predetermined temperature, the alkali saponification method preferably contains a step of controlling the temperature of the polymer film to the predetermined temperature (room temperature or higher) in advance before applying an alkaline solution. In addition, it is also preferable that the alkali saponification method further contains a step of controlling the temperature of an alkaline solution to a predetermined temperature in advance. Especially, it is preferable that the alkali saponification method contains a step of heating the polymer film to the predetermined temperature (temperature at room temperature or higher) in advance before coating.

“make the polymer film at a predetermined temperature”, “a polymer film at a temperature of room temperature or higher”, and “retaining the temperature of the polymer film at room temperature or higher” do not mean that the temperature of the entire polymer film is required to be the predetermined temperature. It is sufficient if the surface treated by saponification, i.e., the surface of the polymer film where saponification reaction proceeds is the predetermined temperature.

Here, the polymer film can be heated to room temperature or higher preferably by means of direct heating by the collision (spraying) of a hot air stream, contact heat transfer with a heat roll, inductive heating with microwave, or radiation heating with an infrared heater. In particular, the contact heat transfer with a heat roll is preferable in that it can achieve a high heat transfer efficiency while needing only a small setting area and that the film temperature can quickly rise at the initiation of transportation. Commonly employed double-jacket roll or an electromagnetic conductive roll (manufactured by TOKUDEN) can be used. The surface temperature of the film after heating is preferably from 25° C. to 120° C., more preferably from 25° C. to 100° C.

The means for retaining the temperature of the polymer film is selected considering that one side of the film is wet with the alkaline solution. Collision (spraying) of a hot air stream to the face opposite to the coated face, contact heat transfer using a heat roll, inductive heating with microwave, radiation heating with an infrared heater, etc. may be preferably employed. It is preferable to use an infrared heater since it enables non-contact heating without causing air stream and thus the effects on the face coated with the alkaline solution can be minimized. For the infrared heater, a far-infrared ceramic heater of electric type, gas type, oil type or steam type can be used. Commercially available infrared heaters (e.g. a product of Noritake Co., Limited) may be used. The infrared heater of oil or steam type using an oil or a steam as a heat medium is preferable from the viewpoint of preventing explosion in an atmosphere where an organic solvent is present. The polymer film temperature may be either the same as or different from the temperature heated before applying an alkaline solution. The temperature may be continuously or stepwise varied in the course of the saponification. The film temperature ranges from 20° C. to 120° C., preferably from 25° C. to 100° C. The film temperature may be measured by using a commonly marketed non-contact infrared thermometer. To control the film temperature within the aforementioned range, the heating means may be feedback regulated.

The time of holding the temperature within the aforementioned range from coating of the alkaline solution to washing away the same is preferably from 1 second to 5 minutes, more preferably from 2 seconds to 100 seconds and particularly preferably from 3 seconds to 50 seconds, though it varies depending on the below-mentioned transportation speed.

These means are preferable since they can control the temperature of the alkaline solution on the film surface to room temperature or higher.

### (Alkaline Solution)

The alkaline solution used for alkali saponification in the present invention preferably has a pH of 11 or greater, more preferably 12 to 14.

Examples of the alkali chemicals used for the alkaline solution include: inorganic alkali chemicals such as sodium hydroxide, potassium hydroxide, lithium hydroxide, and the like; and organic alkali chemicals such as diethanol amine, triethanol amine, DBU (1,8-diazabicyclo[5,4,0]-7-undecene), DBN (1,5-diazabicyclo[4,3,0]-5-nonene), tetramethylammonium hydroxide, tetraethylammonium hydroxide, tetrapropylammonium hydroxide, tetrabutylammonium hydroxide, triethylbutylammonium hydroxide, and the like. These alkali chemicals may be used singly, or in the combination of two or more. For example, the alkali chemicals can be added in the form of salt in which a part of the alkali chemicals is halogenated. Among these, hydroxides of alkali metals are preferable; it is most preferable to use sodium hydroxide or potassium hydroxide since the pH value can be adjusted over a wide range by adjusting the added amount thereof.

The concentration of the alkaline solution is determined depending on a type of the alkali chemicals for use, reaction temperature, and reaction duration, but the content of the alkali chemicals is preferably 0.1 mol/Kg to 5 mol/Kg, and more preferably 0.3 mol/Kg to 3 mol/Kg in the alkaline solution.

The solvent of the alkaline solution is preferably a mixed solution of water and a water-soluble organic solvent. The organic solvent is not particularly limited as long as it is compatible with water, but the organic solvent is preferably the one having a boiling point of 120° C. or less, more preferably the one having a boiling point of 60° C. to 120° C. and particularly preferably the one having a boiling point of 100° C. or less.

Among these, the preferable organic solvent is the one having an inorganic/organic value (I/O value) of 0.5 or more and a solubility parameter of 16 to 40 [mJ/m³]^{1/2}, and the more preferable organic solvent is the one having an inorganic/organic value (I/O value) of 0.6 to 10 and a solubility parameter of 18 to 31 [mJ/m³]^{1/2}. When the I/O value is equal to or less than the upper value (inorganic property is not too strong), and the solubility parameter is equal to or more than the lower value, it is preferable since problems such as lowering of the speed of alkali saponification and insufficient surface evenness of the saponification degree do not occur. On the other hand, when the I/O value is equal to or more than the lower value (organic property is not too strong), and the solubility parameter is equal to or less than the upper value, it is preferable since the speed of saponification is fast, problems such as easy occurrence of haze do not occur, and thus the surface evenness is sufficient.

Examples of the organic solvent having the preferable properties are those listed in The Society of Synthetic Organic Chemistry ed. New Edition Solvent Pocket Book (1994), Ohmsha Ltd. The inorganic/organic value (I/O value) of the organic solvent is explained for example in Yoshio Tanaka, Organic Schematic Diagram (1983), Sankyo Publishing Co., Ltd., pp. 1-31.

Specific examples of the organic solvent include: one-valent aliphatic alcohol such as methanol, ethanol, propanol, buthanol, pentanol, hexanol or the like; alicyclic alkanol such as cyclohexanol, methylcyclohexanol, methoxycyclohexanol, cyclohexylmethanol, cinylhexylethanol, cyclohexylpropanol, or the like; phenyl alkanol such as benzyl alcohol, phenyl ethanol, phenyl propanol, pehnoxyethanol, methoxybenzyl alcohol, benzyloxyethanol, or the like; heterocyclic alkanol such as furfuryl alcohol, tetrahydrofurfuryl alcohol, or the like; monoether of a glycol compound such as methyl cellosolve, ethyl cellosolve, propyl cellosolve, methoxymethoxy ethanol, butyl cellosolve, hexyl cellosolve, methyl carbitol, ethyl carbitol, propyl carbitol, butyl carbitol, ethoxytriglycol, propylene glycol monomethyl ether, propylene glycol monoethyl ether, propylene glycol monopropyl ether, or the like; ketone such as acetone, methylethyl ketone, methylisobutyl ketone, or the like; amide such as N,N-dimethyl formamide, dimethyl formamide, N-methyl-2-pyrrolidone, 1,3-dimethylimidazolidinone, or the like; sulfoxide such as dimethyl sulfoxide, or the like; ether such as tetrahydrofuran, pyran, dioxane, trioxane, dimethyl cellosolve, diegthyl cellosolve, dipropyl cellosolve, megthylethyl cellosolve, dimethyl carbitol, methylethyl carbitol, or the like; and the like. The organic solvent may be used singly or in combination of two or more.

In the case where either one or plurality of the organic solvents is used, at least on organic solvent is preferably the one having a large solubility to water. The solubility of the organic solvent to water is preferably 50% by mass or more, and it is more preferable that the organic solvent has the solubility such that the organic solvent is freely mixed with water. Using such the organic solvent, the alkaline solution which has sufficient solubilities for the alkali chemicals, a salt of fatty acid which is a by-product of the saponification treatment, a salt of carbonic acid generated as a result of absorbing carbon dioxide present in the air, and the like, can be prepared.

The content of the organic solvent in the solution is adjusted depending on the type of the solvent, the compatibility (solubility) to water, reaction temperature and reaction duration.

The mixing ratio of water and the organic solvent is preferably 3/97 to 85/15, more preferably 5/95 to 60/40, and the most preferably 15/85 to 40/60 on the mass basis. When the mixing ratio is within this range, it is preferable since the saponification treatment is easily and uniformly performed on the entire surface of the film without adversely affecting the optical properties of the acylate film.

The alkaline solution for use in the present invention is particularly preferably an alkaline solution such that the alkali chemical is a hydroxide of an alkali metal and the solvent of the alkaline solution contains: one, or two or more organic solvents selected from alcohols having 8 or less carbon atoms, ketones having 6 or less carbon atoms, esters having 6 or less carbon atoms and polyhydric alcohols having 6 or less carbon atoms; and water. Metal hydroxides are preferable since they have high reactivity to the polymer film and thus the amount of alkali chemical used can be reduced. The combination of the aforementioned organic solvents and water is preferable because of high solubility of metal hydroxides

It is preferable that the alkaline solution for use in the present invention is controlled so as to achieve liquid properties of the following ranges. Specifically, it is preferable that the surface tension of the alkaline solution is not more than 45 mN/m and the viscosity thereof is from 0.8 mPa·s to 20 mPa·s. It is more preferable that its surface tension is from 20 mN/m to 40 mN/m and the viscosity thereof is from 1 mPa·s to 15 mPa·s. Within these ranges, stable coating of the alkaline solution can be easily performed depending on the transporting speed and the wettability with the liquid to the film surface, the retention of the liquid having been applied to the film surface and removal of the alkaline solution from the film surface after the completion of the saponification can be sufficiently conducted.

As the organic solvent contained in the alkaline solution, an organic solvent other than the organic solvent having the aforementioned preferable I/O value (for example, alcohol fluoride) can be added as a dissolution assistant for the below-mentioned surfactant and compatible accelerator may be further added. The content thereof is preferably 0.1% to 5% with respect to the total weight of the solution for use.

Use of organic solvents, especially, organic solvents having the organic property and the solubility within each range as described above, in combination with water, the below-mentioned surfactants, compatible accelerators, etc maintains high speed of saponification and improves the evenness of the saponification degree over the entire surface. Namely, the aforementioned alkaline solution is preferably an alkaline solution that contains a water-soluble organic solvent having a boiling point of from 60° C. to 120° C., and a surfactant and compatible accelerator.

The alkaline solution for use in the present invention preferably contains a surfactant. By adding the surfactant, the surface tension of the alkaline solution is reduced to thereby improve coating ability, the evenness of the coated film is improved to thereby inhibit cratering inferiors, haze which tends to be caused under the presence of the organic solvent is inhibited, and the saponification reaction is uniformly progressed. The effects thereof become significant when used in combination with the below-mentioned compatibility accelerator. The surfactant for use is not particularly limited, and can be selected from an anionic surfactant, a cationic surfactant, an amphoteric surfactant, a nonionic surfactant, and a fluorosurfactant. Namely, the alkaline solution preferably contains at least one selected from a nonionic surfactant, an anionic surfactant, cationic surfactant and an amphoteric surfactant. In particular, a nonionic surfactant is preferable.

Specific examples thereof include those known compounds listed in Tokiyuki Yoshida, Surfactant Handbook (New Edition) (1987), Kougaku Tosho, Function-establishment, material development, and applied technologies of surfactant (2000), Gijutu Kyoiku Publishing.

The cationic surfactant is preferably quaternary ammonium salts. The amphoteric surfactant is preferably betaine type compounds. The nonionic surfactant will be described below.

### [Nonionic Surface Active Agent]

Examples of the nonionic surface active agents include polyoxyethylenealkyl ethers, polyoxyethylenealkylphenyl ethers, polyoxyethylenepolystyrylphenyl ethers, polyoxyethylene polyoxypropylenealkyl ethers, esters of glycerin fatty acid moiety, esters of sorbitan fatty acid moiety, esters of pentaerythritol fatty acid moiety, esters of propyleneglycol monofatty acid moiety, esters of sucrose fatty acid moiety, esters of polyoxyethylene sorbitan fatty acid moiety, esters of polyoxyethylenesorbitol fatty acid moiety, esters of polyethyleneglycol fatty acid moiety, esters of polyglycerin fatty acid moiety, polyoxyetylenized castor oils, esters of polyoxyethyleneglycerin fatty acid moiety, diethanol amides of fatty acid, N,N-bis-2-hydroxyalkylamines, polyoxyethylenealkyl amine, fatty acid esters of triethanol amine, and trialkylamineoxide.

Examples of the nonionic surface active agent include polyethylene glycol, polyoxyethylene lauryl ether, polyoxyethylene nonyl ether, polyoxyethylene cetyl ether, polyoxyethylene stearyl ether, polyoxyethylene oleyl ether, polyoxyethylene behenylether, polyoxyethylene polyoxypropylene cetyl ether, polyoxyethylene polyoxypropylene behenyl ether, polyoxyethylene phenyl ether, polyoxyethylene octylphenyl ether, polyoxyethylene stearyl amine, polyoxyethylene oleyl amine, polyoxyethylene stearamide, polyoxyethylene oleamide, polyoxyethylene castor oil, polyoxyethylene abietyl ether, polyoxyethylene nonyl ether, polyoxyethylene monolaurate, polyoxyethylene monostearate, polyoxyethylene glyceryl monoolate, polyoxyethyleneglyceryl monostearate, polyoxyethylene propyleneglycol monostearate, oxyethyleneoxypropylene block polymer, distyrenated phenol polyethyleneoxide adducts, tribenzylphenol polyethyleneoxide adducts, octylphenolpolyoxyethylene polyoxypropylene adducts, glycerol monostearate, sorbitan monolaurylate, and polyoxyethylene sorbitan monolaurate. The nonionic surface active agent has a weight average molecular weight of preferably 300 to 50,000, more preferably 500 to 5,000.

Among these, various polyalkylene glycol derivatives, and polyethylene oxide derivatives such as various polyethylene oxide adducts are preferable.

In particular, in the present invention, the surfactant is preferably the nonionic surfactant represented by the following general formula (1-2).

R1-L1-Q1 General formula (1-2)

In the formula, R1 represents an alkyl group having 8 or more carbon atoms (optionally having a substituent), L1 represents a linking group that links R1 and Q1 and is a direct bond or a divalent liking group, and Q1 represents a nonionic hydrophilic group selected from among a polyoxyethylene unit (degree of polymerization: 5 to 150), a polyglycerin unit (degree of polymerization: 3 to 30) and a hydrophilic sugar chain unit.

Specific examples of the nonionic surfactant include polyoxyethylene lauryl ether, polyoxyethylene nonyl ether, polyoxyethylene cetyl ether, polyoxyethylene stearyl ether, polyoxyethylene oleyl ether, polyoxyethylene behenyl ether, polyoxyethylene octyl phenyl ether, polyoxyethylene stearylamine, polyoxyethylene oleylamine, and the like. The mass-average molecular weights of these nonionic surfactants range preferably from 300 to 50,000, particularly preferably from 500 to 5,000.

Further, in a preferable aspect of the present invention, the compound represented by the following general formula (2-2) is employed as the nonionic surfactant.

R¹¹—O(CH₂CHR¹²O)ₗ—(CH₂CHR¹³O)ₘ—(CH₂CHR¹⁴O)ₙ—R¹⁵ General formula (2-2)

In the general formula (2-2), R¹¹ to R¹⁵ each represent a hydrogen atom, an alkyl group having 1 to 18 carbon atoms, an alkenyl group, an alkynyl group, an aryl group, a carbonyl group, a carboxylate group, a sulfonyl group, or a sulfonate group.

Specific examples of the alkyl group include a methyl group, an ethyl group, a hexyl group, and the like. Specific examples of the alkenyl group include a vinyl group, a propenyl group, and the like. Specific examples of the alkynyl group include an acetyl group, a propynyl group, and the like. Specific examples of the aryl group include a phenyl group, a 4-hydroxyphenyl group, and the like.

l, m, and n represent an integer of 0 or more, where l, m, and n are not 0 at the same time.

Specific examples of the compound represented by the general formula (2-2) include homopolymers such as polyethylene glycol and polypropylene glycol; copolymers of ethylene glycol; and copolymers of propylene glycol. The ratio of the copolymer is preferably from 10/90 to 90/10 in terms of solubility in alkaline aqueous solution. Among the copolymers, a graft polymer and a block polymer are preferable in consideration of solubility in the alkali saponification solution and of ease of the alkali saponification treatment.

It is also preferable that the alkaline solution contains the combination of the nonionic surfactant and the anionic surfactant, or the combination of the nonionic surfactant and the cationic surfactant as the effect of the present invention is enhanced. The content of the surfactant in the alkaline solution is preferably 0.001% by mass to 10% by mass, more preferably 0.01% by mass to 10% by mass, still more preferably 0.1% by mass to 10% by mass, and the most preferably 0.1% by mass to 5% by mass.

### (Compatibility Accelerator)

The alkaline solution for use in the present invention preferably contains a compatibility accelerator. In the present invention, “compatibility accelerator” means a hydrophilic compound having the water solubility of 50 g or more at 25° C. with respect to 100 g of the compatibility accelerator. The water solubility of the compatibility accelerator is preferably 80 g or more, and more preferably 100 g or more with respect to 100 g of the compatibility accelerator. In the case where the compatibility accelerator is a liquid compound, the boiling point thereof is preferably 100° C. or more, and more preferably 120° C. or more.

The compatibility accelerator has functions such that the alkaline solution attached to the wall of the bath or the like for retaining the alkaline solution is prevented from being dried and adhered, and the alkaline solution is stably maintained. Moreover, from when the alkaline solution is coated to the surface of the support and is maintained for a predetermined time till when the saponification treatment is terminated, the compatibility accelerator prevents the thin film of the coated alkaline solution from being dried, precipitating solids, and causing the difficulties in washing out the solid in the washing process. Furthermore, the compatibility accelerator prevents phase separation of water and the organic solvent which constitute the solvent. Especially when the surfactant, the organic solvent, and the aforementioned compatibility accelerator are contained in combination, the treated support has the decreased haze, and has the stable and uniform saponification degree on the entire surface thereof even when the long film of the support is subjected to the continuous saponification treatment.

The compatibility accelerator is not particularly limited as long as the aforementioned conditions are satisfied. Examples thereof include a water-soluble polymer having a repeating unit containing a hydroxyl group and/or an amide group, such as a polyol compound, and saccharide.

The polyol compound may be a low molecular compound, an oligomer compound, or a polymer compound.

Examples of aliphatic polyol as the polyol compound include: C2-8 alkane diol such as ethylene glycol, propylene glycol, butane diol, pentane diol, hexane diol, glycerin monomethyl ether, glycerin monoethyl ether, cyclohexane diol, cyclohexane dimethanol, diethylene glycol, dipropylene glycol, or the like; C3-18 alkane having three or more hydroxyl groups such as glycerin, trimethylol ethane, trimethylol propane, trimethylol butane, hexane triol, pentaerythritol, diglycerin, dipentaerythritol, inositol, or the like; and the like.

Examples of polyalkyleneoxypolyol as the polyol compound include those formed by bonding the same alkylene diols, or different alkylene diols. The preferable polyalkyleneoxypolyol is the one formed by bonding the same alkylene diols. In each case, the number of bonding is preferably 3 to 100, and more preferably 3 to 50. Specific examples thereof include polyethylene glycol, polypropylene glycol, and poly(oxyethylene-oxypropylene).

Examples of the saccharide include the water-soluble compounds listed in The Society of Polymer Science Polymer Laboratory Work Editing Committee ed., Natural Polymer, chap. 2 (1984), Sankyo Publishing Co., Ltd., and Yoshihira Oda, Modern Industrial Chemistry 22, Industrial Chemistry for Natural Product II (1967), Asakura Publishing Co., Ltd. Among these, the saccharide which does not have a free aldehyde group and a free ketone group, and is not reduced.

The saccharide is generally classified into glucose, sucrose, trehalose sucrose in which reduced groups are bonded, glucoside in which a reduced group of saccharide and non-saccharide are bonded, and sugar alcohol in which saccharide is hydrogenated and then reduced, and any of them can be suitably used in the present invention.

Specific examples of the saccharide include sucrose, trehalose, alkyl glucoside, phenol glucoside, mustard oil glucoside, D,L-arabite, ribitol, xylitol, D,L-sorbitol, D,L-mannitol, D,L-iditol, D,L-tahtol, dulcitol, allodulcitol, reduced starch syrup, and the like. These may be used singly or in combination of two or more.

Examples of the water-soluble polymer having a repeating unit containing a hydroxyl group and/or an amide group include: natural gum such as Arabia gum, guar gum, tolagand gum, or the like; polyvinyl pyrrolidone; dihydrixypropyl acrylate polymer; an adduction product of cellulose or chitosan and an epoxy compound (ethylene oxide or propylene oxide); and the like.

Among these, the polyol compounds such as alkylene polyol, polyalkyleneoxy polyol, sugar alcohol and the like are preferable.

The content of the compatibility accelerator is preferably 0.5% by mass to 25% by mass, and more preferably 1% by mass to 20% by mass with respect to the alkaline solution.

The alkaline solution optionally contains other additives. Examples of the additives include conventional additives such as a defoaming agent, an alkaline solution stabilizer, a pH buffer, an antiseptic agent, an antifungal agent, and the like.

The amount of other additives is preferably 0.001% by mass to 30% by mass, more preferably 0.005% by mass to 25% by mass in the alkaline solution.

[Coating Method in the Step of Applying an Alkaline Solution onto a Polymer Film]

As described above, the aforementioned alkali saponification of a polymer film using an alkaline solution is preferably carried out by the coating method that can treat only one side of the film. Examples of the coating method include a dip coating method, a curtain coating method, a bar coating method, a rod-coating method using a rod to which a fine metal string is coiled, a roll coating method using a forward roll coater, a reversal roll coater, or a gravure coater, a curtain coating method, a die coating method using an extrusion coater (slot coater), a slide coater, or a slit die coater, and the like. The coating systems are described in the various documents, such as Edward Cohen and Edger B. Gutoff, Ed., Modern Coating and Drying Technology (1992), VCH Publishers, Inc. The applied amount of the alkaline solution is desirably kept as small as possible in view of a liquid-waste disposal as it is washed with water after being applied. The applied amount thereof is preferably 1 m cc/m² to 100 cc/m², and more preferably 1 mL/m² to 50 mL/m². For coating, it is preferable that the rod coater, the gravure coater, the blade coater, or the die coater is used since it is stably operated with a small applied amount of the alkaline solution. Especially, the use of the die coater, which is a non-contact method where a coating device and a surface of the support to be coated are not contact to each other, is preferable as it enables a high-speed coating with a small applied amount, without generating unevenness of coating lines.

### [Washing]

After completion of the saponification reaction, it is preferable that the alkaline solution and reactants from the saponification reaction are washed off from the surface of the film by washing with water, or diluting (or neutralizing) and then washing with water. It is specifically described, for example, in International Publication No. WO02/46809.

### [Washing for Lowering Concentration of Alkaline Solution Present on a Polymer Film Using an Alkali Diluting Liquid Containing Water and Organic Solvent (Dilution Washing Process)]

In order to wash the applied alkaline solution, a method in which an alkali diluting liquid is applied, or a method in which an alkali diluting liquid is sprayed can be adopted. These methods are preferable for conducting the procedure while continuously transporting the polymer film. The method in which an alkali diluting liquid is sprayed can be carried out by using an alkali diluting liquid instead of water in the below-mentioned method in which water is sprayed. The method in which an alkali diluting liquid is applied will be mentioned below. The method in which an alkali diluting liquid is applied is a more preferable method, since it can be performed while minimizing the required amount of the alkali diluting liquid.

In the present invention, the alkaline solution present on the polymer film is diluted using an alkali diluting liquid that contains water, or water and an organic solvent. In the present invention, for diluting alkaline solution, alkali diluting liquid that contains water, or water and an organic solvent intended for lowering the alkali concentration, which will be described below. Instead of the alkali diluting liquid that contains water, or water and an organic solvent, it is also possible to use an acid solution (mentioned below) intended for lowering pH.

### (Alkali Diluting Liquid Containing Water and Organic Solvent)

Since the purpose of the use of alkali diluting liquid is to lower the alkali concentration, the alkali diluting liquid must be a solvent which dissolves the alkali chemicals in the alkaline solution. Thus, water, or a mixture of an organic solvent and water is employed. Two or more organic solvents may be used in combination. The above-mentioned organic solvents employed in the alkaline solution can be favorably used. For the alkali diluting liquid, it is preferable to use a solvent that contains: water; and one or more compounds selected from monovalent or polyvalent alcohols, ketones, and carboxylic acids that have 1 to 4 carbon atoms. Compounds having 5 or more carbon atoms are not preferable because they and water may be separated to form phases, and there may arise insufficient washing in the water washing process described below, which may cause defect in the polymer film prepared or in the optical film using the same.

Hereinafter, “alkali diluting liquid that contains water, or water and an organic solvent” may also be referred to as “alkali diluting liquid”

### (Application of Alkali Diluting Liquid Containing Water and Organic Solvent)

It is desirable that the alkali diluting liquid is applied by a continuous coating method by which the alkali diluting liquid can be applied further onto the polymer film already coated with the alkaline solution. The coating method can be similar to those described for the step of applying an alkaline solution. A roll coater (a forward roll coater, a reversal roll coater, or a gravure coater), or a rod coater can be preferably employed. In order to promptly mix the alkaline solution present on the polymer film and the alkali diluting liquid thereby lowering the alkali concentration, there is preferred a roll coater or a rod coater in which a flow is not uniform in a small area (also called a coating bead) where the alkali diluting liquid is applied, in comparison with a die coater in which such flow becomes a laminar flow. By using these coaters, the liquid present on the film surface can be reduced while diluting the alkaline solution.

Hereinafter, upstream side along the transporting direction of the film with respect to a coater is referred to as primary and downstream side is referred to as secondary.

The feeding amount of the alkali diluting liquid to the primary side of the coater used for applying an alkali diluting liquid (i.e., the side from which the alkaline solution after saponification reaction proceeds to the coater) is determined depending on the concentration of the alkaline solution and coating speed of the alkali diluting liquid. In case of a die coater which has a laminar flow in the coating bead, the feeding amount is preferably an amount so as to dilute the original alkali concentration 1.5 times to 10 times, and more preferably an amount so as to dilute 2 times to 5 times.

In the case of a roll coater or a rod coater, a flow in the coating bead is not uniform, thus causing a mixture of the alkaline solution and the alkali diluting liquid. This mixture is applied again in the secondary side of the coater. Therefore, in this case, the dilution ratio cannot be determined from the feeding amount of the alkali diluting liquid, and it is therefore necessary to measure the alkali concentration after the application of the alkali diluting liquid. In the case of a roll coater or a rod coater as well, the feeding amount is preferably an amount so as to dilute the original alkali concentration 1.5 times to 10 times, and more preferably an amount so as to dilute 2 times to 5 times.

The surface tension at 35° C. of the alkali diluting liquid is preferably 72 mN/m or less, and more preferably 35 mN/m to 72 mN/m. When the surface tension is within this range, the alkali diluting liquid spreads out the surface of the polymer film easily and makes it wet, leading to the stability of coating bead. When the surface tension of the diluting liquid is higher than 72 mN/m, the coating bead becomes unstable (shortage of liquid may occur in the primary side of the coater in some cases), causing optical defects (unevenness, etc.) in the saponified film or in the optical film using the same sometimes. When the surface tension is lower than 35 mN/m, hydrophobic components are extracted from the polymer film by the diluting liquid and adhered to the surface, causing optical defects (comet with nucleus, etc.) in the saponified film or in the optical film using the same sometimes.

### (Acid Solution)

In order to promptly terminate the saponification reaction by alkali, an acid solution may also be employed. In order to achieve neutralization with a small amount, a strong acid is preferable. Also in consideration of ease of water washing, it is preferable to select an acid of which salt formed after neutralization with alkali has a high solubility in water. Hydrochloric acid, nitric acid, sulfuric acid, phosphoric acid, chromic acid and acetic acid are particularly preferable.

For neutralizing the alkaline solution applied with the acid, there can be employed a method in which an acid solution is applied or a method in which an acid solution is sprayed. These methods are preferable for conducting the procedure while continuously transporting the polymer film. The method in which an acid solution is sprayed can be carried out by using an acid solution instead of water in the below-mentioned method in which water is sprayed. The method in which an acid solution is applied is a more preferable method, since it can be performed while minimizing the required amount of the acid solution.

It is desirable that the acid solution is applied by a continuous coating method by which the acid solution can be applied further onto the polymer film already coated with the alkaline solution. This is also true for the case where an acid solution is applied before the dilution with an alkali diluting liquid. When performed after the dilution with an alkali diluting liquid, it is desirable that the acid solution is applied by a continuous coating method by which the acid solution can be further applied onto the polymer film after the step of applying an alkaline solution and the dilution washing process with an alkali diluting liquid. The coating method can be similar to those described for the step of applying an alkaline solution. A roll coater (a forward roll coater, a reversal roll coater, or a gravure coater), or a rod coater (a rod to which a fine metal string is coiled) can be preferably employed. In order to promptly mix and neutralize an alkaline solution and an acid solution thereby lowering the alkali concentration, there is preferred a roll coater or a rod coater in which a flow is not uniform in a small area (also called a coating bead) where the acid solution is applied, in comparison with a die coater in which such flow becomes a laminar flow.

The applied amount of an acid solution is determined according to the kind of the alkali and the concentration of the alkaline solution. In case of a die coater which has a laminar flow in the coating bead, the applied amount of the acid is preferably 0.1 time to 5 times of the applied amount of the original alkali, more preferably 0.5 time to 2 times. In a roll coater or a rod coater, because of a nonuniform flow in the coating bead, the alkaline solution and the acid solution are mixed and the mixed solution is applied again in the secondary side of the coater. Therefore, in this case, the neutralization rate cannot be determined from the applied amount of the acid solution, and it is therefore necessary to measure the alkali concentration after the application of the acid solution. In a roll coater or a rod coater, it is preferable to determine the amount of the acid solution to be applied so as to obtain a pH value of 4 to 9 after the application of the acid solution, more preferably a pH value of 6 to 8.

As described above, the alkali diluting liquid or acid solution is mixed with the alkaline solution present on the polymer film, and the mixed solution is applied again on the film surface in the secondary side of the coater. That is, by reducing the amount of the liquid to be applied again after dilution or neutralization, the dilution washing process can suitably be performed. The amount of mixed solution to be applied again after dilution is preferably 3 mL/m² or less, and more preferably 1.5 mL/m². Further, when the dilution washing process is performed using two or more coaters, as will be mentioned below, the amount of mixed solution to be applied again is preferably the amount to be applied again at the first coater (the first coater used in the dilution washing process).

The dilution washing process may be performed using plural coaters. For example, in one aspect, while feeding an acid solution for neutralizing the alkaline solution present on the polymer film to the polymer film onto which the alkaline solution is applied with a rod coater for applying a first alkali diluting liquid and neutralizing, the amount of the liquid on the polymer film in the secondary side of the coater is reduced. Continuously, a diluting liquid containing an organic solvent is fed with a rod coater for the second dilution in order to wash hydrophilic contaminants on the surface of the polymer film to dilute the alkaline solution. The number of the coater used in the dilution washing process and provided continuously along the transporting direction of the polymer film is preferably 1 or more, more preferably 2 to 10, and the most preferably 2 to 5.

It is also possible to terminate the saponification reaction by lowering the temperature of the polymer film. The saponification reaction is substantially terminated by a sufficient temperature decrease from a state maintained at the room temperature or higher for accelerating the reaction. Cooling means is selected in consideration of a fact that one side of the polymer film is wet. For example, there can be preferably employed a cold air blowing to a surface opposite to the coated surface, or a contact heat conduction by a cooling roll. A film temperature after the cooling is preferably 5° C. to 60° C., more preferably 10° C. to 50° C. and the most preferably 15° C. to 30° C. The film temperature is preferably measured with a non-contact infrared thermometer. It is also possible to regulate the cooling temperature by a feedback control on the cooling means.

[Process in which Alkaline Solution is Washed from Polymer Film (Water Washing Process)]

In the present invention, after the aforementioned dilution washing process, a water washing process is performed in which the alkaline solution that has not been washed away by dilution or neutralization washing is washed away from the polymer film. The water washing process is carried out to remove the alkaline solution. In the case where the alkaline solution remains, the saponification reaction proceeds and, furthermore, the subsequent film formation of the alignment film and the liquid crystal molecule layer and the alignment of liquid crystal molecules are affected. The washing can be conducted by a method in which washing water is applied, a method in which washing water is sprayed, or a method in which the polymer film is dipped in a vessel containing washing water. The method in which washing water is applied and the method in which washing water is sprayed are preferable for conducting the procedure while continuously transporting the polymer film. The method in which washing water is sprayed is particularly preferable, since the washing water and the alkaline coating solution can be turbulently mixed on the polymer film owing to the jet flow.

Water can be sprayed by a method using a coating head (for example, a fountain coater, a flog mouth coater) or a method using a spray nozzle employed in humidifying the atmosphere, painting or automatically washing a tank. Coating systems are described in “All about Coating”, ed. by Masayoshi Araki, Kako Gijutsu KenKyukai Co., Ltd. (1999). Conical or fan-shaped spray nozzles may be placed, such that they are aligned in the width direction of the polymer film and water is sprayed onto the whole width of the film. Commercially available spray nozzles (for example, products manufactured by H. Ikeuchi & Co., Ltd. or Spraying System Co., Ltd.) may be used.

The higher the water spraying speed is, the more turbulently they are mixed. However, if the spraying speed is too high, the continuously transported polymer film runs unstably in some cases. The spraying collision speed is preferably in the range of 50 cm/sec to 1,000 cm/sec, more preferably in the range of 100 cm/sec to 700 cm/sec, and the most preferably in the range of 100 cm/sec to 500 cm/sec.

The amount of washing water is more than the amount derived from the theoretical dilution ratio defined below:

Theoretical dilution ratio=amount of washing water used [cc/m²]/applied amount of the alkaline solution [cc/m²]

Namely, the theoretical dilution ratio is based on the assumption that all of the water used contributes to dilution of the alkaline coating solution. Practically, however, complete mixing would not occur, and hence it is needed to use the washing water in an amount larger than that expected from the theoretical dilution ratio. The amount of washing water depends on the alkali concentration of the alkaline coating solution used, auxiliary additives and the solvent. The washing water is used in an amount that gives a theoretical dilution of at least 100 to 1,000 times, preferably 500 to 10,000 times, more preferably 1,000 to 100,000 times.

It is preferable to control the variation in the sprayed amount of water within 30% in the width direction of the running polymer film or in terms of spraying time. At the both edges of the polymer film, the alkaline solution and the neutralizing acidic solution are often applied in much amount. For washing well the area where much amount of the solutions is applied, a larger amount of water may be sprayed on the both edges in the width direction. If a coating head is used, the slit clearance, from which water is jetted out, is widened so that the both edges can be washed with much amount of water. Alternatively, a narrow coater may be additionally provided for locally supplying washing water to the edges. A plural number of narrow coaters may be provided. In the case of using a spray nozzle, an additional nozzle may be provided for locally spraying washing water to the edges.

In the case where a predetermined amount of water is used in the water-washing, a batch type washing method in which the water is applied or sprayed in several times is preferable rather than applying or spraying the total volume of water at once. Namely, the water is divided into several portions and supplied to a plural number of washing means provided in tandem in the transporting direction of the polymer film. These washing means are located at an appropriate interval so that the water may diffuse to dilute the alkaline solution well. More preferably, the polymer film is conveyed at an angle so that the water may run on the film. not only the diffusion but also the flow of water promotes mixing dilution. In the most preferable method, draining means for removing a water film on the polymer film are provided among the several washing means so as to further improve the water-washing and dilution efficiency. Specific examples of the draining means include a blade used in a blade coater, an air-knife used in an air-knife coater, a rod used in a rod coater and a roll used in a roll coater. The more the washing means are provided in tandem, the more advantageous it is. However, from the viewpoint of space and cost for the equipment, the number of washing means is normally from 2 to 10, preferably from 2 to 5.

It is preferable that the water film be as thin as possible after the film passes through the draining means, but its thickness is limited according to the draining means used. If the draining means is a solid medium physically contacting the polymer film, such as a blade, rod or roll, it is liable to scratch the film surface or to wear down even if the medium is made of an elastic material having a low hardness such as rubber. Accordingly, the water film having a certain thickness is indispensable since it serves as a lubricating fluid. The thickness of the water film is normally several μm or more, preferably 10 μm or more.

As the draining means, an air-knife is preferred since the water film can be made the thinnest. By using sufficient blowing amount and blowing pressure, the water film thickness can be reduced to close to zero. However, if the amount of blowing air is too much, the polymer film flaps or waves, affecting the transfer stability of the polymer film. For the range of the blowing air speed to be used, the blowing air speed is usually from 10 m/sec to 500 m/sec, preferably from 20 m/sec to 300 m/sec and the more preferably from 30 m/sec to 200 m/sec, though it varies depending on the original water film thickness on the polymer film and the transferring speed of the film. In order to remove evenly the water film, the blowing port of an air-knife or the method of supplying air to the air-knife is selected so that the blowing speed distribution along the width of the polymer film may be normally 10% or less, preferably 5% or less. The gap between the surface of the polymer film being transferred and the blowing port of the air-knife is adequately determined. The smaller the gap is, the better the water film is removed. However, if the gap is too small, the air-knife is liable to come into contact with the polymer film and damage it. Accordingly, the air-knife is set up so that the gap may be normally from 10 μm to 10 cm, preferably from 100 μm to 5 cm and the more preferably from 500 μm to 1 cm. On the opposite side to the washed face of the polymer film, back-up rolls are preferably provided so that they may face to the air-knife. The back-up rolls make it easy to set the gap adequately and can relieve undesirable effects caused by the flapping, wrinkling and deforming of the film.

As the washing water, purified water is preferably employed. It is preferred that the purified water to be used in the present invention has a specific electrical resistivity of at least 0.1 MΩ and contains metal ions such as sodium, potassium, magnesium and calcium ions in an amount of less than 1 ppm and anions such as chlorine and nitrate in an amount of less than 0.1 ppm. The purified water can be obtained by using a reverse osmosis membrane, an ion-exchange resin, distillation or by a combination thereof.

The higher the temperature of the washing water is, the better the polymer film is washed. However, when water is sprayed onto the polymer film being transferred, water comes in contact with air in a large surface area and hotter water vaporizes more, resulting in the elevation of the environmental humidity. Consequently, dew is more likely to be formed. Therefore, the temperature of the washing water is usually controlled in the range of 5° C. to 90° C., preferably in the range of 25° C. to 80° C. and the preferably in the range of 25° C. to 60° C.

In the present invention, the polymer film is preferably washed also by applying washing solution using a roll coater (a forward roll coater, a reversal roll coater, or a gravure coater), or a rod coater, similar to those described for the dilution washing process mentioned above. Application of washing solution is suitably carried out by draining water using the air-knife mentioned above.

It is also possible to conduct a step of drying after the washing process. Usually, the water film can be sufficiently removed by a draining means such as an air-knife and thus no drying process is needed in some cases. However, the polymer film may be dried by heating to attain a preferable moisture content before rolling it. On the contrary, the moisture content may be controlled by using a moist air stream having a defined humidity. The temperature of the drying air stream is preferably from 30° C. to 200° C., more preferably from 40° C. to 150° C. and the most preferably from 50° C. to 120° C.

It is preferable that each step mentioned above is performed while transferring a polymer film, and further it is preferable that each step is continuously performed while transferring a polymer film.

The surface-saponified polymer film of the present invention can be obtained by performing the alkali saponification as described above.

[Film Surface Property after Saponification]

### (Variation in Phosphorus Element Along the Width Direction)

It is preferable that the variation in phosphorus element on the surface of the polymer film along the width direction after completion of the saponification treatment by the aforementioned alkali saponification method, as measured by ESCA, is less than 0.005. It is more preferable if the variation along the width direction is less than 0.004. The reason for this is not known, but it is likely that a phosphorus containing plasticizer, a component of the film, changes the optical properties of the optical compensation film. Therefore, it is presumed that when the variation in phosphorus is small, unevenness is reduced.

The variation is measured as follows. Specifically, 9 samples are taken along the width direction with respect to the saponification direction of the polymer film. Using a photoelectron spectrometer (ESCA750, manufactured by Shimadzu Corporation), the amounts of carbon atom and phosphorus atom on the film surface subjected to saponification treatment are measured as a peak value with respect to the base line of C1s and P2p, respectively, and the area ratio is calculated as P value (P/C). The difference between the maximum value and the minimum value is defined as the variation along the width direction.

### <Alignment Film Layer>

The alignment film (layer) of the present invention contains a polymer having a radical polymerizable group, and a polymerization initiator capable of reacting with the radical polymerizable group and/or a compound capable of reacting with the radical polymerizable group and having two or more vinyl groups, wherein the content of the polymerization initiator is from 0.05% by mass to 30.0% by mass with respect to the polymer having a radical polymerizable group, and the content of the compound having two or more vinyl groups is from 0.10% by mass to 30% by mass with respect to the polymer having a radical polymerizable group.

### —Polymer Having a Radical Polymerizable Group—

Examples of the radical polymerizable group of the aforementioned polymer having a radical polymerizable group include an acryloyl group, a methacryloyl group, a styryl group, an aryl group, a vinyl benzyl group, a vinyl ether group, a vinyl alkylsilyl group, a vinyl ketone group, and an isopenyl group. Among these, the acryloyl group and the methacryloyl group are preferable.

The aforementioned polymer is a polymer capable of self-crosslinking, or a polymer which is crosslinked using a crosslinking agent. Two or more of these polymers can be used in combination. Examples of such polymers are those compounds listed in the paragraph of JP-A No. 08-338913.

Examples of the above-mentioned polymer include polymers such as polymethyl methacrylate, an acrylic acid/methacrylic acid copolymer, a styrene/maleinimide copolymer, polyvinyl alcohol, modified polyvinyl alcohol, poly(N-methylolacrylamide), a styrene/vinyltoluene copolymer, chlorosulfonated polyethylene, nitrocellulose, polyvinyl chloride, chlorinated polyolefin, polyester, polyimide, a vinyl acetate/vinyl chloride copolymer, an ethylene/vinyl acetate copolymer, carboxymethylcellulose, polyethylene, polypropylene, and polycarbonate and compounds such as silane coupling agents.

Preferred examples of the polymer include water-soluble polymers such as poly(N-methylolacrylamide), carboxymethylcellulose, gelatin, polyvinyl alcohol, and modified polyvinyl alcohol, more preferred are gelatin, polyvinyl alcohol, and modified polyvinyl alcohol, and particularly preferred are polyvinyl alcohol and modified polyvinyl alcohol.

Specific examples of the polymer having a radical polymerizable group include those listed in the paragraphs—of JP-A No. 09-152509. Among these, the modified polyvinyl alcohol expressed by the following general formula (1) described in the paragraph of JP-A No. 09-152509 is preferable:

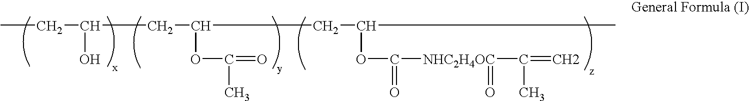

### —Compound Having Two or More Vinyl Groups—

Examples of the compounds capable of reacting with a radical polymerizable group and having two or more vinyl groups include (poly)oxyalkylene glycol di(meth)acrylates such as (poly)ethylene glycol di(meth)acrylate, diethylene glycol di(meth)acrylate, triethylene glycol di(meth)acrylate, tetraethylene glycol di(meth)acrylate, and (poly)propylene glycol di(meth)acrylate; pentaerythritol tetra(meth)acrylate, pentaerythritol tri(meth)acrylate, pentaerythritol di(meth)acrylate, trimethylolpropane tri(meth)acrylate, dipentaerythritol hexa(meth)acrylate, dipentaerythritol penta(meth)acrylate, polyoxyethylene sorbitol tri(meth)acrylate, polyethylene glycol divinyl benzyl ether, triethylene glycol diallyl ether, and glycerol tri(meth)acrylate, glycerol di(meth)acrylate; vinyl compounds such as divinylbenzene, 1,4-divinyloxybutane and divinyl sulfone; allyl compounds such as diallyl phthalate, diallyl acrylamide, triallyl(iso)cyanurate and triallyl trimellitate; and the like. These compounds having two or more vinyl groups may be used alone or two or more may be used in combination.

Among the aforementioned compounds having two or more vinyl groups, water-soluble compounds such as (poly)ethylene glycol di(meth)acrylate and (poly)propylene glycol di(meth)acrylate are preferable, and triethylene glycol di(meth)acrylate and tetraethylene glycol di(meth)acrylate that are represented by the general formulae (II-B) and (III-B) are more preferable.

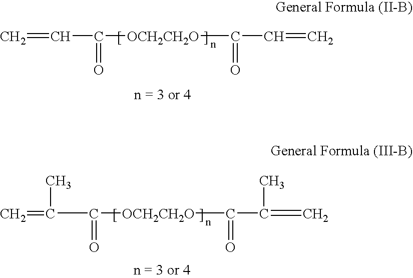

The content of the compound capable of reacting with the radical polymerizable group and having two or more vinyl groups is preferably from 0.1% by mass to 30.0% by mass, more preferably 0.5% by mass or more to less than 20.0% by mass, and the most preferably 1% by mass or more to less than 10% by mass, with respect to the total solid content of the polymer contained in the alignment film layer. If the content of the compound is less than 0.1% by mass, the alignment film layer is swollen under the conditions of high temperature and high humidity due to the moisture and optical compensation films with excellent durability cannot be obtained.

If the content of the compound is more than 30% by mass, alignment inferior is caused and the optical compensatory function of the optical compensation film is deteriorated.

### —Polymerization Initiator—

The alignment film contains a polymerization initiator in order to accelerate the polymerization reaction of a reactive group (e.g. (meth)acryloyl group) contained in the alignment film. The polymerization initiator is preferably photo-radical polymerization initiators in terms of production efficiency, but thermal radical polymerization initiators may be used.

The content of the polymerization initiator is preferably in the range of 0.05% by mass or more to less than 30.00% by mass, more preferably in the range of 0.10% by mass or more to less than 10.00% by mass, further more preferably in the range of 0.25% by mass or more to less than 5.00% by mass, and the most preferably in the range of 0.50% by mass or more to less than 3.00% by mass, with respect to the total solid content of the polymer contained in the alignment film. In the case where the content of the polymerization initiator is less than 0.05% by mass, the curing of the alignment film becomes insufficient, and the alignment film is swollen under the condition of high humidity and thus humidity-heat endurance is lowered.

In the case where the content of the polymerization initiator is more than 30.00% by mass, the process of curing of the alignment film is progressed more than necessary, the formation of an optical anisotropic layer on the alignment film becomes insufficient in the process of forming the optical anisotropic layer, which will be described later, and thus the optical anisotropic layer has an inferior orientation.

The water solubility of the polymerization initiator is preferably 0.01% by mass to 5.00% by mass, more preferably 0.01% by mass to 4.00% by mass, and the most preferably 0.001% by mass to 3.00% by mass in the water having the temperature of 25° C. In the case where the water solubility of the polymerization initiator is less than 0.01% by mass, the curing of the alignment film becomes insufficient, and the alignment film is swollen under the condition of high humidity and thus humidity-heat endurance is lowered.

The maximum absorption wavelength of such a polymerization initiator is preferably from 200 nm to 350 nm. This is because when the maximum absorption wavelength is less than 200 nm, selection of light source is restricted, and when it is more than 350 nm, the optical compensation film is colored, which is not preferable in terms of the quality. Irgacure 2959 (manufactured by Nihon Chiba-Geigy K. K., maximum absorption wavelength λmax: 274 nm) and WS triazine (manufactured by SANWA Chemical Co., Ltd, maximum absorption wavelength λmax: 241 nm) represented by the following general formulae (II-A) and (III-A), respectively.

The polymerization initiator can be contained in the alignment film by being crosslinked with a polymer, or contained as a molecule itself.

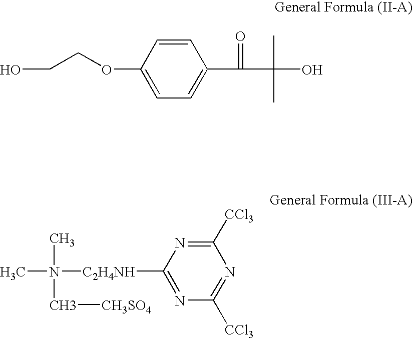

The reaction between the polymer having a radical polymerizable group and the polymerization initiator and/or the compound having two or more vinyl groups can be performed by ionizing radiation or by heating.

The reaction is preferably performed by UV irradiation in terms of production efficiency.

The UV irradiation may be performed directly on the alignment film layer, or may be performed after an optical anisotropic layer is disposed on the alignment film layer. The UV irradiation may be performed several times. It is preferable to perform UV irradiation after liquid crystal compounds are disposed in terms of production efficiency. In addition, a thermal radical initiator or photo-radical initiator may be used for accelerating the reaction.

The water solubility of the compound having two or more vinyl groups, or the polymerization initiator is defined as follows. When the compound having two or more vinyl groups or the polymerization initiator is added dropwise to 100 g of water at 25° C. and stirred for 1 hour, the maximum (saturated) amount of the compound having two or more vinyl groups or the polymerization initiator that can be dissolved is defined as the water solubility of the compound having two or more vinyl groups, or the polymerization initiator. In the present invention, the solubility of the compound having two or more vinyl groups to water is preferably 0.01 to 5.0, more preferably 0.1 to 5.0, and the most preferably 0.5 to 5.0.

It is undesirable that the water solubility of the compound having two or more vinyl groups or the polymerization initiator is less than 0.01, because cratering defects arise on the surface of the alignment film layer. When it is more than 5.0, the hydrophilicity of the alignment film layer is increased and thus durability under the conditions of high temperature and high humidity is poor.

### —Saponification Degree—

The aforementioned polyvinyl alcohol and modified polyvinyl alcohol have the saponification degree of preferably 70% to 100%, more preferably 80% to 100%, and the most preferably 85% to 95%. The polymerization degree thereof is preferably in the range of 100 to 3,000.

The modified group of the modified polyvinyl alcohol is introduced by copolymerization modification, chain transfer modification, block polymerization modification, or the like. Examples of the modified group include: hydrophilic groups such as a carboxyl group, a sulfonic group, a phosphonoic group, an amino group, an ammonium group, an amido group, a mercapt group, and the like; C10-100 hydrocarbon groups; fluorine-substituted hydrocarbon groups; sulfide groups; polymerizable groups such as an unsaturated polymer group, an epoxy group, an aziridinyl group, and the like; alkoxysilyl groups such as a trialkoxysilyl group, a dialkoxysilyl group, a monoalkoxysilyl group, and the like. Specific examples of these modified polyvinyl alcohol compounds are those listed in the paragraphs—of JP-A No. 09-152509, the paragraph of JP-A No. 2000-56310, the paragraphs—of JP-A No. 2000-155216, and the paragraphs—of JP-A No. 2002-62426. In the case where the orientation treatment is carried out by irradiating light, it is necessary to contain a photo-orientation group which exhibits the function of photoinduced orientation within a molecule of the aforementioned polymer. Examples of the photo-orientation group include: those listed in Masaki Hasegawa (1999), Liquid Crystal, vol. 3(1), pp. 3-16; photo-orientation groups containing a C═C bonding and capable of exhibiting a photoinduced orientation as a result of a photo-dimerization reaction, such as a polyene group, a stilbene group, a stilbazole group, a stilbazolium group, a cinnamoyl group, a hemithioindigo group, a chalcone group, and the like; and photo-orientation groups containing a C═O bonding and capable of exhibiting a photoinduced orientation as a result of a photo-dimerization reaction, such as groups containing the structure of a benzophenone group, a coumarin group, or the like. Specific examples thereof are those listed in JP-A No. 2000-122069, and the paragraph of JP-A No. 2002-317013.

### —Crosslinking Agent—

The crosslinking agent used for the polymer for use in the alignment film, e.g. preferably a water-soluble polymer, more preferably polyvinyl alcohol or modified polyvinyl alcohol, is for example, aldehyde, a N-methylol compound, a dioxane derivative, a compound which functions by activating a carboxyl group, an activated vinyl compound, an activated halogen compound, isoxazole, dialdehyde starch, or the like. Specific examples thereof include the compounds listed in the paragraphs—of JP-A No. 2002-62426. Among these, aldehyde having high reaction activity is preferable, and glutaraldehyde is particularly preferable.

### —Content of Crosslinking Agent—

The content of the crosslinking agent is preferably 0.1% by mass to 20% by mass, and more preferably 0.5% by mass to 15% by mass with respect to the amount of the polymer. The amount of the crosslinking agent which remained in the alignment film without reacting is preferably 1.0% by mass or less, and more preferably 0.5% by mass or less. When the residual amount of the crosslinking agent is equal to or less than the aforementioned value, a sufficient durability can be provided to the alignment film and thus it is preferable. If such the alignment film is used for a liquid crystal display device, reticulation would not be caused even when it is used for a long-period of time or left in the high temperature and high humidity condition for a long-period of time.

### —Carboxylic Acid Compound—

The compositions for the alignment film preferably contain a certain carboxylic acid compound. By containing the carboxylic acid compound, the excellent condition of the coating surface of the optical compensation sheet which is obtained by coating an optical anisotropic layer after aligning the formed alignment film by means for aligning can be attained, the optical defects such as white-out or the like can be reduced or improved.

The reason for this is probably because the certain carboxylic acid compound contained in the alignment film stabilizes the concentration of hydrogen ions and the like in the surface of the alignment film, and the effect to the alignment condition of the liquid crystal molecules is reduced when the optical anisotropic layer is coated.

Moreover, in the case where the surface of the transparent support is hydrophilized by an alkali saponification treatment, the alignment film having excellent optical properties can be stably formed even though there is the residual treatment solution on the surface of the transparent support. The effect of the carboxylic acid compound is varied depending on the added amount thereof, and thus the amount thereof needs to be adjusted. Specific examples of the carboxylic acid compound include those listed in the paragraphs—of JP-A No. 2005-115341.

The alignment film is theoretically a cured film formed by applying a coating liquid of the composition for the alignment film containing the polymer, the polymerization initiator, the crosslinking agent, and the carboxylic acid compound on the transparent support, heating and drying so as to crosslink, and applying the alignment treatment. Namely, the alignment film is preferably a cured film which is obtained by coating the compositions for the alignment film containing polyvinyl alcohol and/or modified polyvinyl alcohol as a main substance, and drying. The crosslinking reaction can be carried out at any arbitrary selected time after the compositions for the alignment film is coated on the transparent support.

The method for applying the alignment film is not particularly limited and may be appropriately selected depending on the purpose. Examples thereof include spin coating, dip coating, curtain coating, extrusion coating, rod coating and roll coating. Among these, rod coating is preferred.

The solid concentration of the composition for the alignment film is preferably 0.5% by mass to 3.0% by mass. When the solid concentration is less than 0.5% by mass, it becomes difficult to dry. An alignment film with sufficient hardness may not be obtained occasionally even in the case where the degree of cross-linking in the alignment film layer is increased by adding a compound having two or more vinyl groups and the durability under the conditions of high temperature and high humidity is improved as in the present invention. On the other hand, when the solid concentration is more than 3.0% by mass, the leveling of the coating liquid of the composition for the alignment film during drying is not sufficient, causing unevenness of coating in the alignment film and the resulting unevenness of the optical anisotropic layer. Thus, an optical compensation film, polarizing plate, or liquid crystal display device that is excellent in exterior properties cannot be obtained. In particular, this is problematic for the liquid crystal display device for TV applications, in which enhanced luminance and high-resolution are required.

Thus, the thickness of the alignment film after drying is preferably 0.01 μm to 5 μm, more preferably 0.05 μm to 1 μm, and the most preferably 0.07 μm to 0.4 μm.

In the case that the water-soluble polymer such as polyvinyl alcohol is used as a composition for the alignment film, the coating liquid is preferably a mixed solvent of an organic solvent having a defoaming effect (e.g. methanol, ethanol, and isopropanol) and water. The mixing ratio of the water and the organic solvent, e.g. methanol, (water/organic solvent) is preferably 0/100 to 99/1, and more preferably 0/100 to 91/9 on the mass basis. If the mixed solvent having the mixing ratio within this range is used for the coating liquid, the formation of forms is inhibited, and the defects on the surface of the alignment film and also the surface of the optical anisotropic layer can be significantly reduced.

The alignment film is obtained by, after curing the polymer layer as described above, providing the rubbing treatment to the surface thereof.

The rubbing treatment can be selected from the treatments widely applied in the liquid crystal alignment process for the liquid crystal display device. Namely, the rubbing treatment can be performed for example by rubbing the surface of the alignment film in a certain direction using paper, gauze, felt, rubber, nylon, polyester fiber, or the like, to thereby attain the alignment. Generally, it is performed by carrying out rubbing a few times using a cloth in which fibers having a uniform length and thickness are uniformly implanted.

In the case where the optical alignment is performed by light irradiation, the light source of the radiation device is selected from an ultra-high pressure mercury lamp, a xenon lamp, a fluorescence lamp, a laser, and the like. In order to optically align the photo-dimerization compound, the light source and the polarizer are combined to make ultraviolet ray to a linearly polarized light via the polarizer, and such the light is irradiated to the optical alignment film.

As the polarizer, a stretched and dyed PVA (polyvinyl alcohol) is generally used. Examples of the linearly polarized ultraviolet ray irradiation device include those disclosed in JP-A No. 10-90684.

### <Optical Anisotropic Layer>

The optical anisotropic layer is preferably designed so as to compensate a liquid crystal compound of a liquid crystal cell in the black display of the liquid crystal display device. The alignment state of the liquid crystal compound of the liquid crystal cell in the black display is different depending on the mode of the liquid crystal display device. The alignment state of the liquid crystal compound in the liquid crystal cell is described in IDW'00, FMC7-2, pp. 411-414.

The optical anisotropic layer contains liquid crystal molecules. The liquid crystal molecules for use in the optical anisotropic layer contain rod-shaped liquid crystal molecules and discotic compounds.

The rod-shaped liquid crystal molecule and discotic compound may be polymer liquid crystal or low molecular liquid crystal, and may also contain the one which has lost the characteristics of liquid crystal as a result of that the low molecular liquid crystals are crosslinked.

The optical anisotropic layer is formed by applying a coating liquid containing the liquid crystal molecules, and optionally a polymerization initiator and other substances, onto the alignment film.

### [Rod-Shaped Liquid Crystal Compound]

Examples of the rod-shaped liquid crystal compound that can be used for the present invention include azomethine, azoxy, cyanobiphenyl, cyanophenyl ester, benzoic acid ester, cyclohexanecarboxylic acid phenyl ester, cyanophenylcyclohexane, cyano-substituted phenylpyrimidine, alkoxy-substituted phenylpyrimidine, phenyldioxane, tolan, and alkenylcyclohexylbenzonitrile.

Examples of the rod-shaped liquid crystal compound further include metal complexes. A liquid crystal polymer containing a rod-like liquid crystal compound in its repeating unit can also be used. In other words, the rod-shaped liquid crystal compound may be bonded to a (liquid crystal) polymer.

Rod-shaped liquid crystal compounds have been described in Chapter 4, Chapter 7, and Chapter 11 of Quarterly Chemical Review Vol. 22 “Chemistry of Liquid Crystals” (1994) edited by the Chemical Society of Japan and Chapter 3 of the “Liquid Crystal Device Handbook” edited by the 142nd Committee of the Japan Society for the Promotion of Science.

The birefringence of the rod-shaped liquid crystal compound used for the present invention is preferably in a range of 0.001 to 0.7.

The rod-shaped liquid crystal compound preferably has a polymerizable group for fixing its alignment state. The polymerizable group is preferably an unsaturated polymerizable group or an epoxy group, more preferably, an unsaturated polymerizable group, and particularly preferably, an ethylenically unsaturated polymerizable group.

### [Discotic Liquid Crystal Compound]

Examples of the discotic liquid crystal compound include benzene derivatives described in a study report by C. Destrade et al., Mol. Cryst. Liq. Cryst., Vol. 71, page 111 (1981); truxene derivatives described in a study report by C. Destrade et al., Mol. Cryst., Vol. 122, page 141 (1985) and Physics Lett. A, Vol. 78, page 82 (1990); cyclohexane derivatives described in a study report by B. Kohne et al., Angew. Chem., Vol. 96, page 70 (1984); and azacrown-based or phenylacetylene-based macrocycles described in a study report by J. M. LIehn et al., J. Chem. Commun., page 1794 (1985) and a sturdy report by J. Zhang et al., J. Am. Chem. Soc., Vol. 116, page 2655 (1994).

The examples of the discotic liquid crystal compound also include compounds having a structure with a core at the center of the molecule on which straight alkyl, alkoxy, or substituted benzoyloxy groups are radially substituted as side chains of the core and exhibiting crystallinity. It is preferable that the discotic liquid crystal compound has rotation symmetry in the form of a molecule or a molecular assembly and can be provided with a certain alignment.

When the first optically anisotropic layer is formed from a discotic liquid crystal compound, the compound that is finally included in the first optically anisotropic layer no longer needs to exhibit liquid crystallinity.

When, for example, a low-molecular discotic liquid crystal compound has heat- or light-reactive groups and the groups are reacted by heat or light and polymerized or crosslinked to have a high molecular weight, whereby a first optically anisotropic layer is formed, the compound contained in the first optically anisotropic layer may no longer have crystallinity.

Preferred examples of the discotic liquid crystal compound have been described in JP-A No. 08-50206. In addition, there is a description of polymerization of a discotic liquid crystal compound in JP-A No. 08-27284.

In order to fix the discotic liquid crystal compound by polymerization, it is necessary to bond a polymerizable group as a substituent to a discotic core of the discotic liquid crystal compound. However, when a polymerizable group is directly bonded to the discotic core, it becomes difficult to maintain an alignment state in a polymerization reaction. Therefore, a linking group is introduced between the discotic core and the polymerizable group.

Accordingly, the discotic liquid crystal compound having a polymerizable group is preferably a compound expressed by the following general formula (IV).

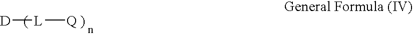

In the above general formula (IV), D denotes a discotic core, L denotes a divalent linking group, Q denotes a polymerizable group, and n denotes an integer of 4 to 12.

Examples (D1) to (D15) of the discotic core (D) are shown in the following. In the following respective examples, LQ (or QL) means a combination of a divalent linking group (L) and a polymerizable group (Q).

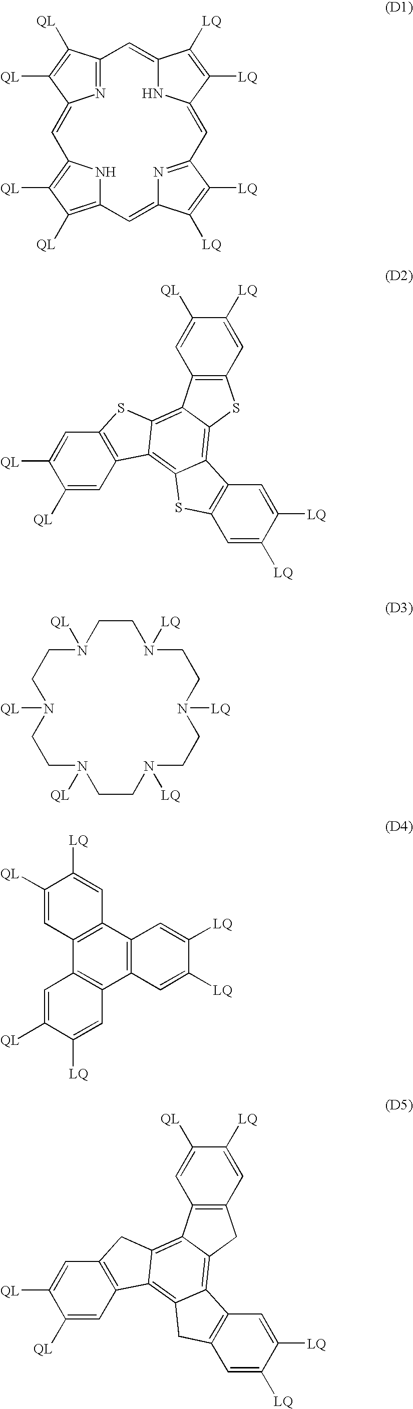

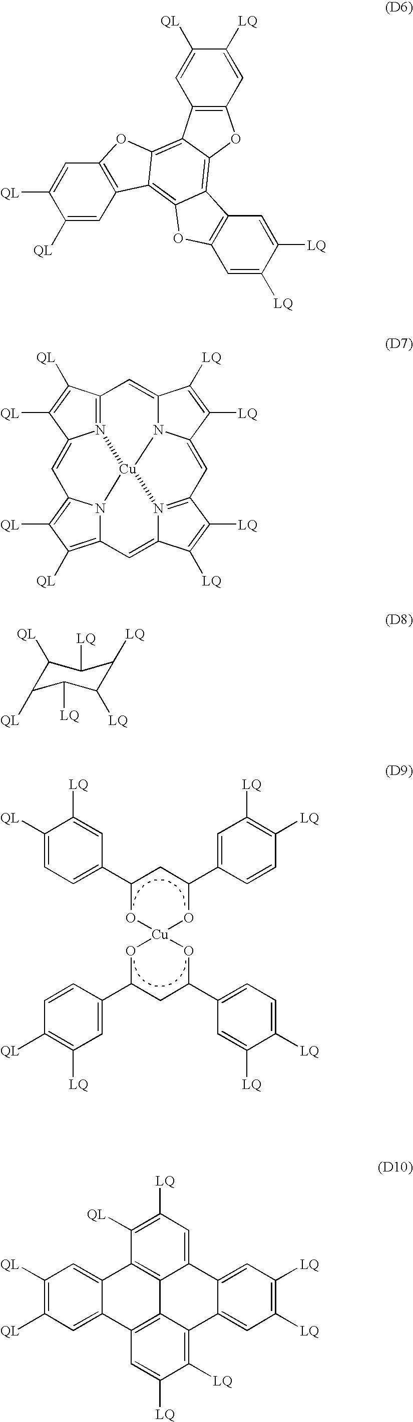

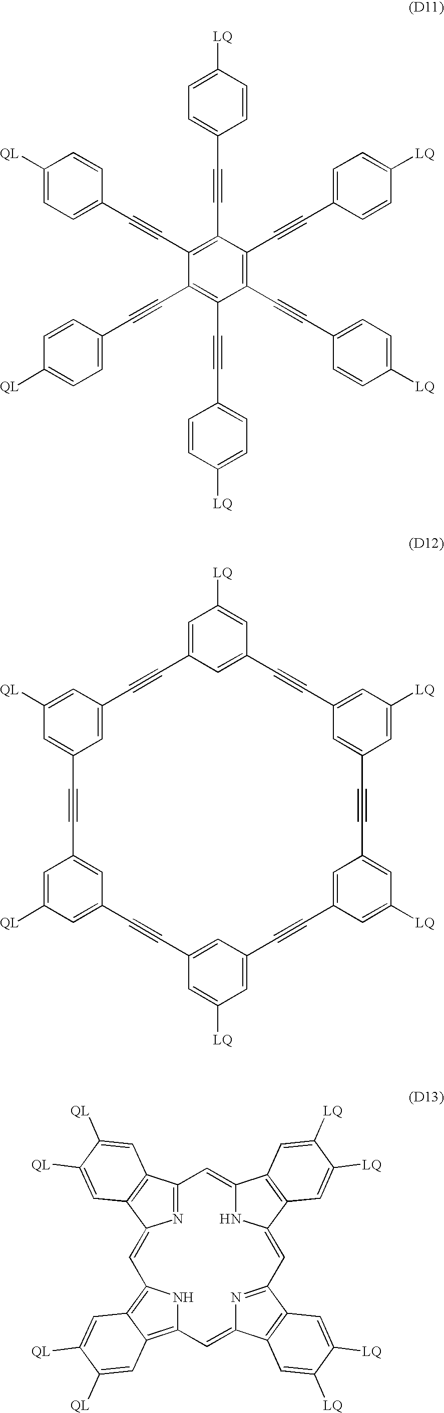

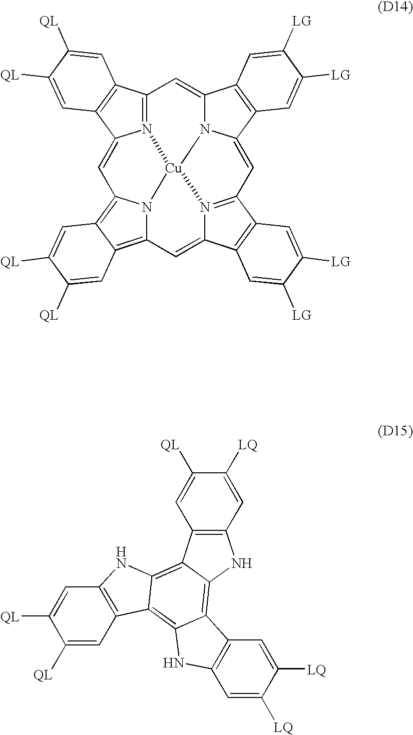

Moreover, in the above general formula (IV), the divalent linking group (L) is preferably a divalent linking group selected from a group consisting of an alkylene group, an alkenylene group, an arylene group, —CO—, —NH—, —O—, —S—, and combinations thereof.

The divalent linking group (L) is more preferably a divalent linking group of a combination of at least two divalent groups selected from a group consisting of an alkylene group, an alkenylene group, an arylene group, —CO—, —NH—, —O—, and —S—.

The divalent linking group (L) is particularly preferably a divalent linking group of a combination of at least two divalent groups selected from a group consisting of an alkylene group, an arylene group, —CO—, and —O—.

The number of carbon atoms of the alkylene group is preferably 1 to 12. The number of carbon atoms of the alkenylene group is preferably 2 to 12. The number of carbon atoms of the arylene group is preferably 6 to 10.

Examples (L1 to L24) of the divalent linking group (L) are shown in the following. The left side bonds to the discotic core (D), and the right side bonds to the polymerizable group (Q). AL means an alkylene group or an alkenylene group, while AR means an arylene group. Also, the alkylene group, the alkenylene group, and the arylene group may have a substituent (e.g. an alkyl group).

### L1: -AL-CO—O-AL-

### L2: -AL-CO—O-AL-CO—

### L3: -AL-CO—O-AL-O-AL-

### L4: -AL-CO—O-AL-O—CO—

### L5: —CO-AR-O-AL-

### L6: —CO-AR-O-AL-CO—

### L7: —CO-AR-O-AL-O—CO—

### L8: —CO—NH-AL-

### L9: —NH-AL-CO—

### L10: —NH-AL-O—CO—

### L11: —O-AL-

### L12: —O-AL-O—

### L13: —O-AL-O—CO—

### L14: —O-AL-O—CO—NH-AL

### L15: —O-AL-S-AL-

### L16: —O—CO-AL-AR-O-AL-O—CO—

### L17: —O—CO-AR-O-AL-CO—

### L18: —O—CO-AR-O-AL-O—CO—

### L19: —O—CO-AR-O-AL-O-AL-O—CO—

### L20: —O—CO-AR-O-AL-O-AL-O-AL-O—CO—

### L21: —S-AL-

### L22: —S-AL-O—

### L23: —S-AL-O—CO—

### L24: —S-AL-S-AL-

### L25: —S-AR-AL-

The polymerizable group (Q) of the general formula (IV) is selected depending on a polymerization reaction. Examples of the polymerizable group (Q) are presented below:

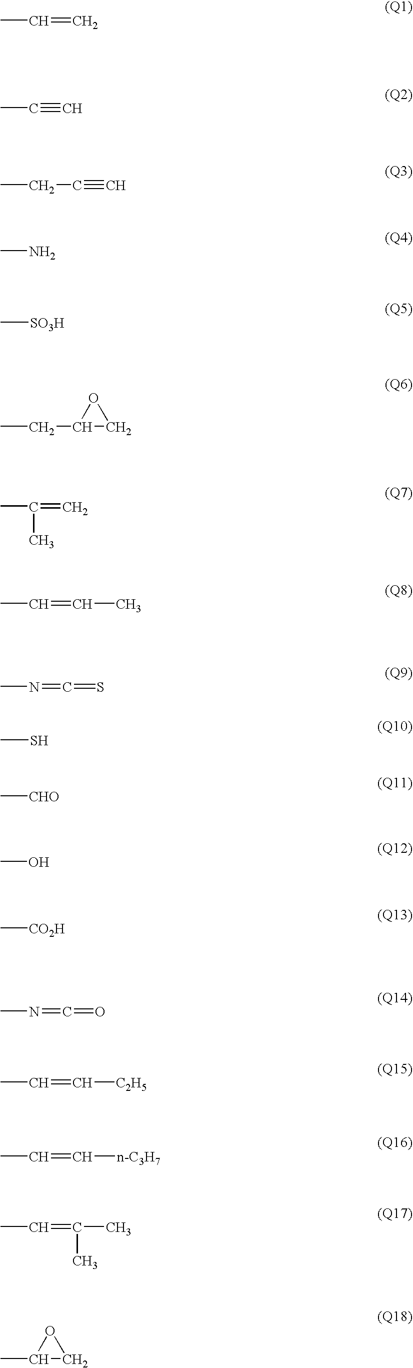

The polymerizable group (Q) of the general formula (IV) is preferably the unsaturated polymerizable group (Q1, Q2, Q3, Q7, Q8, Q15, Q16, or Q17) or the epoxy group (Q6 or Q8), more preferably the ethylene unsaturated polymerizable group (Q1, Q7, Q8, Q15, Q16, or Q17). The specific value for n is determined depending on the type of the discotic core (D). Note that, L(s) and Q(s) are respectively the same or different in the combination of plurality of L and Q, but it is preferable that L(s) and Q(s) are respectively the same.

In a hybrid alignment, the angle between the long axis (disc face) of the discotic compound and the plane of the support, i.e. the tilt angle, increases or decreases as the distance in the depth direction of the optically anisotropic layer and from the plane of the polarizer increases. The angle preferably decreases with a decrease in distance.

Furthermore, the variation in angle is, for example, a continuous increase, a continuous decrease, an intermittent increase, an intermittent decrease, a variation including a continuous increase and a continuous decrease, or an intermittent variation including an increase and a decrease. In the case of an intermittent variation, included is a region where the tilt angle does not vary in the middle of the thickness direction.

As for the angle, there may be a region where the angle does not vary as long as the angle as a whole increases or decreases. Furthermore, it is preferable that the angle varies continuously.

The average direction of the long axes (disc face) of the discotic compound can be generally adjusted by selecting the material of the discotic compound or the alignment film or by selecting a rubbing treatment method.

Moreover, the long axis direction (disc face) of the discotic compound on the front surface side (air side) can be generally adjusted by selecting the type of the discotic compound or an additive used in combination with the discotic compound.

### [Other Substances of Optical Anisotropic Layer]

By using components such as a plasticizer, a surfactant, a fluoro-aliphatic group containing polymer, a polymerizable monomer, a polymer, an alignment agent, and a tilt angle controlling agent in combination with the discotic compound, the evenness of the coated film, strength of the film, alignment of the long axis of the discotic compound can be improved.

The plasticizer, surfactant, and polymerizable monomer used in combination with the discotic compound preferably have compatibility with the discotic liquid crystal compound and can give variation in tilt angle of the discotic compound or do not hinder alignment. Therefore, the polymerizable monomer is preferable among these substances.

As the polymerizable monomer, compounds having vinyl groups, vinyloxy groups, acryloyl groups, and methacryloyl groups are preferred.

In addition, the amount of addition of the above-mentioned compound is generally in a range of 1% by mass to 50% by mass, and preferably in a range of 5% by mass to 30% by mass with respect to the amount of the discotic compound. Using polymerizable monomers having 4 or more reactive functional groups by mixture can improve adhesion between the alignment film and the optically anisotropic layer.

The optical anisotropic layer preferably contains a polymer together with the discotic compound. Such polymer is preferably the one which has a certain degree of compatibility with the discotic liquid crystal compound and which can give variation in the tilt angle to the discotic liquid crystal compound.

Examples of the polymer include cellulose ester. Preferred examples of the cellulose ester include cellulose acetate, cellulose acetate propionate, hydroxypropyl cellulose, and cellulose acetate butyrate.

In order not to hinder the alignment of the discotic liquid crystal compound, the addition amount of the above-mentioned polymer is preferably in a range of 0.1% by mass to 10% by mass, more preferably, in a range of 0.1% by mass to 8% by mass, and even more preferably, in a range of 0.1% by mass to 5% by mass, with respect to the amount of the discotic liquid crystal compound.

The phase transition temperature from a discotic nematic liquid crystal phase to a solid phase of the discotic liquid crystal compound is preferably 70° C. to 300° C., and more preferably, 70° C. to 170° C.

The fluoro-aliphatic group containing polymer includes a copolymer having a repeating unit derived from fluoro-aliphatic group containing monomer and a repeating unit represented by the following general formula (1-F).

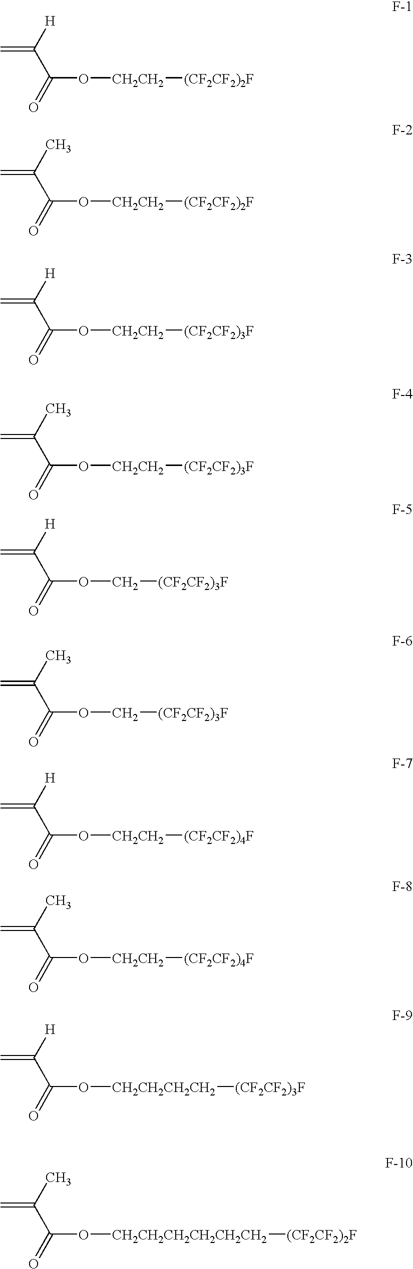

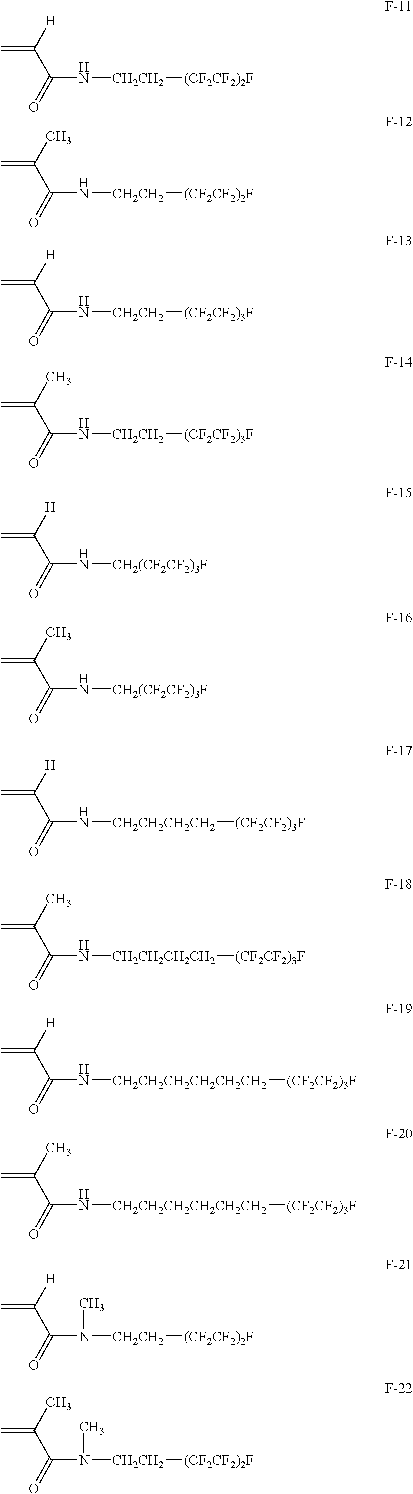

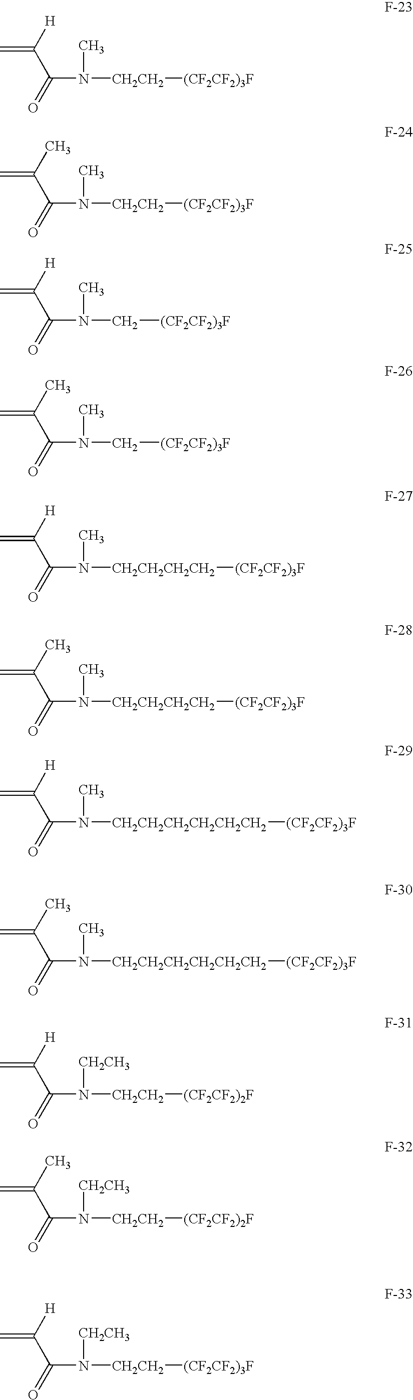

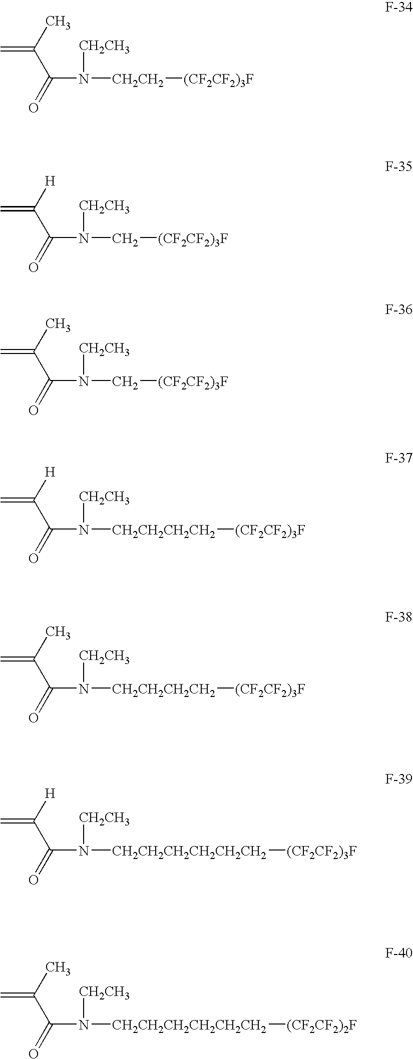

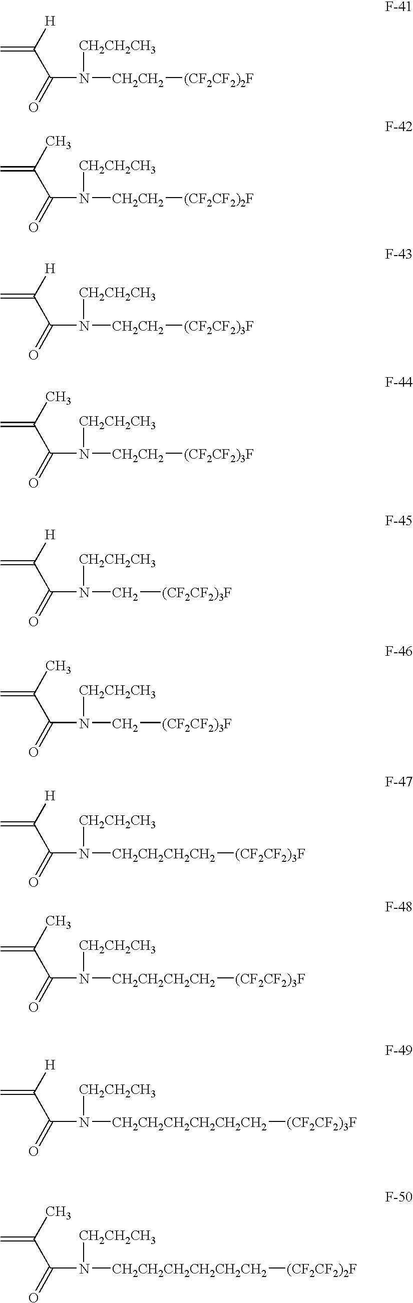

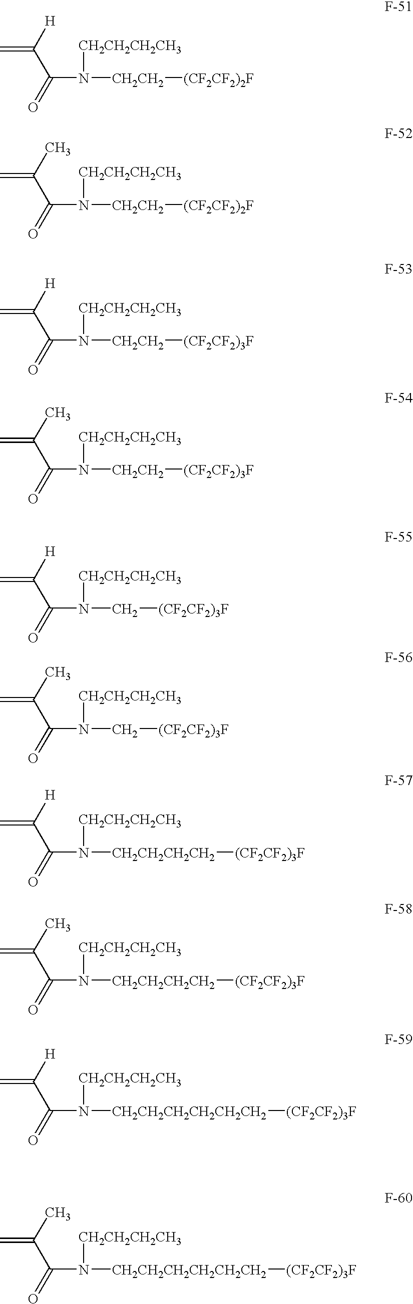

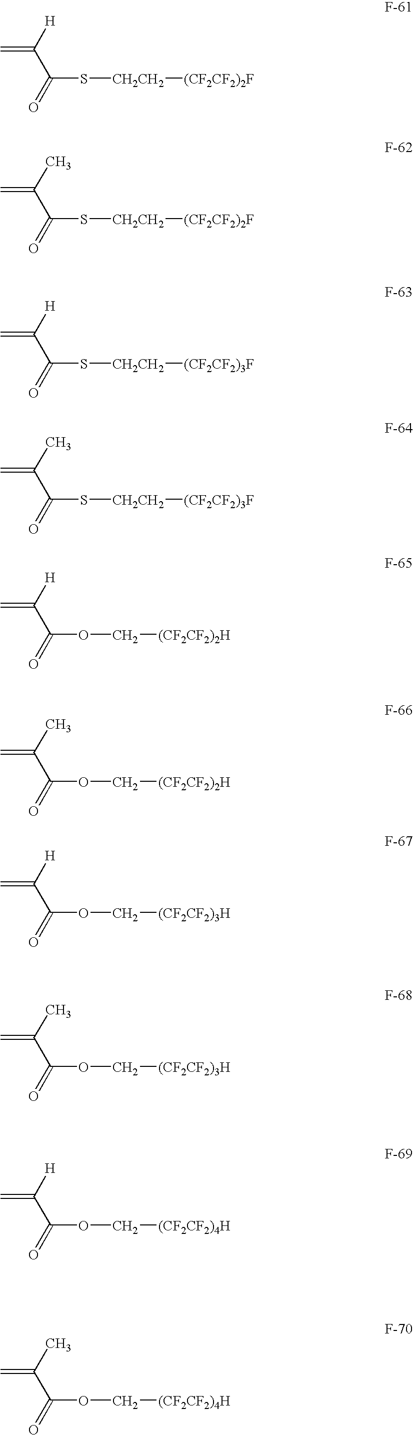

Next, the repeating unit represented by (1-F) will be described below.

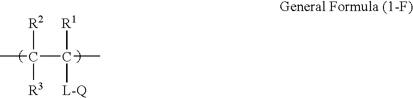

In the aforementioned general formula (1-F), R¹, R² and R³ each independently represent a hydrogen atom or a substituent. Q represents a carboxyl group (—COOH) or a salt thereof, a sulfo group (—SO₃H) or a salt thereof, or a phosphonoxy group {—OP(═O)(OH)₂} or a salt thereof. L represents any group selected from the following linking groups, or a divalent linking group consisting of two or more selected from the following linking groups.

### (Group of Linking Groups)

a single bond, —O—, —CO—, —NR⁴— (where R⁴ represents a hydrogen atom, an alkyl group, an aryl group or an aralkyl group), —S—, —SO₂—, —P(═O)(OR⁵)— (where R⁵ represents an alkyl group, an aryl group or an aralkyl group), an alkylene group and an arylene group

In the general formula (1-F), R¹, R² and R³ each independently represent a hydrogen atom or a substituent selected from the substituent group listed below.

### (Group of the Substituent Groups)

An alkyl group (an alkyl group having preferably 1 to 20 carbon atoms, more preferably 1 to 12 carbon atoms, and even more preferably 1 to 8 carbon atoms such as a methyl group, an ethyl group, an isopropyl group, a tert-butyl group, an n-octyl group, an n-decyl group, an n-hexadecyl group, a cyclopropyl group, a cyclopentyl group, a cyclohexyl group, etc.); an alkenyl group (an alkenyl group having preferably 2 to 20 carbon atoms, more preferably 2 to 12 carbon atoms, and even more preferably 2 to 8 carbon atoms such as a vinyl group, an aryl group, a 2-butenyl group, a 3-pentenyl group, etc.); an alkynyl group (an alkynyl group having preferably 2 to 20 carbon atoms, more preferably 2 to 12 carbon atoms, and even more preferably 2 to 8 carbon atoms such as a propargyl group, a 3-pentynyl group, etc.); an aryl group (an aryl group having preferably 6 to 30 carbon atoms, more preferably 6 to 20 carbon atoms, and even more preferably 6 to 12 carbon atoms such as a phenyl group, a p-methylphenyl group, a naphthyl group, etc.); an aralkyl group (an aralkyl group having 7 to 30 carbon atoms, more preferably 7 to 20 carbon atoms, and even more preferably 7 to 12 carbon atoms such as a benzyl group, a phenethyl group, a 3-phenylpropyl group, etc.); a substituted or unsubstituted amino group (an amino group having preferably 0 to 20 carbon atoms, more preferably 0 to 10 carbon atoms, and even more preferably 0 to 6 carbon atoms such as an unsubstituted amino group, a methylamino group, a dimethylamino group, a diethylamino group, an anilino group, etc.);

An alkoxy group (an alkoxy group having preferably 1 to 20 carbon atoms, more preferably 1 to 16 carbon atoms, and even more preferably 1 to 10 carbon atoms such as a methoxy group, an ethoxy group, a butoxy group, etc.); an alkoxycarbonyl group (an alkoxycarbonyl group having preferably 2 to 20 carbon atoms, more preferably 2 to 16 carbon atoms, and even more preferably 2 to 10 carbon atoms such as a methoxycarbonyl group, an ethoxycarbonyl group, etc.); an acyloxy group (an acyloxy group having preferably 2 to 20 carbon atoms, more preferably 2 to 16 carbon atoms, and even more preferably 2 to 10 carbon atoms such as an acetoxy group, a benzoyloxy group, etc.); an acylamino group (an acylamino group having preferably 2 to 20 carbon atoms, more preferably 2 to 16 carbon atoms, and even more preferably 2 to 10 carbon atoms such as an acetylamino group, a benzoylamino group, etc.); an alkoxycarbonylamino group (an alkoxycarbonylamino group having preferably 2 to 20 carbon atoms, more preferably 2 to 16 carbon atoms, and even more preferably 2 to 12 carbon atoms such as methoxycarbonylamino group, etc.); an aryloxycarbonylamino group (an aryloxycarbonylamino group having preferably 7 to 20 carbon atoms, more preferably 7 to 16 carbon atoms, and even more preferably 7 to 12 carbon atoms such as phenyloxycarbonylamino group, etc.); a sulfonylamino group (a sulfonylamino group having preferably 1 to 20 carbon atoms, more preferably 1 to 16 carbon atoms, and even more preferably 1 to 12 carbon atoms such as a methanesulfonylamino group, a benzenesulfonylamino group, etc.); a sulfamoyl group (a sulfamoyl group having preferably 0 to 20 carbon atoms, more preferably 0 to 16 carbon atoms, and even more preferably 0 to 12 carbon atoms such as a sulfamoyl group, a methylsulfamoyl group, a dimethylsulfamoyl group, a phenylsulfamoyl group, etc.); a carbamoyl group (a carbamoyl group having preferably 1 to 20 carbon atoms, more preferably 1 to 16 carbon atoms, and even more preferably 1 to 12 carbon atoms such as an unsubstituted carbamoyl group, a methylcarbamoyl group, a diethylcarbamoyl group, a phenylcarbamoyl group, etc.).

An alkylthio group (an alkylthio group having preferably 1 to 20 carbon atoms, more preferably 1 to 16 carbon atoms, and even more preferably 1 to 12 carbon atoms such as a methylthio group, an ethylthio group, etc.); an arylthio group (an arylthio group having preferably 6 to 20 carbon atoms, more preferably 6 to 16 carbon atoms, and even more preferably 6 to 12 carbon atoms such as a phenylthio group, etc.); a sulfonyl group (a sulfonyl group having preferably 1 to 20 carbon atoms, more preferably 1 to 16 carbon atoms, and even more preferably 1 to 12 carbon atoms such as a mesyl group, a tosyl group, etc.); a sulfinyl group (a sulfinyl group having preferably 1 to 20 carbon atoms, more preferably 1 to 16 carbon atoms, and even more preferably 1 to 12 carbon atoms such as a methanesulfinyl group, a benzenesulfinyl group, etc.); a ureido group (a ureido group having preferably 1 to 20 carbon atoms, more preferably 1 to 16 carbon atoms, and even more preferably 1 to 12 carbon atoms such as an unsubstituted ureido group, a methylureido group, a phenylureido group, etc.); a phosphoric amido group (a phosphoric amido group having preferably 1 to 20 carbon atoms, more preferably 1 to 16 carbon atoms, and even more preferably 1 to 12 carbon atoms such as a diethylphosphoric amido group, a phenylphosphoric amido group, etc.); a hydroxyl group; a mercapto group; a halogen atom (e.g., a fluorine atom, a chlorine atom, a bromine atom and an iodine atom); a cyano group; a sulfo group; a carboxyl group; a nitro group; a hydroxamic acid group; a sulfino group; a hydrazino group; an imino group; a heterocyclic group (a heterocyclic group having preferably 1 to 30 carbon atoms, and more preferably 1 to 12 carbon atoms such as heterocyclic group containing heteroatoms such as a nitrogen atom, an oxygen atom, a sulfur atom, e.g., an imidazolyl group, a pyridyl group, a quinolyl group, a furyl group, a piperidine group, a morpholino group, a benzoxazolyl group, a benzimidazolyl group, a benzthiazolyl group, etc.); a silyl group (a silyl group having preferably 3 to 40 carbon atoms, more preferably 3 to 30 carbon atoms, and even more preferably 3 to 24 carbon atoms such as a trimethylsilyl group, a triphenylsilyl group, etc.). These substituents may be further substituted with these substituents. In addition, when two or more substituents exist, they may be identical or different. Further, they may be bonded to each other to form a ring, if possible.

Preferably, R¹, R² and R³ are each independently a hydrogen atom, an alkyl group, a halogen atom (for example, a fluorine atom, a chlorine atom, a bromine atom or an iodine atom) or a group represented by -L-Q described later; more preferably, R¹, R² and R³ are each independently a hydrogen atom, an alkyl group having 1 to 6 carbon atoms, a chlorine atom or a group represented by -L-Q; much more preferably, R¹, R² and R³ are each independently a hydrogen atom or an alkyl group having 1 to 4 carbon atoms; further much more preferably, R¹, R² and R³ are each independently a hydrogen atom or an alkyl group having 1 or 2 carbon atoms; and the most preferably, R² and R³ are a hydrogen atom and R¹ is a hydrogen atom or a methyl group. Specific examples of the alkyl group include a methyl group, an ethyl group, an n-propyl group, an n-butyl group and a sec-butyl group. The alkyl group may have an appropriate substituent. Examples of the substituent include a halogen atom, an aryl group, a heterocyclic group, an alkoxyl group, an aryloxy group, an alkylthio group, an arylthio group, an acyl group, a hydroxy group, an acyloxy group, an amino group, an alkoxycarbonyl group, an acylamino group, an oxycarbonyl group, a carbamoyl group, a sulfonyl group, a sulfamoyl group, a sulfonamido group, a sulfonyl group and a carboxyl group. When the alkyl group has a substituent, for the number of carbon atoms in the alkyl group, the carbon atoms in the substituent are not considered. Hereinafter, it is also applied to the number of carbon atoms in other groups.

L is a divalent linking group selected from the above-mentioned linking groups, or a divalent linking group formed by combination of two or more kinds thereof to form a divalent linking group. Among the above-mentioned group of the linking groups, R⁴ of —NR⁴— is a hydrogen atom, an alkyl group, an aryl group or an aralkyl group, and preferably a hydrogen atom or an alkyl group. Further, R⁵ of —PO(OR⁵)— is an alkyl group, an aryl group or an aralkyl group, and preferably an alkyl group. When R⁴ and R⁵ are alkyl groups, aryl groups or aralkyl groups, the number of carbon atoms is the same as described for the “group of the substituents”. Examples of L preferably include a single bond, —O—, —CO—, —NR⁴—, —S—, —SO₂—, an alkylene group or an arylene group, preferably include a single bond, —CO—, —O—, —NR⁴—, an alkylene group or an arylene group, and particularly preferably include a single bond. When L is an alkylene group, it is an alkylene group having preferably 1 to 12 carbon atoms, more preferably 1 to 8 carbon atoms, and even more preferably 1 to 6 carbon atoms. Specific examples of the particularly preferable alkylene groups include a methylene group, an ethylene group, a trimethylene group, a tetrabutylene group, a hexamethylene group and the like. When L is an arylene group, the number of carbon atoms in an arylene group is preferably 6 to 24, more preferably 6 to 18, and even more preferably 6 to 12. Specific examples of the particularly preferable arylene groups include a phenylene group, a naphthalene group and the like. When L comprises a divalent linking group (i.e. aralkylene group) obtained by combination of an alkylene group and an arylene group, the number of carbon atoms in the aralkylene group is preferably 7 to 36, more preferably 7 to 26, and even more preferably 7 to 16. Specific examples of the particularly preferable aralkylene groups include a phenylenemethylene group, a phenyleneethylene group, a methylenephenylene group and the like. The group mentioned as L may have a suitable substituent. Such the substituent may be the same substituent as the above-mentioned for the substituent in R¹ to R³.

Hereinbelow, the specific structures of L are exemplified, but the present invention is not limited thereto.

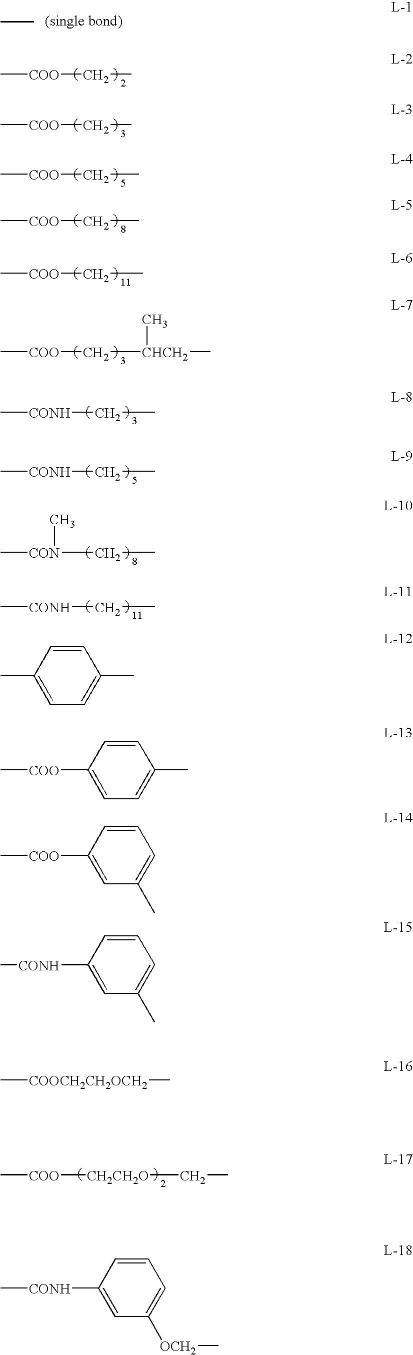

The fluoro-aliphatic group containing polymer may be a copolymer that contains the repeating unit represented by the following general formula (2-F) and is derived from a fluoro-aliphatic group containing monomer.

The fluoro-aliphatic group containing polymer is represented by the following general formula (2-F).

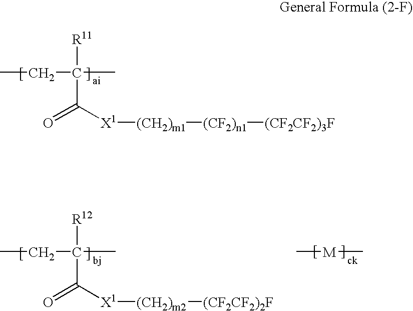

In the general formula (2-F), i and j each represent an integer of 1 or more, and i and j types of “repeating unit” are included, respectively; “M” represents a repeating unit derived from an ethylenically unsaturated monomer and k (k is an integer of 1 or more) types of “M” are included; “a”, “b” and “c” respectively represent mass percentage (polymerization ratio), Σai represents a numerical value of from 1% by mass to 98% by mass, Σbj represents a numerical value of from 1% by mass to 98% by mass, and Σck represents a numerical value of from 1% by mass to 98% by mass; R¹¹ and R¹² each represent a hydrogen atom or a methyl group; X¹ and X² each represent an oxygen atom, a sulfur atom, or —N(R¹³)—; R¹³ represents a hydrogen atom or an alkyl group having 1 to 4 carbon atoms; m1 and m2 each represent an integer of 1 to 6; and n1 represent an integer of 0 to 3.

In the aforementioned formula (2-F), the following repeating units A and B are repeating units derived from a fluoro-aliphatic group containing monomer A having —(CF₂CF₂)₃F at its terminal, and derived from a fluoro-aliphatic group containing monomer B having —(CF₂CF₂)₂F at its terminal, respectively.

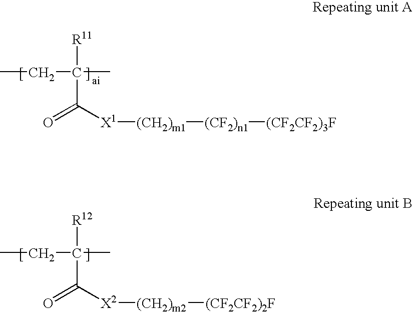

In the repeating units A and B, X¹ and X² are each preferably O. That is, the repeating units A and B are each preferably a repeating unit derived from (meth)acrylic monomers.

m1 and m2 are each preferably 1 to 4, more preferably 1 or 2.

n1 is preferably 0 to 2, more preferably 0 or 1, and the most preferably 0.

Examples of the fluoro-aliphatic group containing monomer which gives the repeating unit A are listed below, however, are not limited to these. Among these, (meth)acrylic monomers, exemplary compounds, A1-1 to A1-6 and A2-1 to A2-6, are preferable. The compounds in the case of n1=0 in the formula (2-F) are listed in the exemplary compounds shown below, but compounds in the case of n1=1 to 3 are, of course, also included in the examples of the fluoro-aliphatic group containing monomer which gives the repeating unit A.

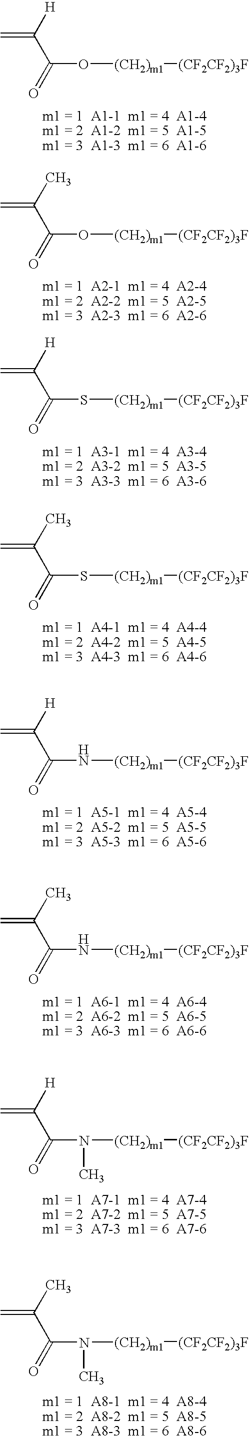

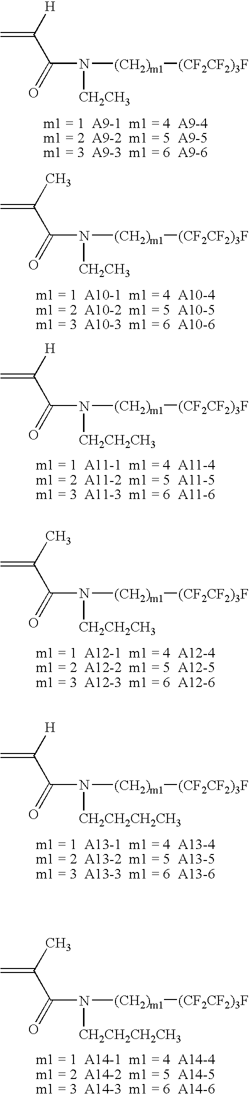

Examples of the fluoro-aliphatic group containing monomer which gives the repeating unit B are listed below, however, are not limited to these. Among these, (meth)acrylic monomers, exemplary compounds, B1-1 to B1-6 and B2-1 to B2-6, are preferable.

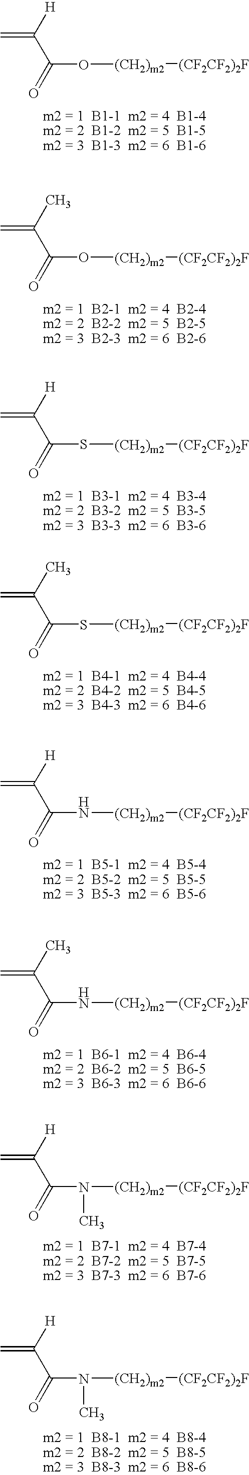

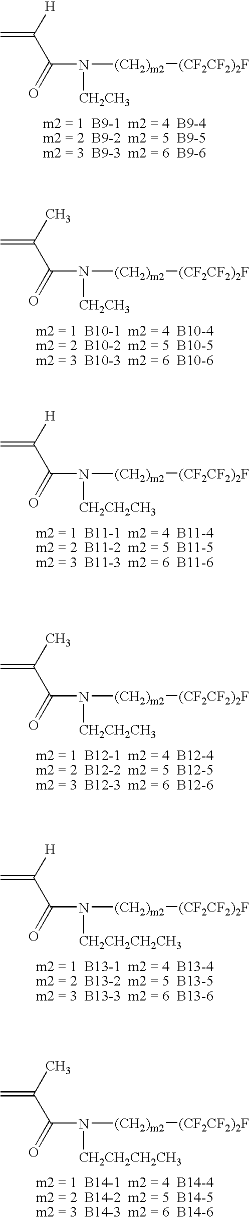

The monomer having a fluoro-aliphatic group may be derived from a fluoro aliphatic compound prepared by a telomerization method, occasionally referred to as telomer method, or an oligomemerization, occasionally referred to as oligomer method. Examples of preparation of the fluoride-aliphatic compound are described on pages 117 to 118 in “Synthesis and Function of Fluoride Compounds (Fussokagoubutsu no Gousei to Kinou)” overseen by ISHIKAWA NOBUO and published by CMC Publishing Co., Ltd in 1987; and on pages 747 to 752 in “Chemistry of Organic Fluorine Compounds II”, Monograph 187, Ed by Milos Hudlicky and Attila E. Pavlath, American Chemical Society 1995; and the like. The telomerization method is a method for producing a telomer by carrying out radical polymerization of fluorine-containing vinyl compound such as tetrafluoroethylene in the presence of an alkylhalide such as iodide, having a large chain-transfer constant number, as a telogen. One example is shown in Scheme 1.

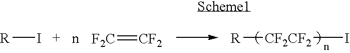

The obtained iodine-terminated telomers are usually terminal-modified properly as shown in Scheme 2, to give fluoroaliphatic compounds.

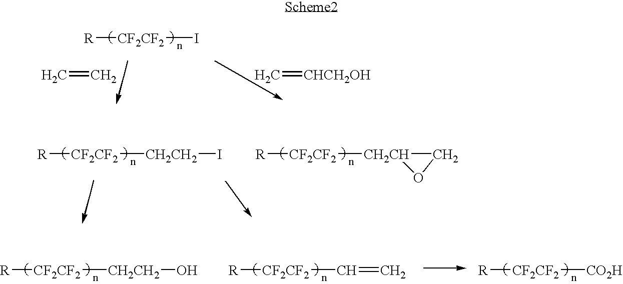

In the formula (2-F), M is a repeating unit derived from an ethylenically unsaturated monomer. M is not particularly limited, but preferably a repeating unit having a polar group capable of hydrogen bonding in a side chain. M is preferably a repeating unit represented by the following general formula (2-2-F).

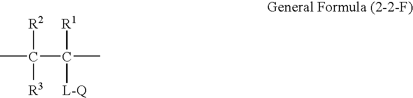

In the aforementioned general formula (2-2-F), R¹, R² and R³ each independently represent a hydrogen atom, an alkyl group, a halogen atom, or a group expressed by -L-Q. L represents a divalent linking group, and Q represents a polar group capable of hydrogen bonding.

L is preferably any group selected from the Linking Group shown below, or a divalent linking group consisting of two or more selected from the Linking Group shown below.

### (Linking Group)

a single bond, —O—, —CO—, —NR⁴—, —S—, —SO₂—, —P(═O)(OR⁵)—, an alkylene group and an arylene group (R⁴ represents a hydrogen atom, an alkyl group, an aryl group or an aralkyl group. R⁵ represents an alkyl group, an aryl group or an aralkyl group.)

More specifically, in (2-2-F), R¹, R² and R³ respectively represent a hydrogen atom, an alkyl group, a halogen atom (such as a fluorine atom, chlorine atom, bromine atom or iodine atom) or a group represented by -L-Q described later; preferred that R¹, R² and R³ respectively represent a hydrogen atom, an alkyl group having 1 to 6 carbon atoms, a chlorine group atom, or a group represented by -L-Q described later; more preferred that R¹, R² and R³ respectively represent a hydrogen atom or an alkyl group having 1 to 4 carbon atoms; and most preferred that R¹, R² and R³ respectively represent a hydrogen atom or an alkyl group having 1 to 2 carbon atoms. Examples of the alkyl groups represented by R¹, R² and R³ include methyl, ethyl, n-propyl, n-butyl and sec-butyl. The alkyl group may have any substituent. Examples of the substituent include a halogen atom, an aryl group, a heterocyclic group, an alkoxyl group, an aryloxy group, an alkylthio group, an arylthio group, an acyl group, a hydroxy group, an acyloxy group, an amino group, an alkoxycarbonyl group, an acylamino group, an oxycarbonyl group, a carbamoyl group, a sulfonyl group, a sulfamoyl group, a sulfonamido group, a sulforyl group and a carboxyl group.

When the alkyl group has a substituent, for the number of carbon atoms in the alkyl group, the carbon atoms in the substituent are not considered. Hereinafter, it is also applied to the number of carbon atoms in other groups.

L represents a divalent linking group selected from a single bond, —O—, —CO—, —NR⁴—, —S—, —SO₂, —PO(OR⁵)—, an alkylene group, an arylene group, or any combination of two or more selected from these. Here, R⁴ represents a hydrogen atom, an alkyl group, an aryl group or an aralkyl group. R⁵ represents an alkyl group, an aryl group or an aralkyl group.

L preferably contains a single bond, —O—, —CO—, —NR⁴—, —S—, —SO₂—, an alkylene group or an arylene group, and particularly preferably contains —CO—, —O—, —NR⁴—, an alkylene group, or an arylene group. In addition, it is also preferable that L contains both of —O— and an alkylene group, or L contains an alkyleneoxy group, and also preferable that L contains a polyalkyleneoxy group that contains repeating of an alkyleneoxy group.

When L contains an alkylene group, the number of carbon atoms of the alkylene group is preferably 1 to 10, more preferably 1 to 8, and the most preferably 1 to 6. Specific examples of particularly preferred alkylene group include a methylene group, an ethylene group, a trimethylene group, a tetrabutylene group, a hexamethylene group, and the like. The alkylene group (including an alkylene group in an alkyleneoxy group) may have a branched structure, and the number of carbon atoms of the alkylene chain in the branched portion is preferably 1 to 3.

When L contains an arylene group, the number of carbon atoms of the arylene group is preferably 6 to 24, more preferably 6 to 18, and the most preferably 6 to 12. Specific examples of particularly preferred arylene group include a phenylene group, a naphthalene group, and the like.

When L contains a divalent linking group consisting of a combination of an alkylene group and an arylene group (i.e., an aralkylene group), the number of carbon atoms of the aralkylene group is preferably 7 to 34, more preferably 7 to 26, and the most preferably 7 to 16. Specific examples of particularly preferred aralkylene group include a phenylenemethylene group, a phenyleneethylene group, a methylenephenylene group, and the like.

The groups for L may have a suitable substituent. Such the substituent includes the same substituents as the above-mentioned for the substituent in R¹, R² and R³.

The specific structures of L are exemplified below, which are not intended to limit the present invention.

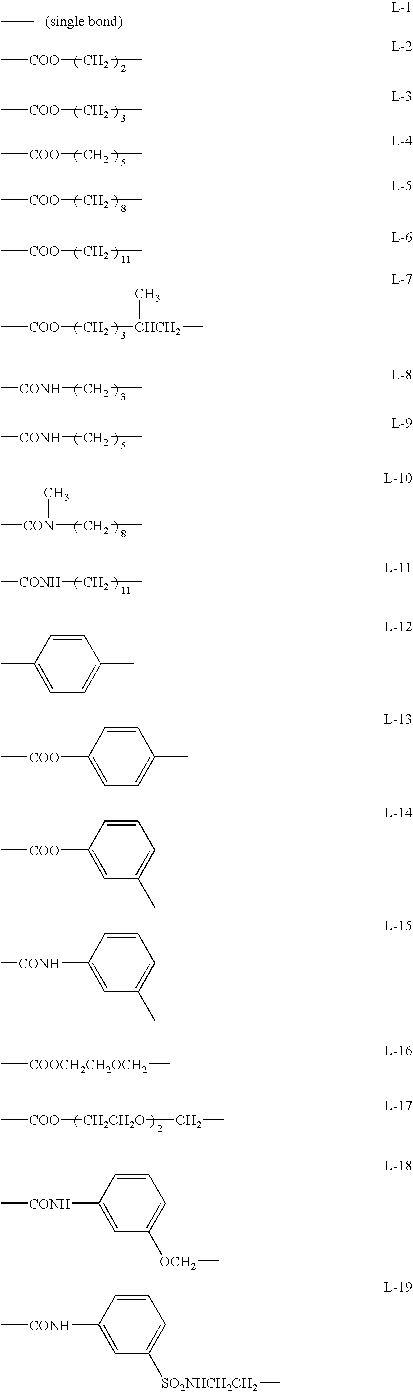

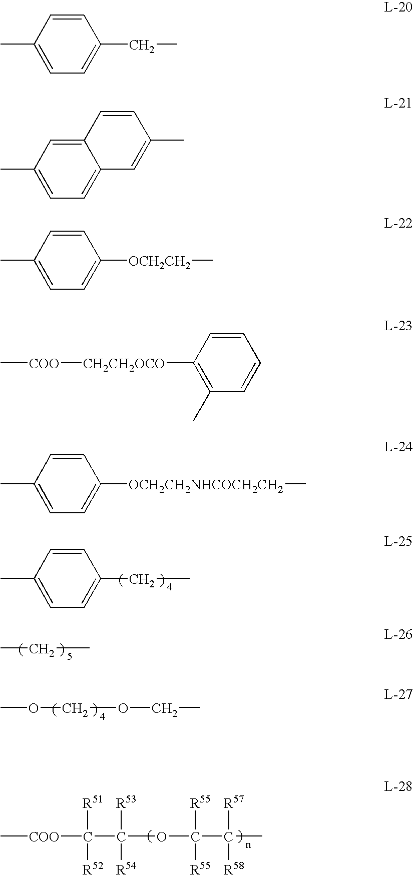

In L-28, R⁵¹ to R⁵⁸ each are a hydrogen atom or an alkyl group (the number of carbon atoms is preferably 1 to 4, more preferably 1 or 2), and n is from 1 to 12 (preferably an integer of 2 to 10). It is preferable that for R⁵³ and R⁵⁴, R⁵⁵ and R⁵⁶, and R⁵⁷ and R⁵⁸, one is a hydrogen atom and the other is an alkyl group.

Q is not particularly limited as long as it is a polar group capable of hydrogen bonding. Q is preferably a hydroxyl group, a carboxyl group, a carboxylate such as lithium carboxylate, sodium carboxylate, potassium carboxylate or ammonium carboxylate (for example, ammonium, tetramethyl ammonium, trimethyl-2-hydroxyethyl ammonium, tetrabutyl ammonium, trimethylbenzyl ammonium or dimethylphenyl ammonium); a pyridinium salt, a carboxylic amide (for example, non-substituted or N-mono substituted carboxylic amide with lower alkyl group such as —CONH₂ and —CONHCH₃), a sulfo group, a sulfate (examples of the cation are same as those exemplified above for the carboxylate), a sulfonamide (for example, non-substituted or N-mono substituted sulfonamide with lower alkyl group such as —SO₂NH₂ and —SO₂NHCH₃), a phospho group, a phosphate (examples of the cation are same as those exemplified above for the carboxylate), a phosphoamide group (for example, non-substituted or N-mono substituted phosphonamide with lower alkyl group such as —OP(=0) (NH₂)₂ and —OP(=0) (NHCH₃)₂), a ureido group (—NHCONH₂), and a non-substituted or N-mono substituted amino group (for example, —NH₂ or —NHCH₃) (where the lower alkyl group represents a methyl group or ethyl group).

Q is more preferably a hydroxyl group, a carboxyl group, a sulfo group and a phospho group, even more preferably a hydroxyl group and a carboxyl group, and most preferably a hydroxyl group.

The repeating unit represented by the general formula (2-2-F) is preferably a repeating unit derived from (meth)acrylic monomers.

Specific examples of the ethylenically unsaturated monomer which gives the repeating unit M are shown below, however, are not limited to these.

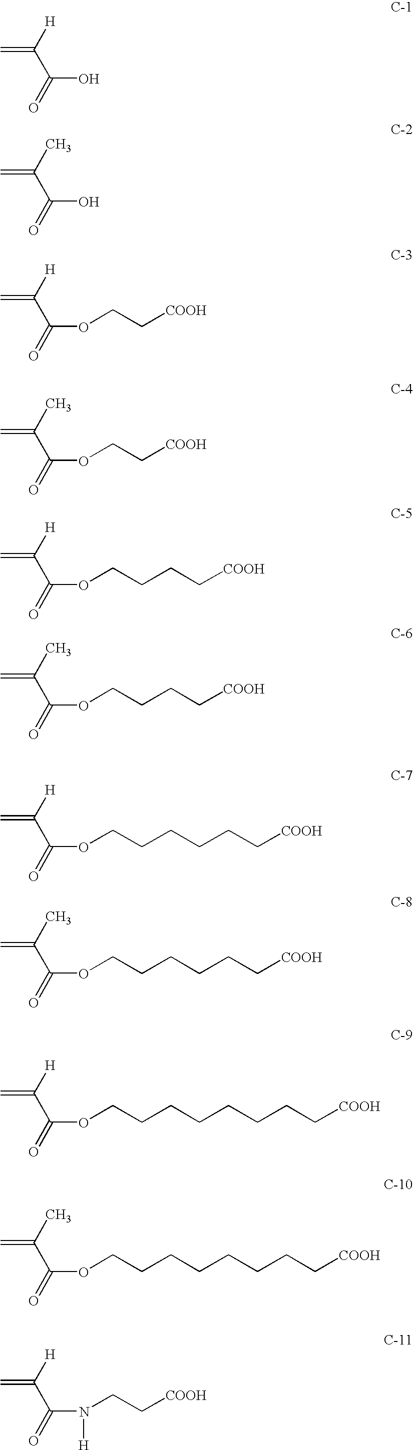

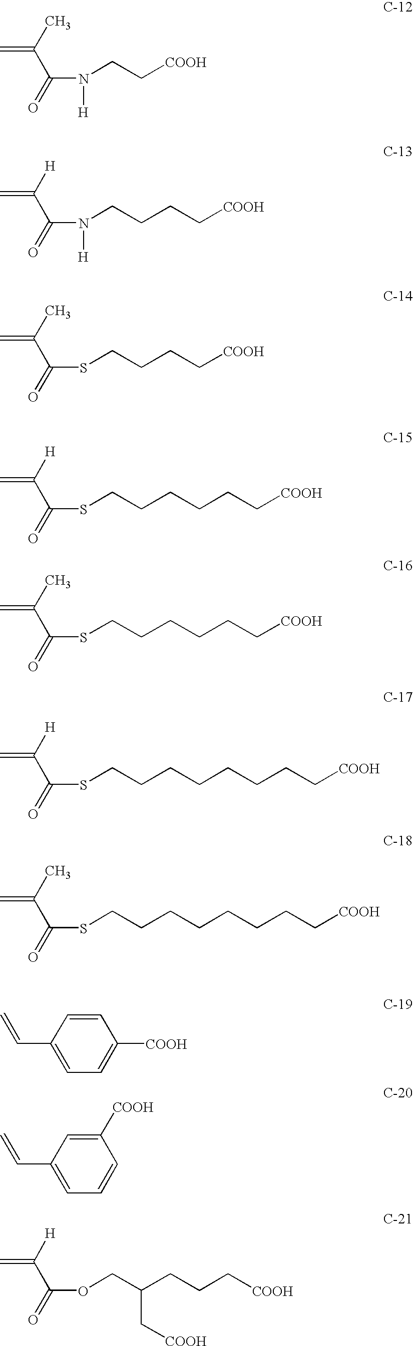

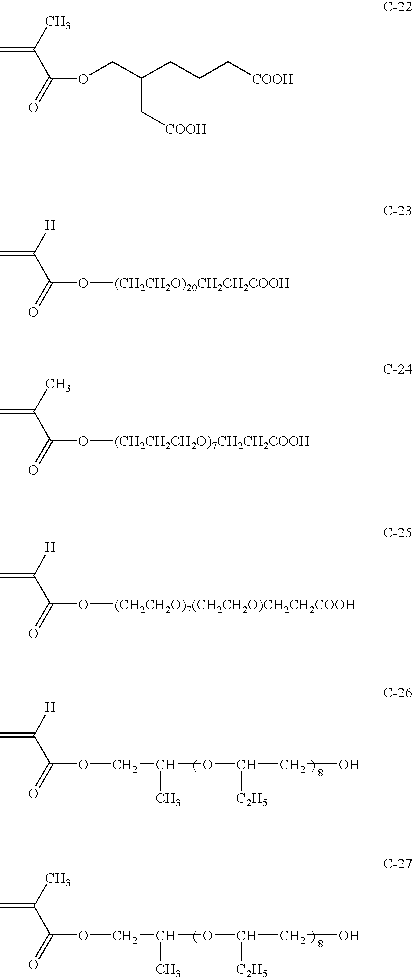

The fluoro-aliphatic group containing polymer represented by the general formula (2-F) contains repeating units A, B, and M, and in the aforementioned formula (2-F), i, j and k, which mean the number of types of each repeating unit, are each an integer of 1 or more. The fluoro-aliphatic group containing polymer represented by the general formula (2-F) may contain two or more types of each repeating unit, and may contain repeating units other than the repeating units A, B, and M.

For example, the fluoro-aliphatic group containing polymer may contain one of, or two or more of repeating units derived from the monomer selected from the following group of the monomers.

### Monomer Group

(1) Alkenes: ethylene, propylene, 1-buten, isobuten, 1-hexene, 1-dodecene, 1-octadecene, 1-eicocene, hexafluoropropene, vinylidene fluoride, chlorotrifluoroethylene, 3,3,3-trifuluoropropylene, tetrafluoroethylene, vinyl chloride, vinylidene chloride or the like;
(2) Dienes: 1,3-butadiene, isoprene, 1,3-pentadiene, 2-ethyl-1,3-butadiene, 2-n-propyl-1,3-butadiene, 2,3-dimethyl-1,3-butadiene, 2-methyl-1,3-pentadiene, 1-phenyl-1,3-butadiene, 1-α-naphtyl-1,3-butadiene, 1-β-naphtyl-1,3-butadiene, 2-chloro-1,3-butadiene, 1-bromo-1,3-butadiene, 1-chlorobutadiene, 2-fluoro-1,3-butadiene, 2,3-dichloro-1,3-butadiene, 1,1,2-trichloro-1,3-butadiene, 2-cyano-1,3-butadiene, 1,4-divinyl cyclohexane or the like;
(3) α,β-unsaturated carboxylic acid derivatives
(3a) Alkyl acrylates: methyl acrylate, ethyl acrylate, n-propyl acrylate, isopropyl acrylate, n-butyl acrylate, isobutyl acrylate, sec-butyl acrylate, tert-butyl acrylate, amyl acrylate, n-hexyl acrylate, cyclohexyl acrylate, 2-ethylhexyl acrylate, n-octyl acrylate, tert-octyl acrylate, dodecyl acrylate, phenyl acrylate, benzyl acrylate, 2-chloroethyl acrylate, 2-bromoethyl acrylate, 4-chlorobutyl acrylate, 2-cyanoethyl acrylate, 2-acetoxyethyl acrylate, methoxybenzyl acrylate, 2-chlorocyclohexyl acrylate, furfuryl acrylate, tetrahydrofurfuryl acrylate, 2-methoxyethyl acrylate, ω-methoxy polyethyleneglycol acrylate (having additional molar number, n, of 2 to 100), 3-metoxybutyl acrylate, 2-ethoxyethyl acrylate, 2-butoxyethyl acrylate, 2-(2-butoxyethoxy)ethyl acrylate, 1-bromo-2-methoxyethyl acrylate, 1,1-dichloro-2-ethoxyethyl acrylate, glycidyl acrylate or the like;
(3b) Alkyl methacrylates: methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, n-hexyl methacrylate, cyclohexyl methacrylate, 2-ethylhexyl methacrylate, n-octyl methacrylate, stearyl methacrylate, benzyl methacrylate, phenyl methacrylate, allyl methacrylate, furfuryl methacrylate, tetarahydrofurfuryl methacrylate, crezyl methacrylate, naphthyl methacrylate, 2-methoxyethyl methacrylate, 3-methoxybutyl methacrylate, ω-methoxypolyethyleneglycol methacrylate (having additional molar number, n, of 2 to 100), 2-acetoxyethyl methacrylate, 2-ethoxyethyl methacrylate, 2-butoxyethyl methacrylate, 2-(2-butoxyethoxy)ethyl methacrylate, glycidyl methacrylate, 3-trimetoxysilylpropyl methacrylate, allyl methacrylate, 2-isosyanate ethyl methacrylate or the like;
(3c) Diesters of unsaturated polycarboxylic acids: dimethyl maleate, dibutyl maleate, dimethyl itaconate, dibutyl itaconate, dibutyl crotonate, dihexyl crotonate, diethyl fumarate, dimethyl fumarate or the like;
(3d) Amides of α,β-unsaturated carboxylic acids: N,N-dimethyl acrylamide, N,N-diethyl acrylamide, N-n-propyl acrylamide, N-tert-butyl acrylamide, N-tert-octyl methacrylamide, N-cyclohexyl acrylamide, N-phenyl acrylamide, N-(2-acetoacetoxyethyl)acrylamide, N-benzyl acrylamide, N-acryloyl morpholine, diacetone acrylamide, N-methyl maleimide or the like;
(4) Unsaturated nitriles: acrylonitrile, methacrylonitrile or the like;
(5) Styrene or derivatives thereof: styrene, vinyltoluene, ethylstyrene, p-tert-butylstyrene, p-vinyl methyl benzoate, α-methyl styrene, p-chloromethyl styrene, vinyl naphthalene, p-methoxy styrene, p-hydroxy methyl styrene, p-acetoxy styrene or the like;
(6) Vinyl esters: vinyl acetate, vinyl propanate, vinyl butyrate, vinyl isobutyrate, vinyl benzoate, vinyl salicylate, vinyl chloroacetate, vinyl methoxy acetate, vinyl phenyl acetate or the like;
(7) Vinyl ethers: methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-octyl vinyl ether, n-dodecyl vinyl ether, n-eicosyl vinyl ether, 2-ethylhexyl vinyl ether, cyclohexyl vinyl ether, fluorobutyl vinyl ether, fluorobutoxyethyl vinyl ether or the like; and
(8) Other monomers: N-vinyl pyrrolidone, methyl vinyl ketone, phenyl vinyl ketone, methoxy ethyl vinyl ketone, 2-vinyl oxazoline, 2-isoprppenyl oxazoline or the like.

In the general formula (2-F), “a”, “b” and “c” represent a polymerization ratio (mass percentage) of monomers which give each repeating unit, Σai represents a numerical value of from 1% by mass to 98% by mass, Σbj represents a numerical value of from 1% by mass to 98% by mass, and Σck represents a numerical value of from 1% by mass to 98% by mass. It is preferable that Σai is from 5% by mass to 40% by mass, Σbj is from 5% by mass to 40% by mass, and Σck is from 20% by mass to 90% by mass, and it is more preferable that Σai is from 10% by mass to 35% by mass, Σbj is from 10% by mass to 35% by mass, and Σck is from 30% by mass to 80% by mass. The fluoro-aliphatic group containing polymer represented by the general formula (2-F) may contain repeating units other than the repeating units A, B, and M. That is, it may be that Σai+Σbj+Σck<100% by mass, but it is preferable that repeating units other than the repeating units A, B, and M are not included. In other words, it is preferable that Σai+Σbj+Σck=100% by mass.

It is preferable that the total mass percentage of the repeating units A and B, derived from the fluoro-aliphatic group containing monomer, that are contained in the fluoro-aliphatic group containing polymer is within a predetermined range as generation of unevenness at an initial drying stage can be reduced more. Specifically, the sum of the total mass percentage of i types of repeating unit A, Σai, and the total mass percentage of j types of repeating unit B, Σbj, that is, (Σai+Σbj) is preferably from 20% by mass to 50% by mass, more preferably from 25% by mass to 45% by mass, and the most preferably from 25% by mass to 40% by mass. If the (Σai+Σbj) is less than 20% by mass, liquid crystal compounds may not be controlled at an air interface sufficiently, and thus the effect of the present invention that unevenness of the optical film is reduced may be impaired. If it is more than 50% by mass, the coatability of the coating solution when a liquid crystalline composition is applied on the surface (for example, surface of the transparent support such as a polymer film) is not sufficient, causing cratering inferiors occasionally. When the (Σai+Σbj) is within the range, such problem does not arise, and unevenness at an initial drying stage can be reduced more.

In addition, from the same viewpoint, the ratio of Σai to (Σai+Σbj), (Σai/(Σai+Σbj)), is preferably from 0.2 to 0.8, more preferably from 0.3 to 0.6, and the most preferably from 0.35 to 0.55. If the ratio (Σai/(Σai+Σbj)) is less than 0.2, liquid crystal compounds may not be controlled at an air interface sufficiently, and thus the effect of the present invention that unevenness of the optical film is reduced may be impaired. If it is more than 0.8, the coatability of the coating solution when a liquid crystalline composition is applied on the surface (for example, surface of the transparent support such as a polymer film) is not sufficient, causing cratering inferiors occasionally. When the (Σai/(Σai+Σbj)) is within the range, it is preferable since such problem does not arise, and unevenness at an initial drying stage can be reduced more.

Specific examples of the fluoro-aliphatic group containing polymer that can be used for the present invention are listed in the tables below, but are not limited to the following specific examples. In the tables below, the repeating units A, B and M are specified by the number of the exemplary compounds of the monomer which gives each repeating unit.

TABLE 1

| Polymer | Repeating unit A | Repeating unit B | Repeating unit M |
|---|---|---|---|
| No. | (Σai: mass %) | (Σbj: mass %) | (Σck: mass %) |
| P-1 | A1-2 | B1-2 | C-27 |
| | (20) | (20) | (60) |
| P-2 | A1-2 | B1-2 | C-27 |
| | (10) | (30) | (60) |
| P-3 | A1-2 | B1-2 | C-26 |
| | (20) | (20) | (60) |
| P-4 | A1-2 | B1-2 | C-26 |
| | (10) | (30) | (60) |
| P-5 | A1-2 | B1-2 | C-23 |
| | (25) | (25) | (50) |
| P-6 | A1-2 | B1-2 | C-24 |
| | (30) | (5) | (65) |
| P-7 | A1-2 | B1-2 | C-26 |
| | (35) | (5) | (60) |
| P-8 | A1-2 | B1-2 | C-26 |
| | (40) | (10) | (50) |
| P-9 | A1-4 | B1-4 | C-23 |
| | (20) | (20) | (60) |
| P-10 | A1-4 | B1-4 | C-24 |
| | (10) | (30) | (60) |
| P-11 | A1-4 | B1-4 | C-26 |
| | (20) | (20) | (60) |
| P-12 | A1-4 | B1-4 | C-26 |
| | (10) | (30) | (60) |
| P-13 | A1-4 | B1-4 | C-23 |
| | (25) | (25) | (50) |
| P-14 | A1-4 | B1-4 | C-24 |
| | (30) | (5) | (65) |
| P-15 | A1-4 | B1-4 | C-26 |
| | (35) | (5) | (60) |
| P-16 | A1-4 | B1-4 | C-26 |
| | (40) | (10) | (50) |

TABLE 2

| Polymer | Repeating unit A | Repeating unit B | Repeating unit M |
|---|---|---|---|
| No. | (Σai: mass %) | (Σbj: mass %) | (Σck: mass %) |
| P-17 | A2-2 | B2-2 | C-27 |
| | (20) | (20) | (60) |
| P-18 | A2-2 | B2-2 | C-27 |
| | (25) | (25) | (50) |
| P-19 | A2-2 | B2-2 | C-26 |
| | (10) | (30) | (60) |
| P-20 | A2-2 | B2-2 | C-26 |
| | (25) | (25) | (50) |
| P-21 | A2-4 | B2-4 | C-27 |
| | (20) | (20) | (60) |
| P-22 | A2-4 | B2-4 | C-26 |
| | (20) | (20) | (60) |

The optical anisotropic layer of the present invention contain at least one the fluoro-aliphatic group containing polymer, and of course, may contain two or more fluoro-aliphatic group containing polymers. The amount of the fluoro-aliphatic group containing polymer in the composition is preferably 0.01% by mass to 20% by mass, more preferably 0.05% by mass to 10% by mass, and the most preferably 0.1% by mass to 5% by mass of the mass of the liquid crystal compound (preferably, discotic liquid crystal compound).

The preferable range of the concentration, C % by mass, of the fluoro-aliphatic group containing polymer in the composition (solid content when the composition is prepared as a coating solution, etc.) varies depending on the fluorine content, F %, in the fluoro-aliphatic group containing polymer. In order to reduce unevenness at an initial drying stage more, the product of the concentration, C % by mass, of the fluoro-aliphatic group containing polymer and the fluorine content, F %, in the fluoro-aliphatic group containing polymer is preferably 0.05 to 0.12, more preferably 0.06 to 0.09, and the most preferably 0.06 to 0.08. If C×F is less than 0.05, liquid crystal compounds may not be controlled at an air interface sufficiently, resulting in the poor exterior properties (degree of unevenness) of the optical film occasionally. If C×F is more than 0.12, the coatability of the coating solution when a liquid crystalline composition is applied on the surface (for example, surface of the transparent support such as a polymer film) is not sufficient, resulting in the poor exterior properties of the optical film (cratering inferiors are caused) occasionally. When C×F is within the range, such problem does not arise, and unevenness at an initial drying stage can be reduced more.

The fluoro-aliphatic group containing polymer may be a copolymer that contains the repeating unit represented by the following general formula (3-F) and is derived from a fluoro-aliphatic group containing monomer.

The fluoro-aliphatic group containing polymer preferably contains: at least one repeating unit derived from the monomer having a fluoro-aliphatic group; and at least one repeating unit derived from the monomer having an acid group such as a carboxyl group (—COOH) or a salt thereof, a sulfo group (—SO₃H) or a salt thereof, or phosphonoxy {—OP(═O)(OH)₂} or a salt thereof.

Preferable examples of the fluoro-aliphatic group containing polymer include the following polymer A described in WO 2006/001504 (copolymer that contains a repeating unit derived from a fluoro-aliphatic group containing monomer and a repeating unit represented by the following general formula (3-F).

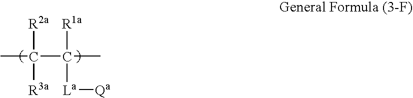

where R^{1a}, R^{2a} and R^{3a} each represent a hydrogen atom or a substituent; L^{a} represents a divalent linking group selected from the following linking groups or a divalent linking group formed of combination of two or more kinds selected from the following linking groups;

### (Group of Linking Groups)

a single bond, —O—, —CO—, —NR^{4a}— (where NR^{4a} represents a hydrogen atom, an alkyl group, an aryl group or an aralkyl group), —S—, —SO₂—, —P(—O)(OR^{5a})— (where R^{5a} represents an alkyl group, an aryl group or an aralkyl group), an alkylene group and an arylene group;

Q^{a} represents a carboxyl group (—COOH) or a salt thereof, a sulfo group SO₃H) or a salt thereof, or phosphonoxy {—OP(═O)(OH)₂} or a salt thereof.

In the formula, the preferable ranges of R^{1a}, R^{2a}, R^{3a} and La are each the same as the preferable range of R¹, R², R³ and L in the general formula (2-2-F).

The repeating unit derived from a fluoro-aliphatic group containing monomer, which the fluoro-aliphatic group containing polymer has, may be one of the repeating units A and B.

### [Fixation of the Aligned Liquid Crystal Molecules]

The aligned liquid crystal compound is fixed while retaining its alignment state. The fixation is performed by a polymerization reaction. Examples of the polymerization reaction include a thermal polymerization reaction using a thermal polymerization initiator, and a photopolymerization reaction using a photopolymerization initiator. Among these, the photopolymerization is preferable.

Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketones (described in the specification of U.S. Pat. No. 3,549,367), acridine and phenazine compounds (described in JP-A No. 60-105667 and U.S. Pat. No. 4,239,850), and oxadiazole compounds (described in U.S. Pat. No. 4,212,970).

The usage amount of the photopolymerization initiator is preferably in a range of 0.01% by mass to 20% by mass, and more preferably in a range of 0.5% by mass to 5% by mass based on the solid content of the coating solution.

Light irradiation for polymerizing the liquid crystal compound and fixing the same is preferably carried out with ultraviolet ray. The exposure dose thereof is preferably in a range of 20 mJ/cm² to 50 J/cm², more preferably in a range of 20 mJ/cm² to 5,000 mJ/cm², and even more preferably in a range of 100 mJ/cm² to 800 mJ/cm². Also, the light irradiation may be carried out under a heating condition to accelerate the photopolymerization reaction.

The optical anisotropic layer is formed by coating a coating liquid which is prepared by mixing at least one the aforementioned liquid crystal compound, and optionally a polymerization initiator and additives such as a fluoropolymer, on the surface of the alignment film, and drying the coated layer.

The fluoropolymer (fluorine compound) can be selected from those known in the art, but specific examples thereof include the fluorine compounds listed in the paragraphs—of JP-A No. 2001-330725.

The solvent for use in the coating liquid is preferably an organic solvent. Examples of the organic solvent include: amide such as N,N-dimethylformamide; sulfoxide such as dimethyl sulfoxide; heterocyclic compounds such as pyridine; hydrocarbons such as benzene, and hexane; alkyl halide such as chloroform, dichloromethane, and tetrachloromethane; ester such as methyl acetate and butyl acetate; ketone such as acetone, and methylethyl ketone; ether such as tetrahydrofuran, and 1,2-dimethoxyethane; and the like. Among these, alkyl halide and ketone are preferred. One of them may be used as the organic solvent, or two or more of them may be used in combination as the organic solvent.

When an extremely highly uniformed optical compensation film is produced as in the case of the present invention, the surface tension of the coating liquid is preferably 25 mN/m or less, and more preferably 22 mN/m or less.

The coating of the coating liquid is carried out in accordance with the conventional method. Examples of the coating method include a wire-bar coating method, an extrusion coating method, a direct gravure coating method, a reverse gravure coating method, a die coating method, and the like.

The thickness of the optical anisotropic layer is preferably 0.1 μm to 20 μm, more preferably 0.5 μm to 15 μm, and the most preferably 1 μm to 10 μm. Moreover, the optical anisotropic layer may have a protective layer on the surface thereof.

### (Production Method of Optical Compensation Film)

Hereinafter, the preferably method for continuously producing the optical compensation film of the present invention is explained. In the method for producing the optical compensation film of the present invention, for example, the following steps (1)-(7) are sequentially performed.

### (1) Step of Forming a Support

The composition of cellulose acetate solution is stirred while heating so as to dissolve each substance, to thereby prepare a cellulose acetate solution. Separately, in another tank, etc., cellulose acetate (linter), a retardation elevating agent, and the like are stirred while heating to thereby prepare a retardation elevating agent solution.

The retardation elevating agent solution is added to the cellulose acetate solution, and the mixed solution is sufficiently stirred to thereby prepare a dope. This dope is cast by means of a band flow caster to prepare a support.

### (2) Step of Adhesion Imparting Treatment

When the alignment film is disposed by coating, it is preferable to subject the support to surface treatment so that an adhesion is imparted to the surface of the support and the coating liquid of the alignment film is uniformly coated on the support. Examples of the surface treatment include a method in which an undercoat layer is disposed, a corona discharge treatment, a glow discharge treatment, and a UV radiation treatment. Alkali saponification treatment is extremely effective for the surface treatment of the cellulose acetate film. Alkali saponification treatment contains (a) a step of heating a support to room temperature or higher in advance, (b) a step of applying an alkali solution onto the support, (c) a step of retaining the temperature of the support at room temperature or higher, and (d) a step of washing away the alkaline solution from the support.

### (3) Step of Forming an Alignment Film

The alignment film is prepared by applying the coating liquid for the alignment film that contains a polymerization initiator capable of reacting with the radical polymerizable group and/or a compound having two or more vinyl groups onto the support obtained in the step of adhesion imparting treatment and drying. The alignment film is subjected to a rubbing treatment in the predetermined axis direction of the support.

### (4) Step of Pretreatment

In the present invention, it is preferable that the step of pretreatment is performed after the alignment film is formed as mentioned above, but before the optical anisotropic layer is formed. The step of pretreatment is a step for irradiating UV ray to the alignment film, and curing the inner part of the alignment film.

By irradiating the UV ray to the alignment film and curing the inner part of the alignment film before the optical anisotropic layer is formed, a swelling rate of the alignment itself is lowered, and the alignment film is prevented from swelling even when an optical compensation film in which each layers are laminated to form the final product is stored under the high humidity condition, since the inner part of the alignment film is cured at a certain degree, as well as the interface of the alignment film.

The exposure dose of the UV ray is preferably 60 mJ/cm² to 600 mJ/cm², more preferably 80 mJ/cm² to 300 mJ/cm², and the most preferably 100 mJ/cm² to 200 mJ/cm². In the case where the exposure dose is lower than 60 mJ/cm², the curing of the alignment film become insufficient, and thus the alignment film may be swollen under the high humidity condition. In the case where the exposure dose is more than 600 mJ/cm², the curing of the alignment progresses more than necessary, the formation of the optical anisotropic layer on the alignment film becomes insufficient in the below-mentioned step of forming the optical anisotropic layer, and thus the alignment inferior of the optical anisotropic layer may be caused.

Here, the inner part means, when the support, the alignment film and the optical anisotropic layer are laminated and the direction of the lamination is determined as a thickness direction, a region of the alignment film where is from the interface between the support and the alignment film to 0 μm to 0.7 μm depth in the thickness direction, and the region also including the interface between the support and the alignment film.

The curing of the inner part of the alignment film as a result of the pretreatment can be confirmed by confirming significance of the distribution of the reaction rate of the radical polymerizable groups in the inner part when the cross-section of the alignment film is observed by the transparent electron microscopic picture in accordance with an osmium dye method.

### (5) Step of Rubbing

The support on which the alignment film layer is formed is subjected to a rubbing treatment by means of a rubbing device, and the surface of the formed alignment film is cleaned by means of a surface dust cleaner disposed adjacent to the rubbing device.

### (6) Step of Forming an Optical Anisotropic Layer

To the solution in which a discotic liquid crystal compound, a photopolymerization initiator, and the like are dissolved, there is further added the fluoro-aliphatic group containing copolymer to prepare a coating liquid for the optical anisotropic layer

This coating liquid is continuously coated on the alignment film, heated to align the discotic liquid crystal compound, and exposed with UV ray to polymerize the discotic liquid crystal compound. The film is stood to cool down to a room temperature to thereby prepare an optical compensation film with an optical anisotropic layer.

### (Polarizing Plate)

The polarizing plate of the present invention contains at least the optical compensation film of the present invention and a polarizer. The optical compensation film significantly exhibits its functions by binding with the polarizer to form the polarizing plate.

### <Polarizer>

As the polarizer, the preferred is a coating-type polarizer represented by Optiva Inc. or a polarizer composed of a binder and either iodine or a dichroic dye. The iodine and dichroic dye express polarizing performance when these are aligned in the binder. The iodine and dichroic dye are preferably aligned along the binder molecules, or otherwise the dichroic dye is preferably aligned in one direction through self-organization as in liquid crystals.

Currently commercially available polarizers are generally fabricated by immersing a stretched polymer in a bath of an iodine or dichroic dye solution so that the iodine or dichroic dye penetrates into the binder.

Moreover, in a commercially available polarizer, the iodine or dichroic dye is distributed within approximately 4 μm from each polymer surface (approximately 8 μm in total of both sides), and in order to obtain sufficient polarizing performance, the thickness of the binder is preferably at least 10 μm. On the other hand, there is no upper limit for the thickness of the binder, but the thinner is more preferable from the standpoint of a light leaking phenomenon that occurs when the polarizing plate is used for a liquid crystal display. The thickness is preferably 30 μm or less, more preferably 25 μm or less, and particularly preferably 20 μm or less. At 20 μm or less, a light leaking phenomenon is no longer observed in a 17-inch liquid crystal display. The degree of penetration can be controlled by adjusting the concentration of an iodine or dichroic dye solution, the temperature of a bath of the same, and the time for immersing the same.

The binder of the polarizer may be crosslinked. As the binder of the polarizer, a self-crosslinkable polymer may be used. The polarizer can be formed such that a polymer having functional groups or a polymer prepared by introducing functional groups to a polymer is crosslinked between polymer particles by a reaction of the functional groups under light, heat, or a pH variation.

In addition, a crosslinked structure may be introduced to the polymer by a crosslinking agent. The polarizer can be formed by using the crosslinking agent being a high-reactive compound to introduce a linking group from the crosslinking agent to the binder and crosslinking the binder.

Crosslinking can be generally carried out by applying a coating solution containing a crosslinkable polymer or a mixture of a polymer and a crosslinking agent onto a support and then heating the same. The crosslinking treatment may be caused at any stage before a final polarizing plate is obtained since it is sufficient so long as durability can be secured at the stage of a final product.

As mentioned above, either a self-crosslinkable polymer or a polymer crosslinked by a crosslinking agent can be used as the binder of the polarizer.

Examples of the polymers include polymethyl methacrylate, polyacrylic acid, polymethacrylic acid, polystyrene, gelatin, polyvinyl alcohol, modified polyvinyl alcohol, poly(N-methylolacrylamide), polyvinyl toluene, chlorosulfonated polyethylene, nitrocellulose, chlorinated polyolefin (e.g., polyvinyl chloride), polyester, polyimide, polyvinyl acetate, polyethylene, carboxymethylcellulose, polypropylene, polycarbonate, and copolymers thereof (e.g., an acrylic acid/methacrylic acid copolymer, a styrene/maleinimide copolymer, a styrene/vinyltoluene copolymer, a vinyl acetate/vinyl chloride copolymer, an ethylene/vinyl acetate copolymer).

Preferred examples are water-soluble polymers (e.g., poly(N-methylolacrylamide), carboxymethylcellulose, gelatin, polyvinyl alcohol, and modified polyvinyl alcohol). Gelatin, polyvinyl alcohol, and modified polyvinyl alcohol are more preferable, and polyvinyl alcohol and modified polyvinyl alcohol are particularly preferable.

The degree of saponification of the polyvinyl alcohol and modified polyvinyl alcohol is preferably 70% to 100%, more preferably, 80% to 100%, and particularly preferably, 95% to 100%. The degree of polymerization of the polyvinyl alcohol is preferably 100 to 5,000.

The modified polyvinyl alcohol can be obtained by introducing a modifying group to polyvinyl alcohol by copolymerization, a chain transfer, or block polymerization.

Examples of the modifying group in the copolymerization include COONa, Si(OH)₃, N(CH₃)₃—Cl, C₉H₁₉COO, SO₃Na, and C₁₂H₂₅. Examples of the modifying group in the chain transfer include COONa, SH, and C₁₂H₂₅.

The degree of polymerization of the modified polyvinyl alcohol is preferably 100 to 3,000. The modified polyvinyl alcohol has been described in JP-A Nos. 08-338913, 09-152509, and 09-316127.

In addition, unmodified and alkylthio-modified polyvinyl alcohols having degrees of saponification of 85% to 95% are particularly preferable.

Furthermore, two or more unmodified or modified polyvinyl alcohols may be used in combination. Alternatively, unmodified or modified polyvinyl alcohols may be used singly.

The more the crosslinking agent is added to the binder, the more the moist heat resistance of the polarizer can be improved. However, if the crosslinking agent is added to the binder at 50% by mass or more, alignability of the iodine or dichroic dye is lowered. The amount of the crosslinking agent is preferably 0.1% by mass to 20% by mass, and more preferably, 0.5% by mass to 15% by mass with respect to the amount of the binder.

Even after the crosslinking reaction is completed, the binder contains unreacted crosslinking agent to some extent. However, the amount of the unreacted crosslinking agent remaining in the binder is preferably 1.0% by mass or less, and more preferably, 0.5% by mass or less. If the binder contains the crosslinking agent in an amount of more than 1.0% by mass, a problem may arise in durability. That is, if the polarizer containing a large amount of remaining crosslinking agent is installed in a liquid crystal display and used for a long time or left under a high-temperature and high-humidity atmosphere for a long time, the degree of polarization can be lowered.

Examples of the crosslinking agent described in the specification of U.S. Reissue Pat. No. RE 23,297 can be used for the present invention. Boron compounds (e.g., boric acid, borax) can also be used as the crosslinking agent.

As the dichroic dye, an azo dye, a stilbene dye, a pyrazolone dye, a triphenylmethane dye, a quinoline dye, an oxazine dye, a thiazine dye, or an anthraquinone dye is used. The dichroic dye is preferably water soluble. The dichroic dye preferably has a hydrophilic substituent (e.g., a sulfo, amino, or hydroxyl group).

Examples of the dichroic dye include C.I. Direct Yellow 12, C.I. Direct Orange 39, C.I. Direct Orange 72, C.I. Direct Red 39, C.I. Direct Red 79, C.I. Direct Red 81, C.I. Direct Red 83, C.I. Direct Red 89, C.I. Direct Violet 48, C.I. Direct Blue 67, C.I. Direct Blue 90, C.I. Direct Green 59, and C.I. Acid Red 37.

The dichroic dyes have been described in JP-A Nos. 01-161202, 01-172906, 01-172907, 01-183602, 01-248105, 01-265205, and 07-261024.

The dichroic dye is used as a free acid, an alkali metal salt, an ammonium salt, or an amine salt. Moreover, the polarizer of various hues can be produced by combining two or more dichroic dyes.

As the polarizer using the dichroic dye, the polarizer using a compound which colors in black when the polarizing axis is positioned perpendicular, the polarizer using the combination of various dichroic dyes so that it colors in black when the polarizing axis is positioned perpendicular, or the polarizing plate thereof is preferable in view of excellent single-plate transmittance and polarization.

The polarizer preferably has a high transmittance and preferably has a high degree of polarization in order to increase the contrast ratio of the liquid crystal display. The transmittance of the polarizer of the present invention is preferably in a range of 30% to 50%, more preferably, in a range of 35% to 50%, and particularly preferably, in a range of 40% to 50% to light with a wavelength of 550 nm. Note that a maximum transmittance of the polarizer for single plate is 50%.

The degree of polarization is preferably in a range of 90% to 100%, more preferably, in a range of 95% to 100%, and particularly preferably, in a range of 99% to 100% to light with a wavelength of 550 nm.

The polarizer and the optical anisotropic layer are disposed via an adhesive. Examples of the adhesive include a polyvinyl alcohol resin, an aqueous solution of an iodine compound, and the like. Among these, the polyvinyl alcohol resin is preferable. Note that, the polyvinyl alcohol resin includes modified polyvinyl alcohol which is modified with an acetoacetyl group, a sulfonic group, a carboxyl group, or an oxyalkylene group.

The thickness of the adhesive is preferably 0.01 μm to 10 μm, and more preferably 0.05 μm to 5 μm on dry basis.

### [Polarizer Production Method]

For a polarizer, it is preferable that a binder is stretched in the longitudinal direction (MD direction) of a polarizer while being tilted at an angle of 10° to 80° (a stretching method), or it is rubbed (a rubbing method), and then it is dyed with iodine or a dichroic dye, in view of yield. The tilt angle is preferably equal to an angle formed between a transmission axis of the two polarizing plates bonded to the both sides of the liquid crystal cell constituting a liquid crystal display (LCD) and the longitudinal or transversal direction of the liquid crystal cell.

Although the tilt angle is generally 450, it is not necessarily 45° in the recently developed devices, such as a transmission LCD, a reflection LCD, and a half-transmission and half-reflection LCD. Therefore, it is preferably that the direction of stretching is appropriately adjusted depending on the design of LCD.

In the case of a stretching method, the stretch ratio is preferably 2.5 to 30.0, and more preferably, 3.0 to 10.0. The stretching can be carried out by dry stretching in air.

In addition, wet stretching in a state submerged in water may also be carried out. The stretch ratio in dry stretching is preferably 2.5 to 5.0, while the stretch ratio of wet stretching is preferably 3.0 to 10.0.

The stretching step may be carried out in several steps. Dividing the stretching step into several steps allows stretching more uniformly even at a high stretching ratio.

Before being thus stretched, the binder may be slightly stretched laterally or longitudinally (to the extent that a shrinkage in the width direction is prevented). For the stretching, a tenter stretching of a biaxial stretching can be carried out in different steps at the left and right.

In the stretching method, a binder film which is stretched at a tilt angle of 10° to 80° with respect to the MD direction of the alignment film is produced as described above.

The rubbing treatment which is widely used for the liquid crystal alignment treatment of LCD can be applied in the aforementioned rubbing method. Namely, the alignment is performed by rubbing the surface of the film in a certain direction by using a paper, gauze, felt, rubber, nylon, polyester fibers, or the like. Generally, it is performed by carrying out rubbing a few times using a cloth in which fibers having a uniform length and thickness are uniformly implanted.

The rubbing is preferably performed by using a rubbing roll having a circularity of 30 μm or less, a cylindricality of 30 μm or less, and deflection (decentration) of 30 μm or less. The wrapping angle of the film with respect to the rubbing roll is preferably 0.1° to 90°. However, the stable rubbing can be also performed by wrapping the rubbing roller with the film at 360° or more as described in JP-A No. 08-160430.

In the case where the rubbing treatment is performed on a long film, the film is preferably transferred at the transferring speed of 1 m/min. to 100 m/min. by means of a conveying device while maintaining the film at a certain tension. In this process, the rubbing angle of the rubbing roll can be appropriately adjusted, and thus the rubbing roll is preferably freely rotated in the horizontal direction with respect to the traveling direction of the film. Specifically, the appropriate rubbing angle is preferably adjusted in the range of 0 to 60°. In the case where the polarizer is used in a liquid crystal display device, the rubbing angle is preferably 40° to 50°, and more preferably 45°.

It is preferably that a polymer film is disposed on a surface of the polarizer opposite to the surface where the optical anisotropic layer is disposed, and it is structured as the optical anisotropic layer/the polarizer/the polymer film.

### [Surface Treatment of Optical Compensation Film]

In the case where an optical compensation film is used instead of a transparent protective film of a polarizing plate, there is a problem of the adhesion between the optical compensation film and the transparent protective film of the polarizing plate. In the present invention the adhesion between the optical compensation film and the polarizer is improved by performing a surface treatment on a surface of the optical compensation film to which the polarizer is disposed.

Examples of the surface treatment include a corona discharge treatment, a glow discharge treatment, a flame treatment, a UV irradiation treatment, an ozone treatment, an acid treatment, and an alkali treatment.

The treating methods such as the corona discharge treatment, the glow discharge treatment, the flame treatment, the UV irradiation treatment, the ozone treatment, the acid treatment, the alkali treatment, and the like are those described in the pages 30-31 of Journal of technical disclosure (N1) No. 2001-1745. In the present invention, the surface treatment is preferably an alkali treatment, and the example thereof is the one explained in the aforementioned saponification method of the film.

### (Liquid Crystal Display Device)

The liquid crystal display device of the present invention contains the polarizing plate of the present invention. The preferable embodiments for each liquid crystal mode are explained hereinafter.

### [TN-Mode Liquid Crystal Display Device]

The liquid crystal cell of TN (Twisted Nematic) mode is the most commonly used as a component of a color thin film transistor (TFT) liquid crystal display device, and it has been described in the various documents.

The alignment state in the liquid crystal cell of the black display of TN mode is such that the rod-shaped liquid crystal molecules are stood up in the centric part of the cell and the rod-shaped liquid crystal molecules are laid in the area adjacent to the substrate of the cell.

The rod-shaped liquid crystal molecules in the centric part of the cell are compensated with a discotic compound of a homeotropic alignment that is in the horizontal alignment state such that a disc surface is laid, or (transparent support). The rod-shaped liquid crystal molecules in the area adjacent to the substrate of the cell are compensated with a discotic compound of a hybrid alignment that is an alignment in which a tilt of the long axis is changed depending on the distance to the polarizer.

Moreover, the rod-shaped liquid crystal molecules in the centric part of the cell can be also compensated with a rod-shaped liquid crystal compound of a homogeneous alignment that is in the horizontal alignment state such that the long axis is laid, or a (transparent) support, and the rod-shaped liquid crystal molecules in the area adjacent to the substrate of the cell can be also compensated with a discotic compound of a hybrid alignment.

The liquid crystal molecule of the homeotropic alignment is aligned in the state such that an average alignment direction of a long axis of the liquid crystal molecule and the surface of the polarizer forms an angle of 85° to 95°.

The liquid crystal molecule of the homogeneous alignment is aligned in the state such that an average alignment direction of a long axis of the liquid crystal molecule and the surface of the polarizer forms an angle of less than 5°.

The liquid crystal molecule of the hybrid alignment is aligned in the state such that an average alignment direction of a long axis of the liquid crystal molecule and the surface of the polarizer forms an angle of preferably 15° or more, and more preferably 15° to 85°.

The (transparent) support, an optical anisotropic layer in which the discotic compound is homeotropically aligned, an optical anisotropic layer in which the rod-shaped liquid crystal compound is homogeneously aligned, and an optical anisotropic layer which contain the mixture of the homeotropically aligned discotic compound and the homogeneously aligned rod-shaped liquid crystal compound preferably have a thickness retardation (Rth) of 40 nm to 200 nm, and an in-plate retardation (Re) of 0 to 70 nm. Here, Rth is a value determined by the following formula (A), and Re is a value determined by the following formula (B).

Rth={(nx+ny)/2−nz}×d Formula (A)

Re=(nx−ny)×d Formula (B)

In the formulae (A) and (B), nx denotes a refractive index of the slow axis direction of the in-plate film, ny denotes a refractive index of the fast axis direction of the in-plate film, nz denotes a refractive index of the thickness direction of the film, and d denotes a thickness of the film.

The layer of the homeotropically (horizontally) aligned discotic compound and the layer of the homogeneously (horizontally) aligned rod-shaped liquid crystal molecule are described in JP-A Nos. 12-304931 and 12-304932. The layer of the hybrid aligned discotic liquid crystal compound is described in JP-A No. 08-50206.

### [OCB-Mode Liquid Crystal Display Device]

An OCB (Optically Compensatory Bend)-mode liquid crystal cell is a liquid crystal cell of a bend alignment-mode where rod-shaped liquid crystalline molecules in upper and lower parts of the liquid crystal cell are aligned in substantially opposite directions (symmetrically), and liquid crystal displays using such the liquid crystal cell are disclosed in U.S. Pat. Nos. 4,583,825 and 5,410,422.

Since the rod-like liquid crystal molecules in the upper and lower parts of the liquid crystal cell are symmetrically aligned, the liquid crystal cell of the bend alignment mode has a self-compensatory function. Therefore, this liquid crystal mode is referred to also as an OCB (Optically Compensatory Bend) liquid crystal mode.

As well as the TN-mode liquid crystal cell, the alignment state in the OCB-mode liquid crystal cell in the black display, the rod-shaped liquid crystal molecules are stood up in the centric part of the cell, and the rod-shaped liquid crystal molecules are laid in the area adjacent to the substrate of the cell.

In the black display, the alignment state of liquid crystal is the same as that of TN-mode, the preferable embodiment of OCB-mode is also the same as that of TN-mode. However, the area of the centric part of the cell in which the liquid crystal compound is stood up is larger in OCM-mode than in TN-mode, and thus the slight adjustment of the retardation is necessary for an optical anisotropic layer in which the discotic compound is homeotropically aligned, or an optical anisotropic layer in which the rod-shaped liquid crystal compound is homogeneously aligned.

Specifically, the optical anisotropic layer in which the discotic compound is homeotropically aligned and the optical anisotropic layer in which the rod-shaped liquid crystal compound is homogeneously aligned have Rth of 150 nm to 500 nm, and Re of 20 nm to 70 nm.

### [VA-Mode Liquid Crystal Display Device]

In the liquid crystal cell of VA (Vertically Aligned)-mode, the rod-shaped liquid crystal molecules are substantially vertically aligned at the time when no voltage is imparted. Examples of the VA-mode liquid crystal cell include: (1) a VA-mode liquid crystal cell in which the rod-shaped liquid crystal molecules are substantially vertically aligned when no voltage is applied, and substantially horizontally aligned when a voltage is applied, as disclosed in JP-A No. 02-176625; (2) a MVA-mode liquid crystal cell in which the cell is designed as a multi-domain for enlarging the view angle as described in SID 97, Digest of Tech. Papers (proceedings) vol. 28 (1997) p. 845; (3) a liquid crystal cell of a mode (n-ASM mode) in which the rod-shaped liquid crystal molecules are substantially vertically aligned when no voltage is applied, and multi-domain twisted aligned when a voltage is applied, as described in Proceedings of Japan Liquid Crystal Panel Discussion 58-59 (1998); and (4) a SURVAIVAL-mode liquid crystal cell disclosed in the LCD International 98.

In the black display of the VA-mode liquid crystal display device, almost all of the rod-shaped liquid crystal molecules in the liquid crystal cell are stood up. Therefore, it is preferable that the liquid crystal compound is compensated with an optical anisotropic layer in which the discotic compound is homeotropically aligned or an optical anisotropic layer in which the rod-shaped liquid crystal molecules are homogeneously aligned, and the viewing angle dependency is separately compensated with an optical isotropic layer in which the rod-shaped liquid crystal molecules are homogeneously aligned and the average alignment direction of the long axis of the rod-shaped liquid crystal molecules and the transmission axis direction of the polarizer form an angle of less than 5′.

The optical anisotropic layer in which the rod-shaped liquid crystal molecules are homeotropically aligned and the optical anisotropic layer in which the rod-shaped liquid crystal molecules are homogeneously aligned preferably have Rth of 150 nm to 500 nm, and Re of 20 nm to 70 nm.

### [Other Liquid Crystal Display Device]

Other than above, an ECB (Electrically Controlled Bend)-mode liquid crystal display device and a STN (Super Twisted Nematic)-mode liquid crystal display device are optically compensated in the same theory as described above.

### EXAMPLES

Hereinafter, examples of the present invention will be described, but the present invention is by no means limited to the following examples.

### Example 1A

### Preparation of Optical Compensation Film (KH-1)

<Preparation of support (PK-1)>

The following components were loaded in a mixing tank, stirred while heating so as to dissolve each substance, to thereby prepare a cellulose acetate solution.

### [Components for Cellulose Acetate Solution]

| | | |
|---|---|---|
| Cellulose acetate (linter) having an acetylation | 80.0 | parts by mass |
| degree of 60.9% | | |
| Cellulose acetate (linter) having an acetylation | 20.0 | parts by mass |
| degree of 60.8% | | |
| Triphenyl phosphate (plasticizer) | 7.8 | parts by mass |
| Biphenyl diphenyl phosphate (plasticizer) | 3.9 | parts by mass |
| Methylene chloride (first solvent) | 300 | parts by mass |
| Methanol (second solvent) | 54.0 | parts by mass |
| 1-Butanol (third solvent) | 11.0 | parts by mass |

Into another mixing tank, there were loaded 4 parts by mass of cellulose acetate (linter) having an acetylation degree of 60.9%, 16 parts by mass of a retardation elevating agent represented by the following general formula (V), 0.5 parts by mass of silica particles (particle diameter: 20 nm, Mohs' hardness: about 7), 87 parts by mass of methylene chloride, and 13 parts by mass of methanol, and the mixture was stirred while heating to thereby prepare a retardation elevating agent solution.

Thereafter, 36 parts by mass of the retardation elevating agent solution was added to 464 parts by mass of the cellulose acetate solution, and the mixed solution was sufficiently stirred to thereby prepare a dope. Note that, the content of the retardation elevating agent was 5.0 parts by mass with respect to 100 parts by mass of cellulose acetate.

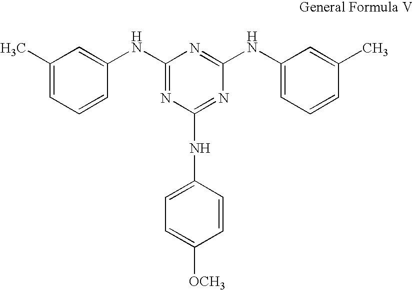

The thus obtained dope was cast by means of a band flow caster. The dope was dried for one minute when the temperature of the coated film of the dope became at 40° C. on the band. The film having the residual solvent content of 43% by mass was peeled off, and then the film was stretched at 28% in the width direction by means of a tentering frame with a drying draft of 140° C.

Thereafter, the film was dried with a drying draft of 135° C. for 20 minutes to thereby prepare a support (PK-1) having the residual solvent content of 0.3% by mass.

The thus obtained support (PK-1) had a width of 1.340 mm, and a thickness of 92 μm. The in-plate retardation (Re) of the support was measured by an ellipsometer (M-150, manufactured by JASCO Corporation) at a wavelength of 590 nm, and was 43 nm. Moreover, the retardation (Rth) of the thickness direction was measured at a wavelength of 590 nm, and was 175 nm.

The support (PK-1) prepared in this manner was immersed in the 2.0N potassium hydroxide solution (25° C.) for 2 minutes, and thereafter it was neutralized with sulfuric acid, washed with water, and then dried. The surface energy of PK-1 was measured in accordance with a contact angle method, and it was 63 mN/m.

### <<Preparation of Alignment Film>>

A composition for preparation of alignment film having the following components was prepared so that the specific gravity of the liquid is 0.968. On the alkali-treated surface of the support (PK-1), an alignment film coating liquid having the following components (composition for forming the alignment film) was coated at an amount of 31.5 mL/m² by means of a wire-bar coater of #18.

Thereafter, the coated film was dried with a hot air of 60° C. for 60 seconds and further dried with a hot air of 90° C. for 150 seconds, to thereby prepare an alignment film.

### [Components for Alignment Film Coating Liquid]

| | | |
|---|---|---|
| Polymer having a radical polymerizable group shown below | 10 | parts by mass |
| Water | 371 | parts by mass |
| Methanol | 119 | parts by mass |
| Glutaraldehyde (crosslinking agent) | 0.5 | parts by mass |
| Carboxylic acid shown below | 0.175 | parts by mass |
| Polymerization initiator (one of general formula (II-A)) | 0.00534 | parts by mass |
| (0.05% by mass of the total solid content) | | |

Polymer having a radical polymerizable group

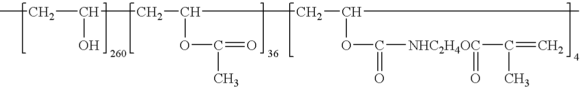

Carboxylic acid compound

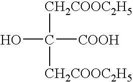

### <Formation of Optical Anisotropic Layer>

A composition for the optical anisotropic layer having the following components was prepared so that the specific gravity of the liquid is 0.912. The coating liquid was coated on the alignment film subjected to a rubbing treatment using a wire-bar of #3.2 at 5.4 mL/m². Then, an optical anisotropic layer was heated in a drying zone of 130° C. for 90 seconds. The optical anisotropic layer was transferred to a drying zone of 90° C., and was exposed with UV ray for 4 second using a high-pressure mercury lamp of 160 W/cm to polymerize a discotic compound. Thereafter, the film was stood to cool down to a room temperature to form an optical anisotropic layer. In this manner, the optical compensation film (KH-1) was prepared.

### [Composition for the Optical Anisotropic Layer]

| | | |
|---|---|---|
| Discotic liquid crystal compound represented by | 41.01 | parts by mass |
| the following general formula (VI) | | |
| Ethylene oxide modified trimethylolpropane | 4.06 | parts by mass |
| triacrylate (V#360, manufactured by Osaka | | |
| Organic Chemistry Industry Ltd.) | | |
| Cellulose acetate butylate (CAB551-0.2, | 0.34 | parts by mass |
| manufactured by Eastman Chemical Japan) | | |
| Cellulose acetate butylate (CAB531-1, | 0.11 | parts by mass |
| manufactured by Eastman Chemical Japan) | | |
| Fluoroaliphatic group containing polymer 1 | 0.56 | parts by mass |
| represented by the following general formula | | |
| (VII) | | |
| Fluoroaliphatic group containing polymer 2 | 0.06 | parts by mass |
| represented by the following general formula | | |
| (VIII) | | |
| Photopolymerization initiator (Irgacure 907, | 1.35 | parts by mass |
| manufactured by Nihon Chiba-Geigy K.K.) | | |
| Sensitizer (KAYACURE-DETX, manufactured | 0.45 | parts by mass |
| by Nippon Kayaku Co., Ltd.) | | |
| Methylethyl ketone | 97.00 | parts by mass |

Discotic liquid crystal compound

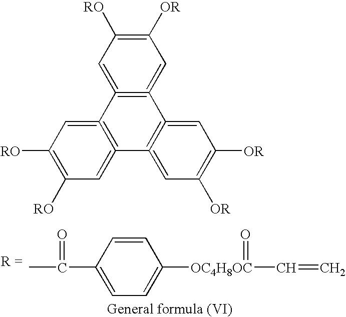

Fluoroaliphatic group containing polymer 1

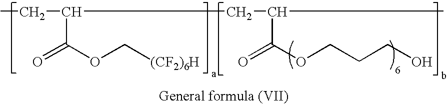

Fluoroaliphatic group containing polymer 2

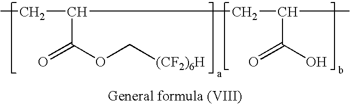

### <Preparation of Polarizing Plate (HB-1)>

### <Preparation of Polarizer>

Polyvinyl alcohol (PVA) having the average polymerization degree of 4,000 and saponification degree of 99.8 mol % was dissolved in water to thereby obtain a 4.0% PVA aqueous solution. This solution was cast on the band by means of a die having a taper, and dried so as to form a film having a width of 110 mm, a left side thickness of 120 μm, and a right side thickness of 135 μm, before stretching.

This film was peeled off from the band. The film was diagonally stretched in the direction of 45° in the dry condition, then immersed in an aqueous solution containing 0.5 g/L of iodine and 50 g/L of potassium iodide at 30° C. for one minute, sequentially immersed in an aqueous solution containing 100 g/L of boric acid, and 60 g/L of potassium iodide at 70° C. for 5 minutes, and then washed with water in a water washing tank at 20° C. for 10 seconds. Thereafter, the film was dried at 80° C. for 5 minutes to thereby obtain an iodine polarizer (HF-01). The thus obtained polarizer had a width of 660 mm and thickness of 20 μm at the both right and left sides.

### <Bonding of Optical Compensation Film>

The polarizer (HF-01) was prepared by making the stretched polyvinyl alcohol film adsorb iodine, and the support side of KH-1 (optical compensation film) was bonded to one face of the polarizer (HF-01) by using a polyvinyl alcohol adhesive.

Moreover, a triacetyl cellulose film having a thickness of 80 μm (TD-80U, manufactured by FujiFilm Corporation) was subjected to a saponification treatment, and the treated film was bonded to the other face of the polarizer (HF-1) by using the polyvinyl alcohol adhesive.

Note that, the polarizer (HF-01), the support (PK-1) and the commercially available triacetyl cellulose film were disposed in such manner that the length directions thereof became parallel to each other. The polarizing plate (HB-1) was prepared in this manner.

### (Preparation of Liquid Crystal Display Device)

A pair of the polarizing plates disposed in the liquid crystal display device (AQUOS LC20C1S, manufactured by Sharp Corporation) using the TN liquid crystal cell was peeled, and instead of these polarizing plates, a pair of the polarizing plates (HB-1) was respectively bonded to the view side and back light side of the liquid crystal cell by using the adhesive in the manner that the optical compensation films (KH-1) were faced to the side of the liquid crystal cell. Here, the polarizing plates (HB-1) were disposed so that the transmission axis of the polarizing plate disposed on the viewer side and the transmission axis of the polarizing plate disposed on the back light side were perpendicular to each other.

### (Evaluation of Optical Compensation Film, Polarizing Plate and Liquid Crystal Display Device)

### —Evaluation for Crack Resistance—

Samples were made by bonding the polarizing plates (HB-1) prepared in Example 1A to glass plates, respectively, and the samples were each left in the condition at the temperature of 60° C. and relative humidity of 90%, for 24 hours. Thereafter, the sample was observed visually and a stereoscopic microscope in terms of the condition of cracking when it was cooled down to the room temperature, and the results were evaluated in accordance with the following evaluation criteria.

A: No crack was formed.
B: Fine crack which could not be observed with the naked eyes was formed, but it could be used as a product without any problem.
D: Crack which could be observed with the naked eyes was formed, and it could not be used as a product.

### —Evaluation of Alignment—

The alignment state of the optical compensation film (KH-1) prepared in Example 1A was observed by a polarizing microscope and the results were evaluated in accordance with the following criteria.

A: No schlierene was observed, and the liquid crystal compound was uniformly aligned.
B: The slight schlierene was observed, but it could be used as a product without any problem.
C: The schlierene was observed, but it could be used as a product without any problem.
D: The schlierene was observed, and it could no be used as a product.

### —Evaluation of Evenness in Panel—

The whole face of the liquid crystal display device using the polarizing plates (HB-1) prepared in Example 1A was adjusted to show the intermediate color, and the unevenness was evaluated from the face and at the angle of 60° from the normal line by naked eyes. Evaluation was made based on the following criteria. The results are shown Table 3. No unevenness was observed from any angles for the liquid crystal display device of this Example.

A: No unevenness was observed
B: The slight, unnoticeable unevenness was observed, but it could be used as a product for monitor applications without any problem.
C: The slight, unnoticeable unevenness was observed. It could be used as a product for monitor applications without any problem, but the unevenness is problematic when used for TV applications, or in the similar high luminance panels.
D: The noticeable unevenness was observed, and it could no be used as a product.

### Examples 2A to 10A

The optical compensation film and the polarizing plate were produced in the same manner as in Example 1A, provided that as shown in Table 3, the content of the polymerization initiator (% by mass with respect to the total solid content) in the composition for forming the alignment film of Example 1A was changed. Moreover, the prepared optical compensation film and polarizing plate were evaluated in terms of the crack resistance, the alignment and the evenness in the same manner as in Example 1A. The results are shown in Table 3.

### Examples 11A to 20A

The optical compensation film and the polarizing plate were produced in the same manner as in Examples 1A to 10A, provided that as shown in Table 3, UV irradiation (emission dose: 60 mJ/cm²) was performed on the alignment film. Moreover, the prepared optical compensation film and polarizing plate were evaluated in terms of the crack resistance, the alignment and the evenness in the same manner as in Examples 1A to 10A. The results are shown in Table 3.

### Examples 21A to 30A

The optical compensation film and the polarizing plate were produced in the same manner as in Examples 1A to 10A, provided that as shown in Table 3, UV irradiation (emission dose: 120 mJ/cm²) was performed on the alignment film. Moreover, the prepared optical compensation film and polarizing plate were evaluated in terms of the crack resistance, the alignment and the evenness in the same manner as in Examples 1A to 10A. The results are shown in Table 3.

### Examples 31A to 33A

The optical compensation film and the polarizing plate were produced in the same manner as in Examples 1A, 3A, and 6A, provided that as shown in Table 3, UV irradiation (emission dose: 300 mJ/cm²) was performed on the alignment film. Moreover, the prepared optical compensation film and polarizing plate were evaluated in terms of the crack resistance, the alignment and the evenness in the same manner as in Examples 1A, 3A, and 6A. The results are shown in Table 3.

### Examples 34A to 36A

The optical compensation film and the polarizing plate were produced in the same manner as in Examples 1A, 3A, and 6A, provided that as shown in Table 3, UV irradiation (emission dose: 600 mJ/cm²) was performed on the alignment film. Moreover, the prepared optical compensation film and polarizing plate were evaluated in terms of the crack resistance, the alignment and the evenness in the same manner as in Examples 1A, 3A, and 6A. The results are shown in Table 3.

### Example 37A

The optical compensation film and the polarizing plate were produced in the same manner as in Example 1A, provided that in Example 1A, the polymerization initiator was changed from “Irgacure 2959” to “WS triazine” represented by the following general formula (IX). Moreover, the prepared optical compensation film and polarizing plate were evaluated in terms of the crack resistance, the alignment and the evenness in the same manner as in Example 1A. The results are shown in Table 3.

### Comparative Example 1A

The optical compensation film and the polarizing plate were produced in the same manner as in Example 1A, provided that in Example 1A, the polymerization initiator was not included in the composition for forming the alignment film. Moreover, the prepared optical compensation film and polarizing plate were evaluated in terms of the crack resistance, the alignment and the evenness in the same manner as in Example 1A. The results are shown in Table 3.

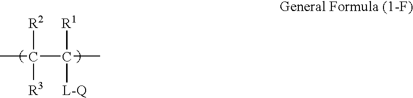

The aforementioned general formula (1-F) will be described in detail below.

First, the fluoro-aliphatic group containing polymer (polymer A) will be described below. The repeating unit derived from fluoro-aliphatic group containing monomer that is contained in the polymer A is preferably a polymer having a fluoro-aliphatic group in a side chain. The fluoro-aliphatic group has preferably 1 to 12 carbon atoms, more preferably 6 to 10 carbon atoms. The aliphatic group may have a chain or cyclic structure, and the chain structure may be linear or branched. Among those, linear fluoro-aliphatic groups having 6 to 10 carbon atoms are preferred. The fluorine-substitution degree of the fluoro-aliphatic group is not particularly limited, but preferably, 50% or more of the hydrogen atoms in the aliphatic groups are replaced with fluorine atoms, and more preferably, 60% or more are replaced. The fluoro-aliphatic group is contained in the side chain which binds to a main chain of the polymer through an ester linkage, amide linkage, imido is linkage, urethane linkage, urea linkage, ether linkage, thioether linkage, aromatic ring or the like.

Specific examples of the fluoro-aliphatic group containing monomer that is contained in the polymer A will be listed; however, the following specific examples are not intended to limit the present invention.

TABLE 3

| | | UV irradiation | Crack resistance | | | |
|---|---|---|---|---|---|---|
| | Polymerization | amount to | Temp. | Temp. | | |
| | initiator content | alignment film | 40° C., RH | 60° C., RH | | |
| | (mass %) | (mJ/cm²) | 95% | 90% | Alignment | Evenness |
| Ex. 1A | 0.05 | 0 | C | C | A | A |
| Ex. 2A | 0.10 | 0 | C | C | A | A |
| Ex. 3A | 0.25 | 0 | B | B | A | A |
| Ex. 4A | 0.50 | 0 | B | B | A | A |
| Ex. 5A | 0.75 | 0 | A | A | A | A |
| Ex. 6A | 1.00 | 0 | A | A | A | A |
| Ex. 7A | 5.00 | 0 | A | A | B | B |
| Ex. 8A | 10.00 | 0 | A | A | C | C |
| Ex. 9A | 15.00 | 0 | A | A | C | C |
| Ex. 10A | 30.00 | 0 | A | A | C | C |
| Ex. 11A | 0.05 | 60 | B | B | A | A |
| Ex. 12A | 0.10 | 60 | B | B | A | A |
| Ex. 13A | 0.25 | 60 | B | B | A | A |
| Ex. 14A | 0.50 | 60 | B | B | A | A |
| Ex. 15A | 0.75 | 60 | A | A | B | B |
| Ex. 16A | 1.00 | 60 | A | A | B | B |
| Ex. 17A | 5.00 | 60 | A | A | B | B |
| Ex. 18A | 10.00 | 60 | A | A | C | C |
| Ex. 19A | 15.00 | 60 | A | A | C | C |
| Ex. 20A | 30.00 | 60 | A | A | C | C |
| Ex. 21A | 0.05 | 120 | A | A | A | A |
| Ex. 22A | 0.10 | 120 | A | A | A | A |
| Ex. 23A | 0.25 | 120 | A | A | A | A |
| Ex. 24A | 0.50 | 120 | A | A | A | A |
| Ex. 25A | 0.75 | 120 | A | A | B | B |
| Ex. 26A | 1.00 | 120 | A | A | B | B |
| Ex. 27A | 5.00 | 120 | A | A | B | B |
| Ex. 28A | 10.00 | 120 | A | A | C | C |
| Ex. 29A | 15.00 | 120 | A | A | C | C |
| Ex. 30A | 30.00 | 120 | A | A | C | C |
| Ex. 31A | 0.05 | 300 | A | A | B | B |
| Ex. 32A | 0.50 | 300 | A | A | B | B |
| Ex. 33A | 1.00 | 300 | A | A | B | B |
| Ex. 34A | 0.05 | 600 | A | A | C | C |
| Ex. 35A | 0.50 | 600 | A | A | C | C |
| Ex. 36A | 1.00 | 600 | A | A | C | C |
| Ex. 37A | 0.05 | 0 | B | B | C | C |
| Com. Ex | 0.00 | 0 | D | D | A | A |
| 1A | | | | | | |

From the results shown in Table 3, it was found that the optical compensation films and polarizing plates of Examples 1A to 37A in which the polymerization initiator is contained in an amount in the range of from 0.05% by mass to 30.0% by mass of the total solid content of the polymer in the alignment film had acceptable alignment and excellent crack resistance. Especially, Examples 21A to 24A in which the content of the polymerization initiator were adjusted to 0.05% by mass to 0.50% by mass and the emission dose of UV to the alignment film adjusted at 120 mJ/cm² had particularly excellent crack resistance and alignment.

On the other hand, the crack resistance of the optical compensation film and polarizing plate of Comparative Example 1 was inferior as it did not contain the polymerization initiator and UV irradiation was not performed on the alignment film.

From the observation of panels, it was found that the liquid crystal display devices of Examples 1A to 37A had excellent display quality without unevenness or the like.

### Examples 38A to 52A

The alignment film layer was prepared in the same manner as in Example 1A, provided that as shown in Table 4, the amount of each substance in the composition for forming the alignment film layer of Example 21A was changed. The optical compensation film and the polarizing plate were produced in the same manner as in Example 1A except this preparation of alignment film layer. Moreover, the prepared optical compensation film and polarizing plate were evaluated in terms of the crack resistance, the alignment and the evenness in the same manner as in Example 1A. The results are shown in Table 4.

The thickness of the alignment film layer was measured as follows. Specifically, the alignment film layer as a sample was exposed to osmium tetraoxide vapor, and then the alignment film layer was observed using a scanning electron microscope (SEM) (JSM 6700F, manufactured by JEOL Ltd.). The thickness was determined by comparing with standard scale.

TABLE 4

| | | Ex. 38A | Ex. 39A | Ex. 40A | Ex. 41A | Ex. 42A | Ex. 43A | Ex. 44A | Ex. 45A |
|---|---|---|---|---|---|---|---|---|---|
| Modified | parts | 15 | 12 | 10 | 10 | 10 | 10 | 10 | 10 |
| polyvinyl | by | | | | | | | | |
| alcohol | mass | | | | | | | | |
| Water | parts | 371 | 371 | 371 | 371 | 371 | 371 | 371 | 371 |
| | by | | | | | | | | |
| | mass | | | | | | | | |
| Methanol | parts | 119 | 119 | 119 | 119 | 119 | 119 | 119 | 119 |
| | by | | | | | | | | |
| | mass | | | | | | | | |
| Glutaraldehyde | parts | 0.5 | 0.5 | 0.5 | 0.5 | 0.5 | 0.5 | 0.5 | 0.5 |
| | by | | | | | | | | |
| | mass | | | | | | | | |
| Carboxylic acid | parts | 0.175 | 0.175 | 0.175 | 0.175 | 0.175 | 0.175 | 0.175 | 0.175 |
| compound | by | | | | | | | | |
| | mass | | | | | | | | |
| Polymerization | parts | 0.0053 | 0.0053 | 0.0053 | 0.011 | 0.027 | 0.053 | 0.08 | 0.107 |
| initiator | by | | | | | | | | |
| | mass | | | | | | | | |
| Solid | % by | 3.1 | 2.52 | 2.13 | 2.13 | 2.14 | 2.14 | 2.15 | 2.15 |
| concentration | mass | | | | | | | | |
| Polymerization | % by | 0.05 | 0.05 | 0.05 | 0.1 | 0.25 | 0.5 | 0.75 | 1 |
| initiator content | mass | | | | | | | | |
| (with respect to | | | | | | | | | |
| the total solid | | | | | | | | | |
| content) | | | | | | | | | |
| Thickness | μm | 0.583 | 0.463 | 0.381 | 0.382 | 0.382 | 0.383 | 0.384 | 0.386 |
| Alignment | | A | A | A | A | A | A | B | B |
| Crack | | A | A | A | A | A | A | A | A |
| resistance | | | | | | | | | |
| Evenness | | D | D | A | A | A | A | A | A |

| | | Ex. 46A | Ex. 47A | Ex. 48A | Ex. 49A | Ex. 50A | Ex. 51A | Ex. 52A |
|---|---|---|---|---|---|---|---|---|
| Modified | parts | 10 | 10 | 10 | 10 | 5 | 1.5 | 1.1 |
| polyvinyl | by | | | | | | | |
| alcohol | mass | | | | | | | |
| Water | parts | 371 | 371 | 371 | 371 | 371 | 360 | 360 |
| | by | | | | | | | |
| | mass | | | | | | | |
| Methanol | parts | 119 | 119 | 119 | 119 | 119 | 120 | 120 |
| | by | | | | | | | |
| | mass | | | | | | | |
| Glutaraldehyde | parts | 0.5 | 0.5 | 0.5 | 0.5 | 0.5 | 0.8 | 0.8 |
| | by | | | | | | | |
| | mass | | | | | | | |
| Carboxylic acid | parts | 0.175 | 0.175 | 0.175 | 0.175 | 0.175 | 1.1 | 1.1 |
| compound | by | | | | | | | |
| | mass | | | | | | | |
| Polymerization | parts | 0.534 | 1.068 | 1.602 | 3.204 | 0.011 | 0.027 | 0.107 |
| initiator | by | | | | | | | |
| | mass | | | | | | | |
| Solid | % by | 2.24 | 2.34 | 2.44 | 2.75 | 1.15 | 0.69 | 0.63 |
| concentration | mass | | | | | | | |
| Polymerization | % by | 5 | 10 | 15 | 30 | 0.1 | 0.25 | 1.00 |
| initiator content | mass | | | | | | | |
| (with respect to | | | | | | | | |
| the total solid | | | | | | | | |
| content) | | | | | | | | |
| Thickness | μm | 0.403 | 0.425 | 0.446 | 0.511 | 0.176 | 0.081 | 0.067 |
| Alignment | | B | C | C | C | C | C | C |
| Crack | | A | A | A | A | A | A | A |
| resistance | | | | | | | | |
| Evenness | | A | C | C | C | C | C | C |

As shown in Table 4, it was found that the polarizing plates of Examples 39A to 52A, which contain the alignment film layer prepared using the composition for the alignment film having a solid concentration in the range of from 0.6% by mass to 3.0% by mass, all had excellent resistance without any crack.

In particular, the liquid crystal display devices of Examples 40A to 46A were particularly excellent with no unevenness observed. For the liquid crystal display devices of Examples 47A, 48A, 50A 51A and 52A unevenness was observed, but they were practically unnoticeable. They could be used as a product for monitor applications without any problem.

For the optical compensation film of Example 38A that contains the alignment film layer prepared using the composition for the alignment film having a solid concentration more than 3.0% by mass, the slight schlierene was observed, but it could be used as a product without any problem. The polarizing plates of Examples 38A to 52A had excellent resistance without any crack.

For the optical compensation film of Example 51A that contains the alignment film layer prepared using the composition for the alignment film having a solid concentration less than 0.7% by mass, the schlierene was observed, but it could be used as a product without any problem.

For the liquid crystal display device of Example 51A, the slight unevenness was observed, but it was not significant for monitor applications. This unevenness may be problematic occasionally in the high luminance panels for TV applications, etc.

### Example 1B

### Preparation of Optical Compensation Film (KH-1)

### <Preparation of Support (PK-1)>

The following components were loaded in a mixing tank, stirred while heating so as to dissolve each substance, to thereby prepare a cellulose acetate solution.

### [Components for Cellulose Acetate Solution]

| | | |
|---|---|---|
| Cellulose acetate (linter) having an acetylation | 80 | parts by mass |
| degree of 60.9% | | |
| Cellulose acetate (linter) having an acetylation | 20 | parts by mass |
| degree of 60.8% | | |
| Triphenyl phosphate (plasticizer) | 7.8 | parts by mass |
| Biphenyl diphenyl phosphate (plasticizer) | 3.9 | parts by mass |
| Methylene chloride (first solvent) | 300 | parts by mass |
| Methanol (second solvent) | 54 | parts by mass |
| 1-Butanol (third solvent) | 11 | parts by mass |

Into another mixing tank, there were loaded 4 parts by mass of cellulose acetate (linter) having an acetylation degree of 60.9%, 16 parts by mass of a retardation elevating agent represented by the following general formula (IV), 0.5 parts by mass of silica particles (particle diameter: 20 nm, Mohs' hardness: about 7), 87 parts by mass of methylene chloride, and 13 parts by mass of methanol, and the mixture was stirred while heating to thereby prepare a retardation elevating agent solution.

Thereafter, 36 parts by mass of the retardation elevating agent solution was added to 464 parts by mass of the cellulose acetate solution, and the mixed solution was sufficiently stirred to thereby prepare a dope. Note that, the content of the retardation elevating agent was 5.0 parts by mass with respect to 100 parts by mass of cellulose acetate.

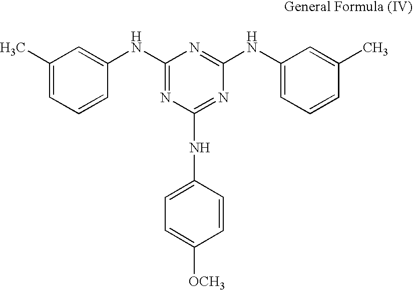

The thus obtained dope was cast by means of a band flow caster. The dope was dried for one minute when the temperature of the coated film of the dope became at 40° C. on the band. The film having the residual solvent content of 43% by mass was peeled off, and then the film was stretched at 28% in the width direction by means of a tentering frame with a drying draft of 140° C.

Thereafter, the film was dried with a drying draft of 135° C. for 20 minutes to thereby prepare a support (PK-1) having the residual solvent content of 0.3% by mass.

The thus obtained support (PK-1) had a width of 1.340 mm, and a thickness of 92 μm. The in-plate retardation (Re) of the support was measured by an ellipsometer (M-150, manufactured by JASCO Corporation) at a wavelength of 590 nm, and was 43 nm. Moreover, the retardation (Rth) of the thickness direction was measured at a wavelength of 590 nm, and was 175 nm.

The support (PK-1) prepared in this manner was immersed in the 2.0N potassium hydroxide solution (25° C.) for 2 minutes, and thereafter it was neutralized with sulfuric acid, washed with water, and then dried. The surface energy of PK-1 was measured in accordance with a contact angle method, and it was 63 mN/m.

### <<Preparation of Alignment Film>>

A composition for the alignment film having the following components was prepared so that the specific gravity of the liquid is 0.968. On the alkali-treated surface of the support (PK-1), an alignment film coating liquid having the following components (composition for forming the alignment film) was coated at an amount of 31.5 mL/m² by means of a wire-bar coater of #18.

Thereafter, the coated film was dried with a hot air of 60° C. for 60 seconds and further dried with a hot air of 90° C. for 150 seconds, to thereby prepare an alignment film.

### [Components for Alignment Film Coating Liquid]

| | | |
|---|---|---|
| Polymer having a radical polymerizable group shown below | 100.00 | parts by mass |
| Water | 2,360.00 | parts by mass |
| Methanol | 755.00 | parts by mass |
| Glutaraldehyde (crosslinking agent) | 5.00 | parts by mass |
| Carboxylic compound shown below (additive) | 1.75 | parts by mass |
| Triethylene glycol diacrylate (compound having two or more vinyl groups) | 5.00 | parts by mass |

Polymer having a radical polymerizable group

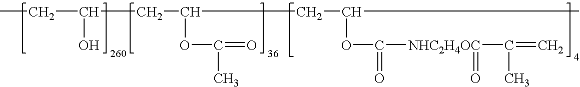

Carboxylic acid compound

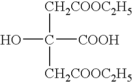

### <Formation of Optical Anisotropic Layer>

A composition for the optical anisotropic layer having the following components was prepared so that the specific gravity of the liquid is 0.912. The coating liquid was coated on the alignment film subjected to a rubbing treatment using a wire-bar of #3.2 at 5.4 mL/m². Then, an optical anisotropic layer was heated in a drying zone of 130° C. for 90 seconds. The optical anisotropic layer was transferred to a drying zone of 90° C., and was exposed with UV ray for 4 second using a high-pressure mercury lamp of 160 W/cm to polymerize a discotic compound. Thereafter, the film was stood to cool down to a room temperature to form an optical anisotropic layer. In this manner, the optical compensation film (KH-1) was prepared.

[Composition for the optical anisotropic layer]

| | | |
|---|---|---|
| Discotic liquid crystal compound represented by | 41.01 | parts by mass |
| the following general formula (VI) | | |
| Ethylene oxide modified trimethylolpropane | 4.06 | parts by mass |
| triacrylate (V#360, manufactured by Osaka | | |
| Organic Chemistry Industry Ltd.) | | |
| Cellulose acetate butylate (CAB551-0.2, | 0.34 | parts by mass |
| manufactured by Eastman Chemical Japan) | | |
| Cellulose acetate butylate (CAB531-1, | 0.11 | parts by mass |
| manufactured by Eastman Chemical Japan) | | |
| Fluoroaliphatic group containing polymer 1 | 0.56 | parts by mass |
| represented by the following general formula | | |
| (VII) | | |
| Fluoroaliphatic group containing polymer 2 | 0.06 | parts by mass |
| represented by the following general formula | | |
| (VIII) | | |
| Photopolymerization initiator (Irgacure 907, | 1.35 | parts by mass |
| manufactured by Nihon Chiba-Geigy K.K.) | | |
| Sensitizer (KAYACURE-DETX, manufactured | 0.45 | parts by mass |
| by Nippon Kayaku Co., Ltd.) | | |
| Methylethyl ketone | 97.00 | parts by mass |

Discotic liquid crystal compound

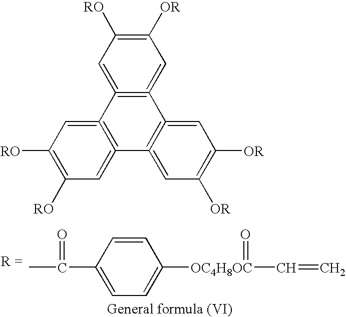

Fluoroaliphatic group containing polymer 1

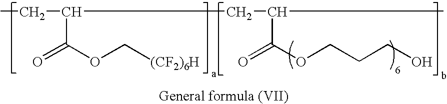

Fluoroaliphatic group containing polymer 2

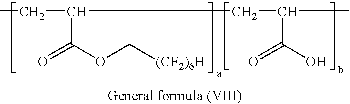

### <Preparation of Polarizing Plate (HB-1)>

### <Preparation of Polarizer>

Polyvinyl alcohol (PVA) having the average polymerization degree of 4,000 and saponification degree of 99.8 mol % was dissolved in water to thereby obtain a 4.0% PVA aqueous solution. This solution was cast on the band by means of a die having a taper, and dried so as to form a film having a width of 110 mm, a left side thickness of 120 μm, and a right side thickness of 135 μm, before stretching.

This film was peeled off from the band. The film was diagonally stretched in the direction of 45° in the dry condition, then immersed in an aqueous solution containing 0.5 g/L of iodine and 50 g/L of potassium iodide at 30° C. for one minute, sequentially immersed in an aqueous solution containing 100 g/L of boric acid, and 60 g/L of potassium iodide at 70° C. for 5 minutes, and then washed with water in a water washing tank at 20° C. for 10 seconds. Thereafter, the film was dried at 80° C. for 5 minutes to thereby obtain an iodine polarizer (HF-01). The thus obtained polarizer had a width of 660 mm and thickness of 20 μm at the both right and left sides.

### <Bonding of Optical Compensation Film>

The polarizer (HF-01) was prepared by making the stretched polyvinyl alcohol film adsorb iodine, and the support side of KH-1 (optical compensation film) was bonded to one face of the polarizer (HF-01) by using a polyvinyl alcohol adhesive.

Moreover, a triacetyl cellulose film having a thickness of 80 μm (TD-80U, manufactured by Fuji Photo Film Co., Ltd.) was subjected to a saponification treatment, and the treated film was bonded to the other face of the polarizer (HF-1) by using the polyvinyl alcohol adhesive.

Note that, the polarizer (HF-01), the support (PK-1) and the commercially available triacetyl cellulose film were disposed in such manner that the length directions thereof became parallel to each other. The polarizing plate (HB-1) was prepared in this manner.

### (Preparation of Liquid Crystal Display Device)

A pair of the polarizing plates disposed in the liquid crystal display device (AQUOS LC20C1S, manufactured by Sharp Corporation) using the TN liquid crystal cell was peeled, and instead of these polarizing plates, a pair of the polarizing plates (HB-1) was respectively bonded to the view side and back light side of the liquid crystal cell by using the adhesive in the manner that the optical compensation films (KH-1) were faced to the side of the liquid crystal cell. Here, the polarizing plates (HB-1) were disposed so that the transmission axis of the polarizing plate disposed on the viewer side and the transmission axis of the polarizing plate disposed on the back light side were perpendicular to each other.

The angle of field of the prepared liquid crystal display device was determined by 8 levels from a black display (L1) to a white display (L8) by means of a measuring device (EZ-Contrast 160D, manufactured by ELDIM).

### (Evaluation of Optical Compensation Film, Polarizing Plate and Liquid Crystal Display Device)

### —Evaluation for Crack Resistance—

Samples were made by bonding the polarizing plates (HB-1) prepared in Example 1A to glass plates, respectively, and the samples were each left in the condition at the temperature of 40° C. and relative humidity of 95%, and the condition at the temperature of 60° C. and relative humidity of 90%, for 24 hours. Thereafter, the sample was observed by naked eyes and a stereoscopic microscope in terms of the condition of cracking when it was cooled down to the room temperature, and the results were evaluated in accordance with the following evaluation criteria.
A: No crack was formed.
B: Fine crack which could not be observed with the naked eyes was formed, but it could be used as a product without any problem.
D: Crack which could be observed with the naked eyes was formed, and it could not be used as a product.

### —Evaluation of Alignment—

The alignment state of the optical compensation film (KH-1) prepared in Example 1A was observed by a polarizing microscope and the results were evaluated in accordance with the following criteria.

A: No schlierene was observed, and the liquid crystal compound was uniformly aligned.
B: The slight schlierene was observed, but it could be used as a product without any problem.
C: The schlierene was observed, but it could be used as a product without any problem.
D: The schlierene was observed, and it could no be used as a product.

### —Evaluation of Evenness in Panel—

The whole face of the liquid crystal display device using the polarizing plates (HB-1) prepared in Example 1A was adjusted to show the intermediate color, and the unevenness was evaluated from the face and at the angle of 60° from the normal line by naked eyes. Evaluation was made based on the following criteria. The results are shown Table 3. No unevenness was observed from any angles for the liquid crystal display device of this Example.

A: No unevenness was observed
B: The slight, unnoticeable unevenness was observed, but it could be used as a product for monitor applications without any problem.
C: The slight, unnoticeable unevenness was observed. It could be used as a product for monitor applications without any problem, but the unevenness is problematic when used for TV applications, or in the similar high luminance panels.
D: The noticeable unevenness was observed, and it could no be used as a product.

### Example 2B

The optical compensation film and the polarizing plate were produced in the same manner as in Example 1B, provided that as shown in Table 5, the compound having two or more vinyl groups in the composition for the alignment film layer in Example 1B was changed from triethylene glycol diacrylate to triethylene glycol dimethacrylate. Moreover, the prepared optical compensation film and polarizing plate were evaluated in terms of the crack resistance, the alignment and the unevenness in the same manner as in Example 1B. The results are shown in Table 5.

### Examples 3B to 5B

The optical compensation film and the polarizing plate were produced in the same manner as in Example 2B, provided that the amount (% by mass with respect to the total solid content) of the compound having two or more vinyl groups (triethylene glycol dimethacrylate) in the composition for the alignment film layer in Example 2B was changed as shown in Table 5. Moreover, the prepared optical compensation film and polarizing plate were evaluated in terms of the crack resistance, the alignment and the unevenness in the same manner as in Example 2B. The results are shown in Table 5.

### Example 6B

The optical compensation film and the polarizing plate were produced in the same manner as in Example 1B, provided that as shown in Table 5, the compound having two or more vinyl groups in the composition for the alignment film layer in Example 1B was changed from triethylene glycol diacrylate to tetraethylene glycol dimethacrylate. Moreover, the prepared optical compensation film and polarizing plate were evaluated in terms of the crack resistance, the alignment, and the unevenness in the same manner as in Example 1B. The results are shown in Table 5.

### Example 7B

The optical compensation film and the polarizing plate were produced in the same manner as in Example 5B, provided that as shown in Table 5, the compound having two or more vinyl groups in the composition for the alignment film layer in Example 5B was changed from triethylene glycol dimethacrylate to diethylene glycol dimethacrylate. Moreover, the prepared optical compensation film and polarizing plate were evaluated in terms of the crack resistance, the alignment, and the unevenness in the same manner as in Example 5B. The results are shown in Table 5.

### Example 8B

The optical compensation film and the polarizing plate were produced in the same manner as in Example 5B, provided that as shown in Table 5, the compound having two or more vinyl groups in the composition for the alignment film layer in Example 5B was changed from triethylene glycol dimethacrylate to ethylene glycol dimethacrylate. Moreover, the prepared optical compensation film and polarizing plate were evaluated in terms of the crack resistance, the alignment, and the unevenness in the same manner as in Example 5B. The results are shown in Table 5.

### Example 9B

The optical compensation film and the polarizing plate were produced in the same manner as in Example 1B, provided that the compound having two or more vinyl groups in the composition for the alignment film layer in Example 1B was changed from triethylene glycol diacrylate to polyoxyethylene sorbitol trimethacrylate (number average molecular weight 1,800), and the amount (% by mass with respect to the total solid content) of the compound having two or more vinyl groups was increased as shown in Table 5. Moreover, the prepared optical compensation film and polarizing plate were evaluated in terms of the crack resistance, the alignment and the unevenness in the same manner as in Example 1B. The results are shown in Table 5.

### Example 10B

The optical compensation film and the polarizing plate were produced in the same manner as in Example 1B, provided that the compound having two or more vinyl groups in the composition for the alignment film layer in Example 1B was changed from triethylene glycol diacrylate to polyethylene glycol divinyl benzyl ether (number average molecular weight 600), and the amount (% by mass with respect to the total solid content) of the compound having two or more vinyl groups was increased as shown in Table 5. Moreover, the prepared optical compensation film and polarizing plate were evaluated in terms of the crack resistance, the alignment and the unevenness in the same manner as in Example 1B. The results are shown in Table 5.

### Example 11B

The optical compensation film and the polarizing plate were produced in the same manner as in Example 1B, provided that as shown in Table 5, the compound having two or more vinyl groups in the composition for the alignment film layer in Example 1B was changed from triethylene glycol diacrylate to triethylene glycol diallyl ether. Moreover, the prepared optical compensation film and polarizing plate were evaluated in terms of the crack resistance, the alignment and the unevenness in the same manner as in Example 1B. The results are shown in Table 5.

### Comparative Example 1B

The optical compensation film and the polarizing plate were produced in the same manner as in Example 1B, provided that as shown in Table 5, the compound having two or more vinyl groups in the composition for the alignment film layer in Example 1B was not added. Moreover, the prepared optical compensation film and polarizing plate were evaluated in terms of the crack resistance, the alignment and the unevenness in the same manner as in Example 1B. The results are shown in Table 5.

### Comparative Example 2B

The optical compensation film and the polarizing plate were produced in the same manner as in Example 1B, provided that as shown in Table 5, triethylene glycol diacrylate as the compound having two or more vinyl groups in the composition for the alignment film layer in Example 1B was changed to triethylene glycol dimethyl ether as a compound which does not have a vinyl group. Moreover, the prepared optical compensation film and polarizing plate were evaluated in terms of the crack resistance, the alignment and the unevenness in the same manner as in Example 1B. The results are shown in Table 5.

### Comparative Example 3B

The optical compensation film and the polarizing plate were produced in the same manner as in Example 1B, provided that as shown in Table 5, triethylene glycol diacrylate as the compound having two or more vinyl groups in the composition for the alignment film layer in Example 1B was changed to triethylene glycol acrylate monomethyl ether as a compound having one vinyl group. Moreover, the prepared optical compensation film and polarizing plate were evaluated in terms of the crack resistance, the alignment and the unevenness in the same manner as in Example 1B. The results are shown in Table 5.

### Comparative Examples 4B and 5B

The optical compensation film and the polarizing plate were produced in the same manner as in Example 2B, provided that the amount (% by mass with respect to the total solid content) of the compound having two or more vinyl groups in the composition for the alignment film layer in Example 2B was changed as shown in Table 5. Moreover, the prepared optical compensation film and polarizing plate were evaluated in terms of the crack resistance, the alignment and the unevenness in the same manner as in Example 2B. The results are shown in Table 5.

TABLE 5

| | | Ex. | Ex. | Ex. | Ex. | Ex. | Ex. | Ex. | Ex. |
|---|---|---|---|---|---|---|---|---|---|
| | | 1B | 2B | 3B | 4B | 5B | 6B | 7B | 8B |
| Modified | parts | 100 | 100 | 100 | 100 | 100 | 100 | 100 | 100 |
| polyvinyl | by | | | | | | | | |
| alcohol | mass | | | | | | | | |
| Carboxylic | parts | 1.75 | 1.75 | 1.75 | 1.75 | 1.75 | 1.75 | 1.75 | 1.75 |
| acid compound | by | | | | | | | | |
| | mass | | | | | | | | |
| Triethylene | parts | 5.00 | — | — | — | — | — | — | — |
| glycol | by | | | | | | | | |
| diacrylate | mass | | | | | | | | |
| Triethylene | | — | 5.00 | 10.00 | 1.00 | 0.20 | — | — | — |
| glycol | | | | | | | | | |
| dimethacrylate | | | | | | | | | |
| Tetraethylene | | — | — | — | — | — | 5.00 | — | — |
| glycol | | | | | | | | | |
| dimethacrylate | | | | | | | | | |
| Diethylene | | — | — | — | — | — | — | 0.20 | — |
| glycol | | | | | | | | | |
| dimethacrylate | | | | | | | | | |
| Ethylene | | — | — | — | — | — | — | — | 0.20 |
| glycol | | | | | | | | | |
| dimethacrylate | | | | | | | | | |
| Polyoxyethylene | | — | — | — | — | — | — | — | — |
| sorbitol | | | | | | | | | |
| trimethacrylate | | | | | | | | | |
| Polyethylene | | — | — | — | — | — | — | — | — |
| glycol divinyl | | | | | | | | | |
| benzyl ether | | | | | | | | | |
| Triethylene | | — | — | — | — | — | — | — | — |
| glycol diallyl | | | | | | | | | |
| ether | | | | | | | | | |
| Triethylene | | — | — | — | — | — | — | — | — |
| glycol dimethyl | | | | | | | | | |
| ether | | | | | | | | | |
| Triethylene | | — | — | — | — | — | — | — | — |
| glycol | | | | | | | | | |
| methacrylate | | | | | | | | | |
| monomethyl | | | | | | | | | |
| ether | | | | | | | | | |
| Glutaraldehyde | parts | 5 | 5 | 5 | 5 | 5 | 5 | 5 | 5 |
| | by | | | | | | | | |
| | mass | | | | | | | | |
| Water | parts | 2360 | 2360 | 2360 | 2360 | 2360 | 2360 | 2360 | 2360 |
| | by mass | | | | | | | | |
| Methanol | parts | 755 | 755 | 755 | 755 | 755 | 755 | 755 | 755 |
| | by mass | | | | | | | | |
| Solid | % by | 3.31 | 3.31 | 3.46 | 3.19 | 3.16 | 3.31 | 3.16 | 3.16 |
| concentration | mass | | | | | | | | |
| Content of | % by | 5.00 | 5.00 | 10.00 | 1.00 | 0.20 | 5.00 | 0.20 | 0.20 |
| compound | mass | | | | | | | | |
| having two | | | | | | | | | |
| or more | | | | | | | | | |
| vinyl groups | | | | | | | | | |
| (with respect to | | | | | | | | | |
| the total solid | | | | | | | | | |
| content | | | | | | | | | |
| of the polymer) | | | | | | | | | |
| Thickness | μm | 0.625 | 0.625 | 0.656 | 0.600 | 0.595 | 0.625 | 0.595 | 0.595 |
| Alignment | | A | A | A | A | A | A | B | B |
| Crack | | A | A | A | A | B | A | B | B |
| resistance | | | | | | | | | |
| Evenness | | B | B | B | B | B | B | B | B |
| | | Ex. | Ex. | Ex. | Com. | Com. | Com. | Com. | Com. |
| | | 9B | 10B | 11B | 1B | 2B | 3B | 4B | 5B |
| Modified | parts | 100 | 100 | 100 | 100 | 100 | 100 | 100 | 100 |
| polyvinyl | by | | | | | | | | |
| alcohol | mass | | | | | | | | |
| Carboxylic | parts | 1.75 | 1.75 | 1.75 | 1.75 | 1.75 | 1.75 | 1.75 | 1.75 |
| acid compound | by | | | | | | | | |
| | mass | | | | | | | | |
| Triethylene | parts | — | — | — | — | — | — | — | — |
| glycol | by | | | | | | | | |
| diacrylate | mass | | | | | | | | |
| Triethylene | | — | — | — | — | — | — | 0.05 | 35.00 |
| glycol | | | | | | | | | |
| dimethacrylate | | | | | | | | | |
| Tetraethylene | | — | — | — | — | — | — | — | — |
| glycol | | | | | | | | | |
| dimethacrylate | | | | | | | | | |
| Diethylene | | — | — | — | — | — | — | — | — |
| glycol | | | | | | | | | |
| dimethacrylate | | | | | | | | | |
| Ethylene | | — | — | — | — | — | — | — | — |
| glycol | | | | | | | | | |
| dimethacrylate | | | | | | | | | |
| Polyoxyethylene | | 25.00 | — | — | — | — | — | — | — |
| sorbitol | | | | | | | | | |
| trimethacrylate | | | | | | | | | |
| Polyethylene | | — | 15.00 | — | — | — | — | — | — |
| glycol divinyl | | | | | | | | | |
| benzyl ether | | | | | | | | | |
| Triethylene | | — | — | 5.00 | — | — | — | — | — |
| glycol diallyl | | | | | | | | | |
| ether | | | | | | | | | |
| Triethylene | | — | — | — | — | 5.00 | — | — | — |
| glycol dimethyl | | | | | | | | | |
| ether | | | | | | | | | |
| Triethylene | | — | — | — | — | — | 5.00 | — | — |
| glycol | | | | | | | | | |
| methacrylate | | | | | | | | | |
| monomethyl | | | | | | | | | |
| ether | | | | | | | | | |
| Glutaraldehyde | parts | 5 | 5 | 5 | 5 | 5 | 5 | 5 | 5 |
| | by | | | | | | | | |
| | mass | | | | | | | | |
| Water | parts | 2360 | 2360 | 2360 | 2360 | 2360 | 2360 | 2360 | 2360 |
| | by mass | | | | | | | | |
| Methanol | parts | 755 | 755 | 755 | 755 | 755 | 755 | 755 | 755 |
| | by mass | | | | | | | | |
| Solid | % by | 3.9 | 3.61 | 3.31 | 3.16 | 3.31 | 3.31 | 3.16 | 4.20 |
| concentration | mass | | | | | | | | |
| Content of | % by | 25.00 | 15.00 | 5.00 | 0.00 | 0.00 | 0.00 | 0.05 | 35.00 |
| compound | mass | | | | | | | | |
| having two | | | | | | | | | |
| or more | | | | | | | | | |
| vinyl groups | | | | | | | | | |
| (with respect to | | | | | | | | | |
| the total solid | | | | | | | | | |
| content | | | | | | | | | |
| of the polymer) | | | | | | | | | |
| Thickness | μm | 0.749 | 0.687 | 0.625 | 0.593 | 0.625 | 0.625 | 0.594 | 0.810 |
| Alignment | | B | B | A | A | A | A | A | D |
| Crack | | A | A | B | D | D | D | D | A |
| resistance | | | | | | | | | |
| Evenness | | B | B | B | D | D | D | D | D |

From the results shown in Table 5, it was found that the optical compensation films and polarizing plates of Examples 1B to 10B in which the compound having two or more vinyl groups is contained in the composition for the alignment film layer in an amount in the range of from 0.10% by mass to 30.00% by mass of the total solid content of the polymer in the alignment film had acceptable alignment and excellent crack resistance. Especially, Examples 1B to 4B and Example 6B in which the content of the compound having two or more vinyl groups were adjusted to 1.0% by mass to 10.0% by mass had particularly excellent crack resistance and alignment.

On the other hand, the optical compensation films and polarizing plates of Comparative Examples 1B to 4B had an excellent alignment as they did not contain the compound having two or more vinyl groups or contained in an amount of less than 0.10% by mass, but the crack resistance thereof were inferior. Comparative Example 5B had an inferior alignment as it contained in an amount of more than 30.00% by mass.

From the observation of panels, it was found that the liquid crystal display devices of Examples 1B to 10B had excellent display quality without unevenness or the like.

### Examples 12B to 24B

The alignment film layer was prepared in the same manner as in Example 1B, provided that as shown in Table 6, the amount of each substance in the composition for forming the alignment film layer of Example 1B was changed. The optical compensation film and the polarizing plate were produced in the same manner as in Example 1B except this preparation of alignment film layer. Moreover, the prepared optical compensation film and polarizing plate were evaluated in terms of the crack resistance, the alignment and the evenness in the same manner as in Example 1B. The results are shown in Table 6.

The thickness of the alignment film layer was measured as follows. Specifically, the alignment film layer as a sample was exposed to osmium tetraoxide vapor, and then the alignment film layer was observed using a scanning electron microscope (SEM) (JSM 6700F, manufactured by JEOL Ltd.). The thickness was determined by comparing with standard scale.

TABLE 6

| | | Ex. 12B | Ex. 13B | Ex. 14B | Ex. 15B | Ex. 16B | Ex. 17B | Ex. 18B |
|---|---|---|---|---|---|---|---|---|
| Modified | parts | 15.5 | 15.5 | 15.5 | 10.3 | 8.4 | 8.4 | 7.6 |
| polyvinyl | by | | | | | | | |
| alcohol | mass | | | | | | | |
| Carboxylic | parts | 1.1 | 1.1 | 1.1 | 1.1 | 1.1 | 1.1 | 1.1 |
| acid | by | | | | | | | |
| compound | mass | | | | | | | |
| Triethylene | parts | 3.870 | 0.155 | 0.031 | 2.575 | 2.100 | 0.084 | 0.076 |
| glycol | by | | | | | | | |
| diacrylate | mass | | | | | | | |
| (number of | | | | | | | | |
| vinyl | | | | | | | | |
| groups: 2) | | | | | | | | |
| Glutaraldehyde | parts | 0.8 | 0.8 | 0.8 | 0.8 | 0.8 | 0.8 | 0.8 |
| | by | | | | | | | |
| | mass | | | | | | | |
| Water | parts | 360 | 360 | 360 | 360 | 360 | 360 | 360 |
| | by | | | | | | | |
| | mass | | | | | | | |
| Methanol | parts | 115 | 115 | 115 | 117 | 117 | 115 | 117 |
| | by | | | | | | | |
| | mass | | | | | | | |
| Solid | % by | 4.12 | 3.39 | 3.37 | 2.84 | 2.36 | 1.98 | 1.79 |
| concentration | mass | | | | | | | |
| Content of | % by | 25.0 | 1.0 | 0.2 | 25.0 | 25.0 | 1.0 | 1.0 |
| compound | mass | | | | | | | |
| having two or | | | | | | | | |
| more vinyl | | | | | | | | |
| groups (with | | | | | | | | |
| respect to the | | | | | | | | |
| total solid | | | | | | | | |
| content of the | | | | | | | | |
| polymer) | | | | | | | | |
| Thickness | μm | 0.793 | 0.643 | 0.638 | 0.526 | 0.428 | 0.348 | 0.309 |
| Alignment | | B | B | B | A | A | A | A |
| Crack | | A | A | A | A | A | A | A |
| resistance | | | | | | | | |
| Evenness | | C | C | C | B | B | A | A |

| | | Ex. 19B | Ex. 20B | Ex. 21B | Ex. 22B | Ex. 23B | Ex. 24B |
|---|---|---|---|---|---|---|---|
| Modified | parts | 3.8 | 1.9 | 1.9 | 1.5 | 1.5 | 1.1 |
| polyvinyl | by | | | | | | |
| alcohol | mass | | | | | | |
| Carboxylic | parts | 1.1 | 1.1 | 1.1 | 1.1 | 1.1 | 1.1 |
| acid | by | | | | | | |
| compound | mass | | | | | | |
| Triethylene | parts | 0.038 | 0.019 | 0.004 | 0.075 | 0.003 | 0.011 |
| glycol | by | | | | | | |
| diacrylate | mass | | | | | | |
| (number of | | | | | | | |
| vinyl | | | | | | | |
| groups: 2) | | | | | | | |
| Glutaraldehyde | parts | 0.8 | 0.8 | 0.8 | 0.8 | 0.8 | 0.8 |
| | by | | | | | | |
| | mass | | | | | | |
| Water | parts | 360 | 360 | 360 | 360 | 360 | 360 |
| | by | | | | | | |
| | mass | | | | | | |
| Methanol | parts | 118 | 119 | 120 | 120 | 120 | 115 |
| | by | | | | | | |
| | mass | | | | | | |
| Solid | % by | 1.02 | 0.62 | 0.62 | 0.55 | 0.53 | 0.46 |
| concentration | mass | | | | | | |
| Content of | % by | 1.0 | 1.0 | 0.2 | 5.0 | 0.2 | 1.0 |
| compound | mass | | | | | | |
| having two or | | | | | | | |
| more vinyl | | | | | | | |
| groups (with | | | | | | | |
| respect to the | | | | | | | |
| total solid | | | | | | | |
| content of the | | | | | | | |
| polymer) | | | | | | | |
| Thickness | μm | 0.147 | 0.065 | 0.064 | 0.050 | 0.047 | 0.031 |
| Alignment | | A | A | A | A | B | C |
| Crack | | A | A | A | A | A | A |
| resistance | | | | | | | |
| Evenness | | A | B | B | B | B | C |

As shown in Table 6, it was found that the polarizing plates of Examples 15B to 23B, which contain the alignment film layer prepared using the composition for the alignment film having a solid concentration in the range of from 0.5% by mass to 3.0% by mass, all had excellent resistance without any crack.

In particular, the liquid crystal display devices of Examples 17B to 19B were particularly excellent with no unevenness observed. For the liquid crystal display devices of Examples 15B, 16B, and 20B to 23B, unevenness was observed, but they were practically unnoticeable. They could be used as a product for monitor applications without any problem.

For the optical compensation films of Examples 12B to 14B that contain the alignment film layer prepared using the composition for the alignment film having a solid concentration more than 3.0% by mass, the slight schlierene was observed, but it could be used as a product without any problem. The polarizing plates of Examples 12B to 14B had excellent resistance without any crack. For the liquid crystal display devices of Examples 12B to 14B, the slight unevenness was observed, but it was not significant for monitor applications. This unevenness may be problematic occasionally in the high luminance panels for TV applications, etc.

For the optical compensation film of Example 24B that contains the alignment film layer prepared using the composition for the alignment film having a solid concentration less than 0.5% by mass, the schlierene was observed, but it could be used as a product without any problem.

For the liquid crystal display device of Example 24B, the slight unevenness was observed, but it was not significant for monitor applications. This unevenness may be problematic occasionally in the high luminance panels for TV applications, etc.

TABLE 7

| | | Ex. 51C | Ex. 52C | Ex. 53C | Ex. 54C | Ex. 55C | Ex. 56C | Ex. 57C |
|---|---|---|---|---|---|---|---|---|
| Modified | parts | 12 | 10 | 10 | 10 | 10 | 10 | 10 |
| polyvinyl | by | | | | | | | |
| alcohol | mass | | | | | | | |
| Water | parts | 371 | 371 | 371 | 371 | 371 | 371 | 371 |
| | by | | | | | | | |
| | mass | | | | | | | |
| Methanol | parts | 119 | 119 | 119 | 119 | 119 | 119 | 119 |
| | by | | | | | | | |
| | mass | | | | | | | |
| Glutaraldehyde | parts | 0.5 | 0.5 | 0.5 | 0.5 | 0.5 | 0.5 | 0.5 |
| | by | | | | | | | |
| | mass | | | | | | | |
| Carboxylic | parts | 0.175 | 0.175 | 0.175 | 0.175 | 0.175 | 0.175 | 0.175 |
| acid compound | by | | | | | | | |
| | mass | | | | | | | |
| Triethylene | parts | 0.006 | 0.010 | 0.050 | 0.100 | 1.000 | 1.500 | 3.000 |
| glycol | by | | | | | | | |
| diacrylate | mass | | | | | | | |
| (number of vinyl | | | | | | | | |
| groups: 2) | | | | | | | | |
| Polymerization | parts | 0.0063 | 0.0107 | 0.0536 | 0.1078 | 1.1675 | 1.8263 | 4.1025 |
| initiator | by | | | | | | | |
| | mass | | | | | | | |
| Solid | % by | 2.52 | 2.14 | 2.15 | 2.17 | 2.55 | 2.78 | 3.50 |
| concentration | mass | | | | | | | |
| Content of | % by | 0.05 | 0.10 | 0.50 | 1.00 | 10.00 | 15.00 | 30.00 |
| compound | mass | | | | | | | |
| having two or | | | | | | | | |
| more vinyl | | | | | | | | |
| groups (with | | | | | | | | |
| respect to the | | | | | | | | |
| total solid | | | | | | | | |
| content of the | | | | | | | | |
| polymer) | | | | | | | | |
| Polymerization | % by | 0.05 | 0.10 | 0.50 | 1.00 | 10.00 | 15.00 | 30.00 |
| initiator | mass | | | | | | | |
| content (with | | | | | | | | |
| respect to the | | | | | | | | |
| total solid | | | | | | | | |
| content) | | | | | | | | |
| Thickness | μm | 0.463 | 0.382 | 0.385 | 0.39 | 0.469 | 0.516 | 0.667 |
| Alignment | | C | A | A | A | C | C | C |
| Crack | | B | B | B | A | A | A | A |
| resistance | | | | | | | | |
| Evenness | | B | C | B | B | B | C | C |

As shown in Table 7, it was found that the polarizing plates of Examples 51C to 57C, which contain the alignment film layer prepared using the composition for the alignment film having a solid concentration in the range of from 0.5% by mass to 3.5% by mass, all had excellent resistance without any crack.

In particular, the liquid crystal display devices of Examples 52C to 54C were particularly excellent with no unevenness observed. For the liquid crystal display devices of Examples 51B, and 55B to 57B, unevenness was observed, but they were practically unnoticeable. They could be used as a product for monitor applications without any problem.

The polarizing plates of Examples 51C to 57C had excellent resistance without any crack.

In the case where both of the polymerization initiator and compound having two or more vinyl groups are added, the content of the polymerization initiator and compound having two or more vinyl groups is preferably 0.05% by mass to 30.0% by mass with respect to the total solid content. If it is less than 0.05% by mass, durability is impaired, and it is more than 30.0% by mass, the unevenness tend to be caused.

The optical compensation film of the present invention has high durability at the time when it is used for forming a polarizing plate and the polarizing plate is left in the high temperature and/or high humidity conditions, and maintains excellent alignment. Therefore, the optical compensation film of the present invention is suitably used for a polarizing plate and a liquid crystal display device having such the polarizing plate.

What is claimed is:

1. An optical compensation film comprising:
a support;
an alignment film layer which comprises a polymer having a radical polymerizable group and a polymerization initiator capable of reacting with the radical polymerizable group, the alignment film layer disposed over the support; and
an optical anisotropic layer which comprises at least one liquid crystal compound and at least one fluoroaliphatic group-containing polymer, the optical anisotropic layer disposed over the alignment film layer,
wherein the amount of the polymerization initiator is 0.05% by mass to 30.0% by mass with respect to a total solid content of the polymer having a radical polymerizable group contained in the alignment film layer.

2. The optical compensation film according to claim 1, wherein the polymer having a radical polymerizable group is a polymer containing at least one of polyvinyl alcohol and modified polyvinyl alcohol as a main substance, and the alignment film layer is a cured film obtained by coating a composition for an alignment film having a solid concentration of 0.5% by mass to 3.0% by mass followed by drying.

3. The optical compensation film according to claim 1, wherein a water solubility of the polymerization initiator is 0.01% by mass to 5.0% by mass at 25° C.

4. The optical compensation film according to claim 1, wherein the polymerization initiator has a maximum absorption wavelength of 200 nm to 350 nm.

5. The optical compensation film according to claim 1, wherein a thickness of the alignment film layer is 0.07 μm to 0.40 μm.

6. The optical compensation film according to claim 1, wherein the alignment film layer is formed through performing a pretreatment step, which allows the polymer having a radical polymerizable group to be crosslinked, before disposing the optical anisotropic layer.

7. An optical compensation film comprising:
a support;
an alignment film layer which comprises a polymer having a radical polymerizable group and a compound capable of reacting with the radical polymerizable group and having two or more vinyl groups, the alignment film layer disposed over the support; and
an optical anisotropic layer which comprises at least one liquid crystal compound and at least one fluoroaliphatic group-containing polymer, the optical anisotropic layer disposed over the alignment film layer,
wherein the amount of the compound capable of reacting with the radical polymerizable group and having two or more vinyl groups is 0.10% by mass to 30.0% by mass with respect to a total solid content of the polymer having a radical polymerizable group contained in the alignment film layer.

8. The optical compensation film according to claim 7, wherein the polymer having a radical polymerizable group is a polymer containing at least one of polyvinyl alcohol and modified polyvinyl alcohol as a main substance, and the alignment film layer is a cured film obtained by coating a composition for an alignment film having a solid concentration of 0.5% by mass to 3.0% by mass, and drying.

9. The optical compensation film according to claim 7, wherein a water solubility of the compound having two or more vinyl groups is 0.05% by mass to 5.0% by mass at 25° C.

10. The optical compensation film according to claim 7, wherein the compound having two or more vinyl groups is a multifunctional (meth)acrylate compound having at least two (meth)acrylate groups.

11. The optical compensation film according to claim 7, wherein a thickness of the alignment film layer is 0.07 μm to 0.40 μm.

12. An optical compensation film comprising:
a support;
an alignment film layer which comprises a polymer having a radical polymerizable group, a polymerization initiator capable of reacting with the radical polymerizable group, and a compound capable of reacting with the radical polymerizable group and having two or more vinyl groups, the alignment film layer disposed over the support; and
an optical anisotropic layer which comprises at least one liquid crystal compound and at least one fluoroaliphatic group-containing polymer, the optical anisotropic layer disposed over the alignment film layer,
wherein the amount of the polymerization initiator and the compound having two or more vinyl groups is 0.05% by mass to 30.0% by mass with respect to a total solid content of the polymer having a radical polymerizable group contained in the alignment film layer.

13. The optical compensation film according to claim 12, wherein the polymerization initiator has a maximum absorption wavelength of 200 nm to 350 nm.

14. The optical compensation film according to claim 12, wherein a thickness of the alignment film layer is 0.07 μm to 0.40 μm.

15. The optical compensation film according to claim 12, wherein the alignment film layer is formed through performing a pretreatment step, which allows the polymer having a radical polymerizable group to be crosslinked, before disposing the optical anisotropic layer.

16. A polarizing plate comprising:
an optical compensation film; and
a polarizer bonded to the optical compensation film,
wherein the optical compensation film comprises:
a support;
an alignment film layer which comprises a polymer having a radical polymerizable group and a polymerization initiator capable of reacting with the radical polymerizable group, the alignment film layer disposed over the support; and
an optical anisotropic layer which comprises at least one liquid crystal compound and at least one fluoroaliphatic group-containing polymer, the optical anisotropic layer disposed over the optical anisotropic layer,
wherein the amount of the polymerization initiator is 0.05% by mass to 30.0% by mass with respect to a total solid content of the polymer having a radical polymerizable group contained in the alignment film layer.

17. A polarizing plate comprising:
an optical compensation film; and
a polarizer bonded to the optical compensation film,
wherein the optical compensation film comprises:
a support;
an alignment film layer which comprise a polymer having a radical polymerizable group and a compound capable of reacting with the radical polymerizable group and having two or more vinyl groups, the alignment film layer disposed over the support; and
an optical anisotropic layer which comprises at least one liquid crystal compound and at least one fluoroaliphatic group-containing polymer, the optical anisotropic layer disposed over the optical anisotropic layer,
wherein the amount of the compound capable of reacting with the radical polymerizable group and having two or more vinyl groups is 0.10% by mass to 30.0% by mass with respect to a total solid content of the polymer having a radical polymerizable group contained in the alignment film layer.

18. A polarizing plate comprising:
an optical compensation film; and
a polarizer bonded to the optical compensation film,
wherein the optical compensation film comprises:
a support;
an alignment film layer which comprises a polymer having a radical polymerizable group, a polymerization initiator capable of reacting with the radical polymerizable group, and a compound capable of reacting with the radical polymerizable group and having two or more vinyl groups, the alignment film layer disposed over the support; and
an optical anisotropic layer which comprises at least one liquid crystal compound and at least one fluoroaliphatic group-containing polymer the optical anisotropic layer disposed over the alignment film layer,
wherein the amount of the polymerization initiator and the compound having two or more vinyl groups is 0.05% by mass to 30.0% by mass with respect to a total solid content of the polymer having a radical polymerizable group contained in the alignment film layer.

19. A liquid crystal display device comprising:
a polarizing plate which comprises an optical compensation film and a polarizer bonded to the optical compensation film; and
a liquid crystal cell,
wherein the optical compensation film comprises:
a support;
an alignment film layer which comprises a polymer having a radical polymerizable group and a polymerization initiator capable of reacting with the radical polymerizable group, the alignment film layer disposed over the support; and
an optical anisotropic layer which comprises at least one liquid crystal compound and at least one fluoroaliphatic group-containing polymer, the optical anisotropic layer disposed over the alignment film layer,
wherein the amount of the polymerization initiator is 0.05% by mass to 30.0% by mass with respect to a total solid content of the polymer having a radical polymerizable group contained in the alignment film layer.

20. A liquid crystal display device comprising:
a polarizing plate which comprises an optical compensation film and a polarizer bonded to the optical compensation film; and
a liquid crystal cell,
wherein the optical compensation film comprises:
a support;
an alignment film layer which comprises a polymer having a radical polymerizable group and a compound capable of reacting with the radical polymerizable group and having two or more vinyl groups, the alignment film layer disposed over the support; and
an optical anisotropic layer which comprises at least one liquid crystal compound and at least one fluoroaliphatic group-containing polymer, the optical anisotropic layer disposed over the alignment film layer,
wherein the amount of the compound capable of reacting with the radical polymerizable group and having two or more vinyl groups is 0.10% by mass to 30.0% by mass with respect to a total solid content of the polymer having a radical polymerizable group contained in the alignment film layer.

21. A liquid crystal display device comprising:
a polarizing plate which comprises an optical compensation film and a polarizer bonded to the optical compensation film; and
a liquid crystal cell,
wherein the optical compensation film comprises:
a support;
an alignment film layer which comprises a polymer having a radical polymerizable group, a polymerization initiator capable of reacting with the radical polymerizable group, and a compound capable of reacting with the radical polymerizable group and having two or more vinyl groups, the alignment film layer disposed over the support; and
an optical anisotropic layer which comprises at least one liquid crystal compound and at least one fluoroaliphatic group-containing polymer, the optical anisotropic layer disposed over the alignment film layer,
wherein the amount of the polymerization initiator and the compound having two or more vinyl groups is 0.05% by mass to 30.0% by mass with respect to a total solid content of the polymer having a radical polymerizable group contained in the alignment film layer.
